(19) United States
(12) Patent Application Publication
(10) Pub. No.: US 2024/0358040 A1
(43) Pub. Date: Oct. 31, 2024

(54) SYSTEMS AND METHODS FOR MODIFYING DAIRY PROTEIN FUNCTIONALITY

(71) Applicant: REGENTS OF THE UNIVERSITY OF MINNESOTA, MINNEAPOLIS, MN (US)

(72) Inventors: Sonali Raghunath, Minneapolis, MN (US); Kumar P. Mallikarjunan, Minneapolis, MN (US); Tonya Schoenfuss, Minneapolis, MN (US)

(21) Appl. No.: 18/649,533

(22) Filed: Apr. 29, 2024

Related U.S. Application Data
(60) Provisional application No. 63/462,509, filed on Apr. 27, 2023.

(51) Int. Cl. A23J 3/08; A23C 9/14; A23C 9/144; A23J 3/10

(52) U.S. Cl. CPC A23J 3/08; A23C 9/14; A23C 9/144; A23J 3/10

(57) ABSTRACT

A system for modifying dairy protein functionality can include a milk protein input, a treatment process, and a milk protein output. A controller can be in communication with the treatment process and can be configured to receive one or more input parameters. The controller can generate one or more treatment parameters based on the one or more input parameters. The controller can then initiate the treatment process based on one or more of the treatment parameters. The modified dairy protein functionality can be selected or optimized based on a target functionality of the milk protein output.

### CROSS-REFERENCE TO RELATED APPLICATIONS

The present application is based on, claims priority to, and incorporates herein by reference in its entirety for all purposes, U.S. Provisional Application No. 63/462,509, filed Apr. 27, 2023

### BACKGROUND

Milk protein concentrate (MPC) is often defined as any type of concentrated milk product that contains a certain percentage of milk protein (e.g., 40%-90% milk protein). Conventional processes for making milk protein concentrate can include first separating whole milk into cream and skim milk. The skim milk can then be fractionated using ultrafiltration to make a skim milk concentrate that is lactose-reduced. This process separates milk components according to their molecular size. Milk can then pass through a membrane that can allow some lactose, minerals, and water to pass through. Casein and whey proteins, however, will not pass through the membrane due to their molecular size. Depending on the purpose of the final product, various treatments can be used to process ultrafiltered milk protein concentrate. Similarly, Micellar casein concentrates (MCC) are also milk-derived high-protein ingredients with high nutritional quality.

In general, as the protein content of MPC and MCC increases, the lactose levels decrease. This high-protein low-lactose ratio makes MPC and MCC appealing ingredients in protein-fortified beverages and foods, including low-carbohydrate foods. In this regard, milk protein concentrate is used in a variety of foods and beverages, including, for example, nutritional beverages, nutritional and dietary products, infant formulas, protein bars, yogurts, cheese and other cultured products, and bakery and confection applications.

Conventionally, milk protein concentrates can exhibit low solubility, poor gelling behavior, or formation of insoluble aggregates, among other undesirable functional characteristics. This often leads to caking, a limited rehydration ability after storage, and other production and application obstacles. In general, caking, solubility, or other characteristics of milk protein concentrates affect the production of various end-use products (e.g., beverages, protein bars, formula, etc.) differently. For example, limited solubility may pose different complications in the production of protein beverages as compared to protein bars. Further, MCC is often subject to high production costs due to the high energy usage during treatment processes due to high viscosity. In this regard, it may be generally useful to reduce the time and energy spent in treatment processes of milk protein concentrates and to consider functional properties of dairy proteins for producing powders with a target functionality.

### SUMMARY

In accordance with some non-limiting aspects of the disclosure, a system is provided for modifying dairy protein functionality. The system can include a milk protein input, a treatment process, and a milk protein output. A controller can be in communication with the treatment process and can be configured to receive one or more input parameters. The controller can generate one or more treatment parameters based on the one or more input parameters. The controller can then initiate the treatment process based on one or more of the treatment parameters. The modified dairy protein functionality can be selected or optimized based on a target functionality of the milk protein output.

In accordance with other aspect of the disclosure, a method of producing a desired dairy product protein according to an input parameter of a processing treatment is provided. The method can include identifying a desired dairy product characteristic and inputting the desired dairy product characteristic into a controller. The controller can provide a treatment parameter based on the desired dairy product characteristic. The method can further include performing a treatment process based on the treatment parameter and outputting the desired dairy product protein.

### BRIEF DESCRIPTION OF THE DRAWINGS

FIG. 1 is a schematic illustration of a milk product treatment process in accordance with the present disclosure.

FIG. 2 is a schematic illustration of another milk product treatment process in accordance with the present disclosure.

FIG. 3 is a system for modifying dairy protein functionality according to an aspect of the disclosure.

FIG. 4 is graph with exemplary data illustrating the effects of cold plasma treatment time on foaming capacity and foam stability of a dairy protein.

FIG. 5 is a graph with exemplary data illustrating the effects of cold plasma treatment time on flow index of a dairy protein.

FIG. 6 is a graph with exemplary data illustrating the effects of cold plasma treatment time on wettability and water binding capacity of a dairy protein.

FIG. 7A is a three-dimensional plot illustrating the mutual effects of electric field intensity and temperature on a foaming capacity of pretreated milk protein concentrate.

FIG. 7B is a three-dimensional plot illustrating the mutual effects of frequency and temperature on a foaming capacity of pretreated milk protein concentrate.

FIG. 7C is a three-dimensional plot illustrating the mutual effects of frequency and electric field intensity on a foaming capacity of pretreated milk protein concentrate.

FIG. 7D is a three-dimensional plot illustrating the mutual effects of electric field intensity and temperature on a foaming capacity of pretreated milk protein concentrate.

FIG. 7E is a three-dimensional plot illustrating the mutual effects of frequency and temperature on a foaming capacity of pretreated milk protein concentrate.

FIG. 7F is a three-dimensional plot illustrating the mutual effects of frequency and electric field intensity on a foaming capacity of pretreated milk protein concentrate.

FIG. 7G is a three-dimensional plot illustrating the mutual effect of frequency and electric field intensity on foaming capacity of milk protein concentrate.

FIG. 7H is a three-dimensional plot illustrating the mutual effects of frequency and temperature on foaming capacity of milk protein concentrate.

FIG. 8A is a three-dimensional plot illustrating the mutual effects of electric field intensity and temperature on emulsion stability of pretreated milk protein.

FIG. 8B is a three-dimensional plot illustrating the mutual effects of frequency and temperature on emulsion stability of pretreated milk protein.

FIG. 8C is a three-dimensional plot illustrating the mutual effects of frequency and electric field intensity on emulsion stability of pretreated milk protein.

FIG. 9A is a three-dimensional plot illustrating the mutual effects of electric field intensity and temperature on gel strength of pretreated milk protein.

FIG. 9B is a three-dimensional plot illustrating the mutual effects of frequency and temperature on gel strength of pretreated milk protein.

FIG. 9C is a three-dimensional plot illustrating the mutual effects of frequency and electric field intensity on gel strength of pretreated milk protein.

FIG. 10 is a prediction profiler plot with stimulation for various models.

FIG. 11A is an interaction profiler for foaming capacity of pulse electric field pre-treated milk protein concentrate.

FIG. 11B is an interaction profiler for foaming stability of pulse electric field pre-treated milk protein concentrate.

FIG. 11C is an interaction profiler for solubility of pulse electric field pre-treated milk protein concentrate.

FIG. 11D is an interaction profiler for gel strength of pulse electric field pre-treated milk protein concentrate.

FIG. 11E is an interaction profiler for water holding capacity of pulse electric field pre-treated milk protein concentrate.

FIG. 11F is an interaction profiler for emulsion stability of pulse electric field pre-treated milk protein concentrate.

FIG. 12A is a three-dimensional plot illustrating the mutual effects of temperature and electric field intensity on insolubility index of reconstituted milk protein concentrate.

FIG. 12B is a three-dimensional plot illustrating the mutual effects of electric field intensity and frequency on insolubility index of reconstituted milk protein concentrate.

FIG. 12C is a three-dimensional plot illustrating the mutual effects of electric field intensity and frequency on insolubility index of reconstituted milk protein concentrate.

FIG. 13A is a three-dimensional plot illustrating the mutual effects of electric field intensity and frequency on foaming capacity of reconstituted milk protein concentrate.

FIG. 13B is a three-dimensional plot illustrating the mutual effects of frequency and temperature on foaming capacity of reconstituted milk protein concentrate.

FIG. 13C is a three-dimensional plot illustrating the mutual effects of electric field intensity and frequency on foaming capacity of reconstituted milk protein concentrate.

FIG. 14A is a three-dimensional plot illustrating the mutual effects of electric field intensity and temperature on flowability of milk protein concentrate.

FIG. 14B is a three-dimensional plot illustrating the mutual effects of frequency and temperature on flowability of milk protein concentrate.

FIG. 14C is a three-dimensional plot illustrating the mutual effects of frequency and electric field intensity on flowability of milk protein concentrate.

FIG. 15 is a prediction profiler plot with stimulation for various models.

FIG. 16A is an interaction profiler for emulsion stability of pulse electric field treated milk protein concentrate.

FIG. 16B is an interaction profiler for foaming capacity of pulse electric field treated milk protein concentrate.

FIG. 16C is an interaction profiler for foaming stability of pulse electric field treated milk protein concentrate.

FIG. 16D is an interaction profiler for water holding capacity of pulse electric field treated milk protein concentrate.

FIG. 16E is an interaction profiler for insolubility index of pulse electric field treated milk protein concentrate.

FIG. 16F is an interaction profiler for flowability of pulse electric field treated milk protein concentrate.

FIG. 17 is a graph illustrating apparent viscosity of pulse electric field-treated micellar casein concentrate.

FIG. 18 is an interaction profiler for a consistency coefficient of pulse electric field-treated milk protein concentrate.

FIG. 19A is a three-dimensional plot illustrating the mutual effects of electric field intensity and temperature on a consistency coefficient of pulse electric field-treated micellar casein concentrate.

FIG. 19B is a three-dimensional plot illustrating the mutual effects of electric field intensity and temperature on a consistency coefficient of pulse electric field-treated micellar casein concentrate.

FIG. 19C is a three-dimensional plot illustrating the mutual effects of temperature and frequency on a consistency coefficient of pulse electric field-treated micellar casein concentrate.

FIG. 19D is a three-dimensional plot illustrating the mutual effects of frequency and temperature on a consistency coefficient of pulse electric field-treated micellar casein concentrate.

FIG. 19E is a three-dimensional plot illustrating the mutual effects of electric field intensity and frequency on a consistency coefficient of pulse electric field-treated micellar casein concentrate.

FIG. 19F is a three-dimensional plot illustrating the mutual effects of electric field intensity and frequency on a consistency coefficient of pulse electric field-treated micellar casein concentrate.

### DETAILED DESCRIPTION

The concepts disclosed in this discussion are described and illustrated with reference to exemplary arrangements. These concepts, however, are not limited in their application to the details of construction and the arrangement of components in the illustrative embodiments and are capable of being practiced or being carried out in various other ways. The terminology in this document is used for the purpose of description and should not be regarded as limiting. Words such as “including,” “comprising,” and “having” and variations thereof as used herein are meant to encompass the items listed thereafter, equivalents thereof, as well as additional items.

While the system and methods disclosed herein may be embodied in many different forms, several specific embodiments are discussed herein with the understanding that the embodiments described in the present disclosure are to be considered only exemplifications of the principles described herein, and the disclosed technology is not intended to be limited to the examples illustrated.

As briefly described above, milk protein concentrates (MPC) and micellar casein concentrates (MCC) are milk-derived high-protein ingredients or compositions that are used in a variety of products. Such products can include, for example, high-protein beverages, bars, and yogurts, among other end-use products. In general, MPC and MCC are regarded as having excellent nutrition quality. However, because of its low solubility, poor gelling behavior, and formation of insoluble aggregates, MPC often results in caking and reduced rehydration issues during storage. MCC, on the other hand, has issues with processing as it cannot be concentrated higher than 32% before spray drying, thus making MCC an expensive ingredient in the market due to the higher energy used in the spray drying process. These complications are caused mainly due to protein-protein interactions and higher calcium content in milk proteins resulting in their aggregation during storage and processing.

During MPC manufacturing processes, whole milk may be first separated into cream and skim milk. The skim milk can then be fractionated using ultrafiltration to make a skim concentrate that is lactose reduced. This process separates milk components according to their molecular size. Milk then passes through a membrane that allows some of the lactose, minerals, and water to cross through. The casein and whey proteins, however, will not pass through the membrane due to their larger molecular size. The proteins, lactose, and minerals that do not go through the membrane can then be spray-dried. Spray drying and evaporation can further concentrate the remaining minerals to form a powder. Depending on the purpose of the final product, different treatments can be used to process ultrafiltered or blended varieties of MPC. For example, pulsed electric field (PEF) is a nonthermal processing technique that involves the application of a high voltage electric field for a short time in between two electrodes.

The present disclosure provides systems and methods of controlling treatments to process varieties of milk protein concentrate and micellar casein concentrate. In particular, embodiments of the disclosure provide systems and methods for controlling, customizing, and selecting or optimizing functional properties of MPC and MCC. Such functional properties can include, for example, rehydration, surface, and rheological properties, among others, as described below.

Some treatments of milk proteins, including pulsed electric field treatments, have shown a reduction in the size of casein micelle structure and partial unfolding of the secondary structures leading to changes in their functional properties. Thus, embodiments of the present disclosure provide systems and methods of controlling treatments, such as pulsed electric field treatments and cold plasma treatments, to modify and customize the functional properties of MPC and MCC. Further, embodiments of the present disclosure can provide control methods to adjust the viscosity of liquid concentrates based on modifications in the casein micelle structure. In general, the reduced viscosity can allow higher concentrations of MCC (e.g., greater than 32%) before spray drying, which can decrease time, energy, and cost spent on evaporation and spray drying processes.

In general, dairy proteins have functional properties which can refer to the ability of the proteins to have desired characteristics or properties. Such characteristics or properties can include, for example, foaming, emulsification, solubility, gelling, and rheology. The performance of these functional properties can depend on factors such as the molecular structure of the protein and the solvent used to dissolve the protein. It can also depend on the concentration of the protein in the formulations, environmental factors like pH, temperature, ionic strength, and the composition of the dairy proteins. Thus, alteration of any one of the factors would create a change in the functional property of the dairy protein. As structural changes impact the functionality of the protein, it may be advantageous to alter the structure of the protein.

The functional properties of milk protein concentrate and micellar casein concentrates are affected based on the composition (e.g., protein content) and type of processing method used in the manufacturing of some spray-dried powders. This decreases the stability of the proteins to be used in various applications. MCC is prone to have issues during processing due to its high viscosity during concentration and hence leading to higher energy for spray drying. PEF can be used as a nonthermal preprocessing and post-processing technique to alter dairy proteins. A desired treatment of PEF ensures a partial unfolding of proteins for desired characteristics. By altering processing parameters, such as, for example, electric field strength, temperature, frequency, and duration of a PEF treatment, the casein micelle voluminosity can be altered to modify its functional properties. In some embodiments, the duration may be consistent across different property modification processes.

The systems and methods of the present disclosure can provide a wide range of parameter controls to customize the proteins according to the desired functional properties and enhance the export of milk protein powders globally. Parameters described herein can adjust a variety MPC and MCC characteristics, such as solubility, foaming, emulsion, heat stability, viscosity, or gelation by modifying the structure of the proteins (e.g., caseins). Further, embodiments of the invention can provide desired or optimum multi-parameter conditions from PEF that can be used to treat MPC (e.g., MPC85) for customizable usage in a high-protein beverage formulation. These modifications can increase the shelf-life storage of the milk proteins thereby aiding the export business of these products, among other benefits.

Some conventional approaches to adjust characteristics of milk proteins can include mechanical methods, such as high shear treatment and thermal processing of MPC. However, these processes are complex, time intensive, and costly. In addition, these processes lower the nutritional quality of proteins. Other conventional methods may include enzymatic and chemical modification. This process can involve transglutaminase cross-linking of protein, which might enhance the rheological properties. However, again, these processes can be complex, time intense, and expensive.

Pulsed electric field technology, as briefly described above, can be used as a method to modify the structure of protein molecules. The working principle involves the usage of short electric pulses onto a sample when it is placed in between the two electrodes. With the application of pulses, short ohmic heating is produced thus characterizing it as a nonthermal process. Nonthermal processing involves an exothermic reaction in most cases leading to heat generation in the process. However, the change in temperature (ΔT) for the process is lower in comparison to conventional thermal processing methods. Hence, these processes are termed nonthermal process. The critical factors into consideration for a PEF treatment include product conductivity, treatment temperature, electric field strength or intensity, frequency of pulses, output voltage, and pulse width. Changing the range at which each of these factors are operated, the PEF treatment can induce desired changes in the protein. In general, PEF can provide an enhanced efficiency drying process that improves the extraction process and enzymatic activity to preserve foods for longer shelf life of solid, liquid, and semi-solid foods. PEF also increases surface hydrophobicity, lessens unfolding or denaturation, and protects protein functionality like gelation and viscosity at a higher degree in comparison to thermal treatments for dairy proteins.

In general, pulsed electric field technology can be widely used for the manufacturing of dairy protein powders like milk protein concentrate and micellar casein concentrate with desired functional characteristics which are suitable for various applications in the dairy industry. Embodiments of the invention can provide methods of controlling milk protein concentrate and micellar casein concentrate production and post-processing treatment that involves less energy, low-temperature processing, lesser carbon footprint, and minimal processing of foods with high retention of nutrition and flavor of the proteins when compared to conventional methods.

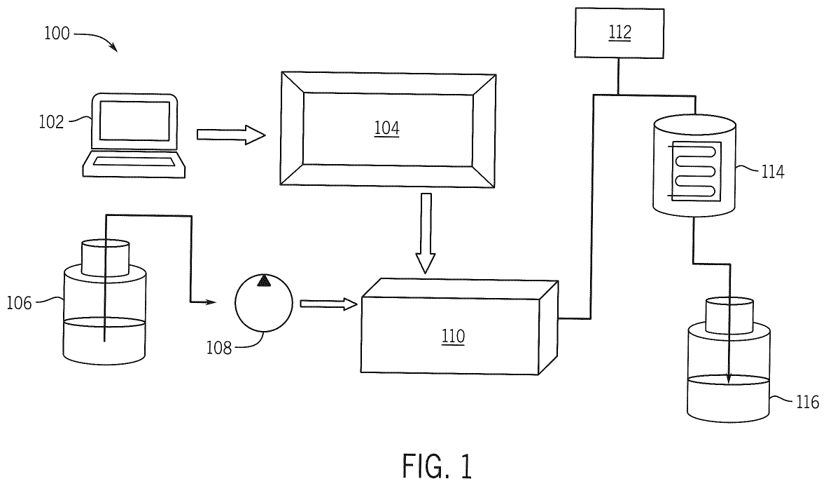

With reference now to FIG. 1, a schematic outline of a pulsed electric field (PEF) process 100 is shown. The process 100 is a non-thermal processing technique that uses short, high voltage pulses. In general, PEF is a fast, targeted, flexible energy-efficient process with minimized heat application. A PEF system can include a control and monitoring system 102 (e.g., a controller) in communication with a pulse generator 104. The process 100 can include the input of a raw material (e.g., milk) or other pre-treated product, such as a pre-treated milk product 106 (e.g., MPC or MCC). A pump 108 or other transport mechanism can move the milk product 106 to a treatment chamber 110. The control and monitoring system 102 can signal the pulse generator 104 to send high-voltage pulses to the treatment chamber 110.

The control and monitoring system 102 can be configured to control a variety of parameters of the PEF process 100. For example, an electric field generated by the pulse generator 104 can depend on the applied electric voltage, a distance between electrodes, or pulse width and waveform. Other parameters controllable by the control and monitoring system 102 can include intensity, frequency, or duration. In some examples, the PEF process 100 can include one or more temperature chambers or temperature controllers 112 to control the temperature of various components or products within the PEF process 100. For example, one or more temperature controllers 112 can adjust temperature of electrodes of the pulse generator 104 or treatment chamber 110. In some examples, the temperature controllers 112 can be in communication with the control and monitoring system 102 and can be utilized during batch or continuous processing to meet temperature requirements or inputs consistent with desired output characteristics.

Relatedly, the PEF process 100 can further include one or more heat exchangers 114 that can include cooling coils, for example. The heat exchangers 114 can be used in the precise temperature metering of milk protein samples moving through the PEF process 100. The PEF process 100 can be configured to produce a treated product 116 (e.g., a treated protein powder). The treated product 116 can include protein products, such as treated milk protein concentrates (MPC) or micellar casein concentrates (MCC). The treated product 116 can be selected or optimized to include desired functionality and aspects according to particular product applications.

In general, a PEF process can advantageously provide a variety of target characteristics of protein output. For example, PEF processes can allow for varying degree of protein folding (or unfolding), can maintain or modify protein structure, and can increase or decrease functional properties of the output protein. Thus, PEF processes, such as the process 100 illustrated in FIG. 1, can allow for a variety of customizable inputs to produce desired or optimal protein product outputs.

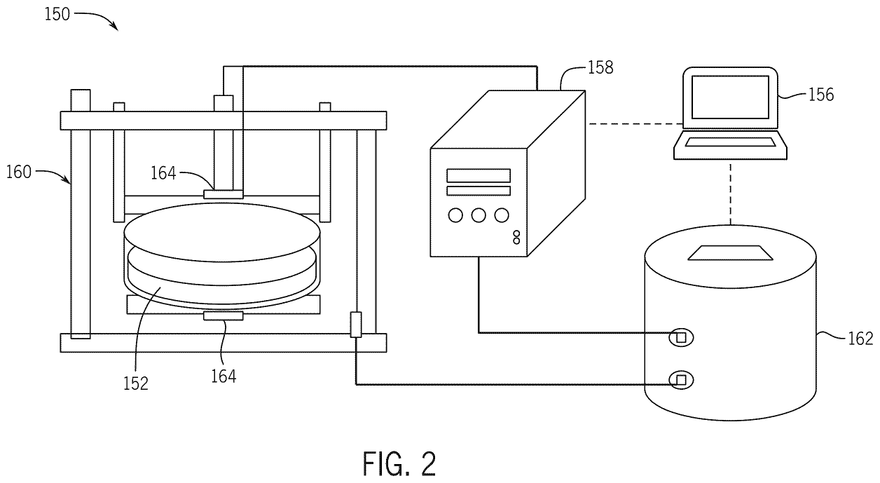

FIG. 2 illustrates another process 150 for treating a milk product 152 (e.g., MPC powder or MCC powder) and producing a post-treated milk product (e.g., a treated protein powder) that can be selected or optimized to include desired functionality and aspects according to particular post-treatment product applications. The process 150 can be configured as a cold plasma treatment process. In general, cold plasma is a non-thermal processing technology that uses energetic, reactive gasses. The process 150 can include a control and monitoring system 156 (e.g., a controller) in communication with a plasma generator 158. The plasma generator 158 can be in communication with a treatment chamber 160. The control and monitoring system 156 can send signal to the plasma generator 158 and a voltage regulator 162 to treat a milk product 152. The cold plasma system illustrated in FIG. 2 can further include a pair of electrodes 164 generally positioned on opposing sides of the of the milk product 152.

A cold plasma system can advantageously produce a milk product output having a variety of target or optimal characteristics. In this regard, a cold plasma process can affect the functionality of milk protein concentrate and produce structural and compositional changes in the protein structure. Like the pulsed electric field process described above, the cold plasma process is a non-thermal process.

In general, each of the processes 100 and 150 described above can output treated dairy protein concentrates, including protein powder, that can have desired or optimized protein functionality according to desired functional properties. Such functional properties can include one or more of optimized solubility (or insolubility), foaming capacity, foaming stability, or flowability, among other characteristics.

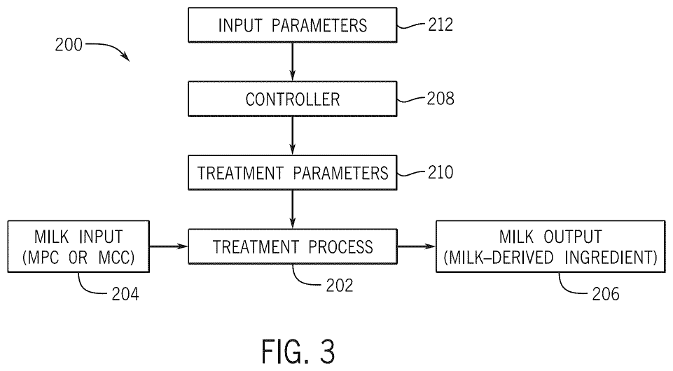

With reference now to FIG. 3, a system 200 for modifying dairy protein functionality is shown. The system or process 100 can include a sub-system or treatment process 202 configured to receive an input 204 to treatment and produce an output 206. More specifically, according to embodiments of the present disclosure, the treatment process 202 can be the PEF process 100 or the cold plasma process 150 described above, and the input 204 can be the milk product input, such as the inputs 106, 152 described above with respect to FIGS. 1 and 2, respectively. The system 200 can further include a controller 208, which may be configured as, or in communication with, the control or monitoring systems 102 or 156 of the processes 100 or 150, respectively.

In this regard, in use, a milk product input 204 can undergo a treatment process 202 according to one or more treatment parameters 210 to produce a milk protein product output 206. The treatment parameters 210 can be set via the controller 208 to govern the treatment process 202. The treatment parameters 210 can dictate one or more variable values of the treatment process, such as, for example, electric field strength, pulse width, current, frequency, temperature, or duration of the treatment process 202. In particular, treatment parameters for a pulsed electric field treatment can include, among others, duration, electric field strength, current frequency, and temperature. Likewise, treatment parameters for a cold plasma treatment can include, among others, duration, gas selection, gas flowrate, and power. The controller 208 can set or adjust the treatment parameters 210 based on one or more input parameters 212.

In some embodiments, the input parameters 212 may be user input parameters or otherwise parameters targeted toward a desired product output 206 characteristics. In one embodiment, the input parameters may be directly linked to process variables of the treatment process 202, such that an input parameter 212 is directly, for example, a temperature or an electric field strength input. However, in other examples according to embodiments of the present disclosure, the input parameters 212 can include a variety of indirect parameters, which can correlate to controllable variables (i.e., treatment parameters 210) of the treatment process 202. For example, an input parameter 212 may correlate to an end-use of the milk protein powder output 206. In this regard, by way of example, an input parameter 212 may be producing a milk concentrate output 206 selected or optimized for baby formula production.

In other non-limiting examples, input parameters 212 for the system 200 for modifying dairy protein functionality can include other end-process uses, such as milk protein powder for high-protein beverages, protein bars, whey protein powder, infant protein powder or liquid, and other consumables. Further, the input parameters 212 can include correction or improvement factors related to environmental factors of either the system 200 or other post-processing environments. Such environmental factors can include, for example, temperature, pressure (e.g., altitude), humidity, pollutants, or light exposure. Input parameters 212 can also be used to account for time factors related to shipping, storage, or manufacturing processes of the end-treatment of the milk product output 206. It should be appreciated that any combination of input parameters 212 can be used to customize the milk product output 206 for a variety of customer and product requirements or desires.

In general, input parameters 212 can affect a variety of characteristics of the milk product output 206. These characteristics, which can be selected or optimized according to output need, can include selection or optimizations of one or more of powder particle size, product flowability, product foaming stability, product wettability, water binding capacity, solubility, isoelectric point, pH, water activity, dry mass, purity, color, or moisture content. Other output characteristics, which in some embodiments may be specific to pulsed electric field processing, can include foaming capacity, emulsion stability, water holding capacity, and gelation.

The controller 208 can include a computer (e.g., computing hardware and software) that can accept and analyze one or more input parameters 212 and control aspects of the treatment process 202 to produce a milk product output 206 according to guidelines of the input parameters 212 to produce a product that is suitable for a particular application.

Accordingly, embodiments of the invention can provide control methods of MPC and MCC processing to modify functional properties of dairy proteins for producing powders with target functionality. For example, various products (e.g., end products) may have different desired or optimal property requirements of dairy proteins. In particular, by way of example, different dairy protein properties may be desirable for protein beverages compared to protein bars compared to baby formula, etc. Furthermore, different processing methods and factors, such as environmental factors (e.g., temperature, humidity, pollutants, etc.) or manufacturing parameters or requirements may dictate desired or optimal specifications for milk protein. Thus, embodiments of the present disclosure provide a method of controlling the production of milk proteins based on desired or optimization parameters that may vary based on desired output characteristics or capabilities of the MPC or MCC.

In some instances, MPC can undergo one or more treatment processes, including post-treatment processes and pre-treatment processes. Likewise, MCC can undergo one or more pre-process treatments. In MPC treatment processes, the treatment can be used to alter or modify the proteins present in the MPC (e.g., MPC powder). In MCC treatment processes, the treatment can be used to alter or modify certain properties of the MCC, including viscosity.

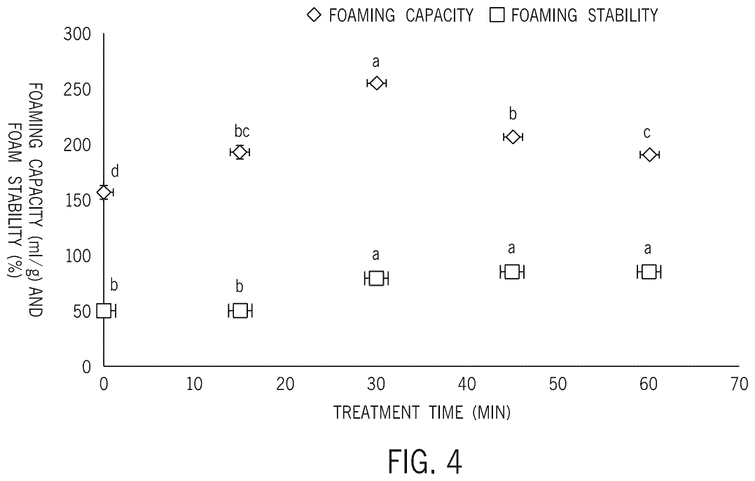

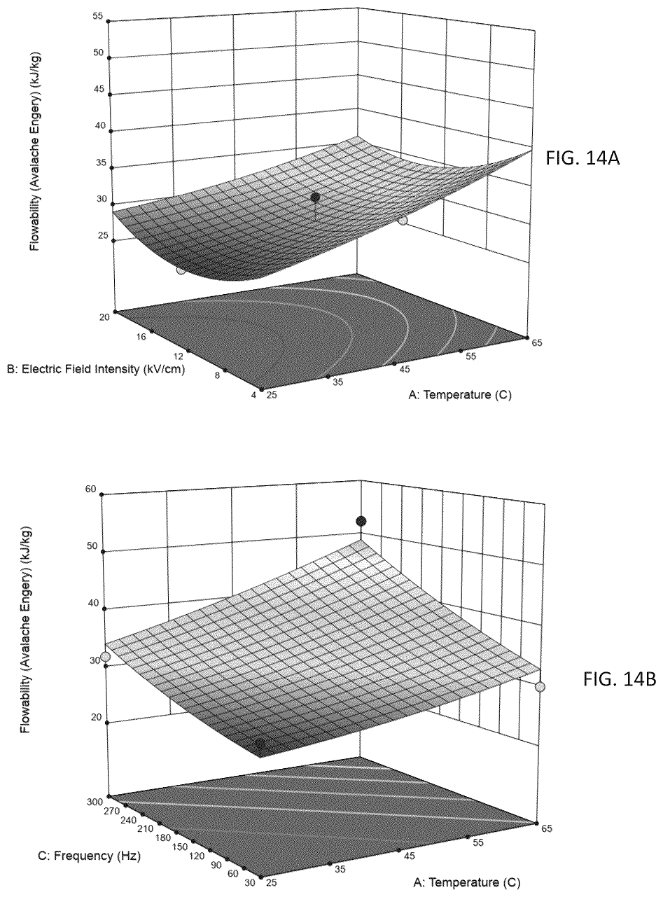

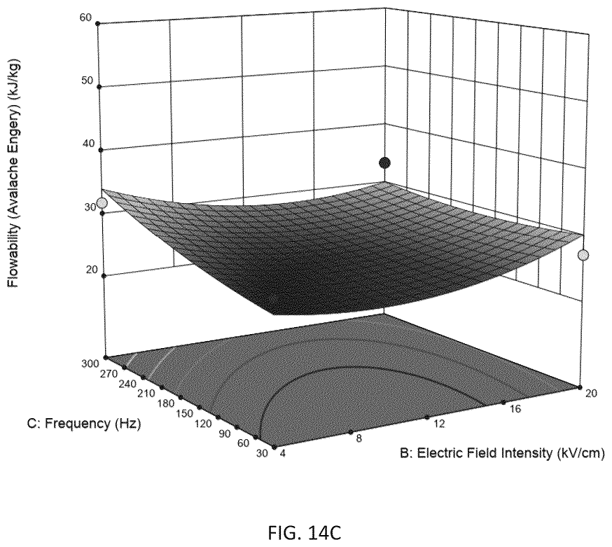

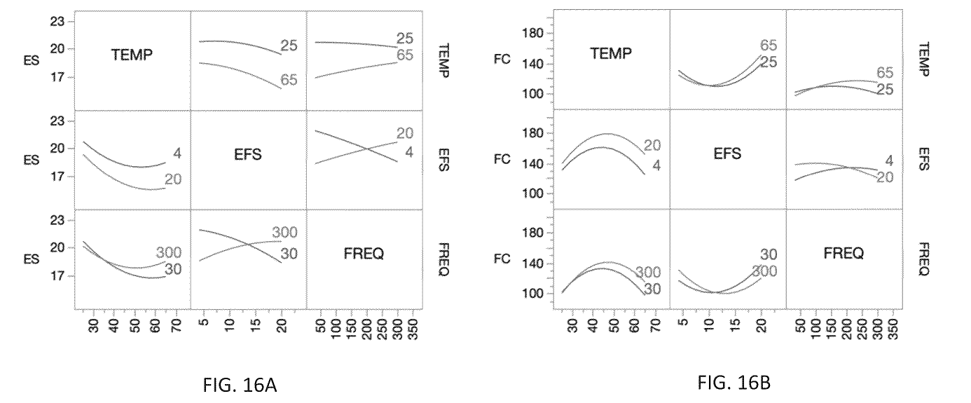

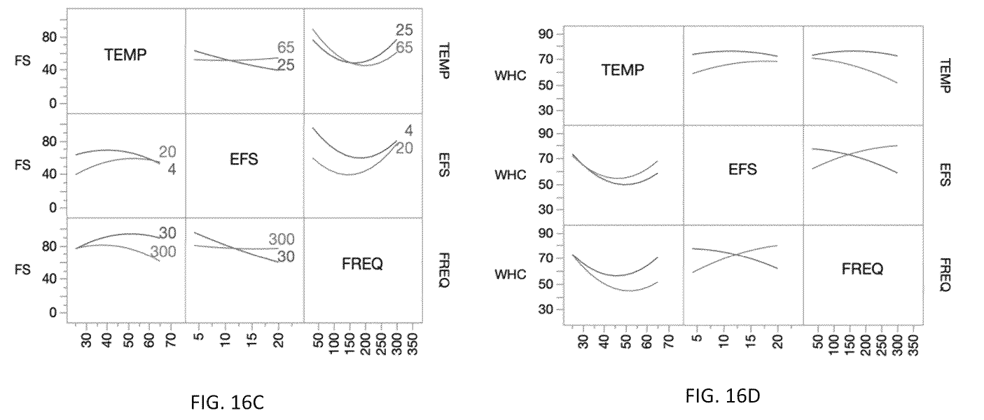

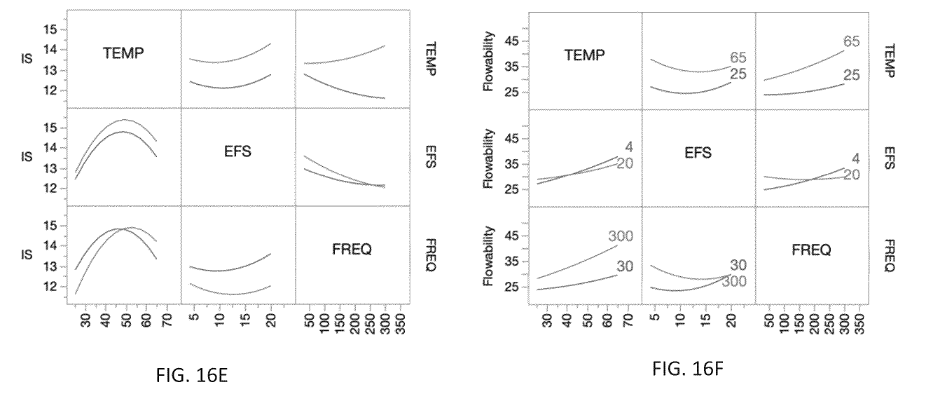

By way of example, FIGS. 4-19 illustrate graphical representations of effects on milk protein outputs versus adjusting process parameters of a treatment process, such as the processes 100 and 150 described above. For example, FIG. 4 illustrates variations in foaming capacity and foaming stability of a milk product output by adjusting treatment time in a treatment process, such as cold plasma. With reference to FIG. 4, the data indicates that a desired or optimal foaming capacity may occur at a different (e.g. lower) treatment time compared to a desired or optimal foaming stability.

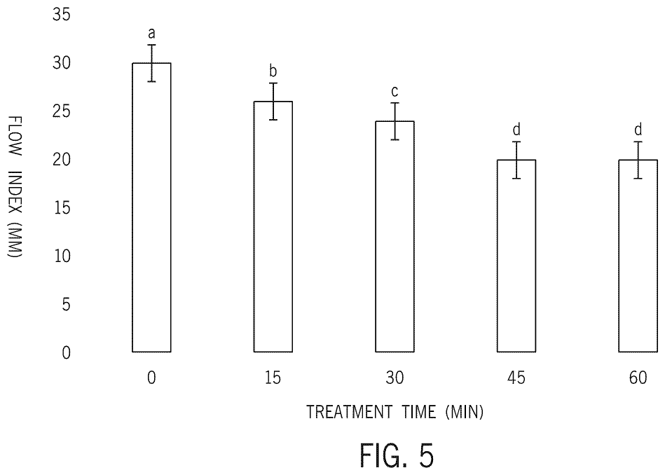

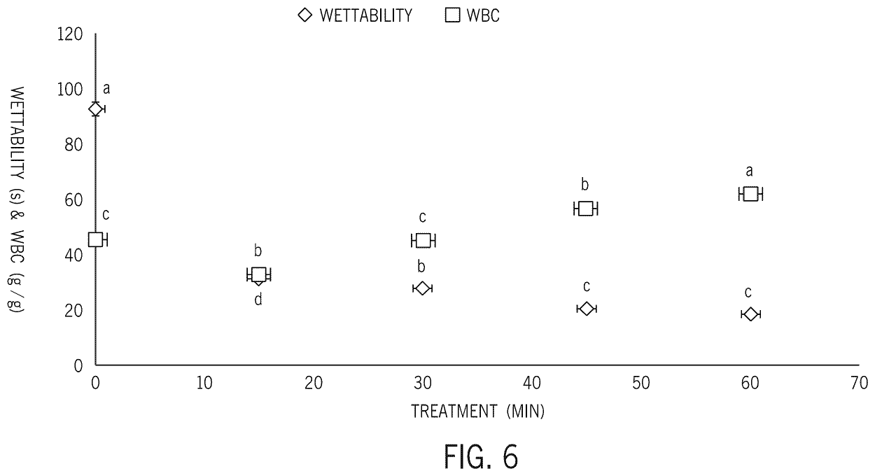

FIG. 5 illustrates a flowability effect of treating a milk product for varying treatment times in a treatment process, such as cold plasma. In particular, FIG. 5 indicates a decrease in flow index of a treated milk protein as treatment time increases. FIG. 6 illustrates effects of wettability and water binding capacity (WBC) of a treated milk product for varying treatment times. FIG. 6 indicates that a desired or optimal measure of wettability may occur at a different treatment time than a desired or optimal measure of water binding capacity of a milk product output.

Pretreatment with Pulsed Electric Field Processing to Improve Milk Protein Concentrate (e.g., MPC85) Functionality with Response Surface Methodology.

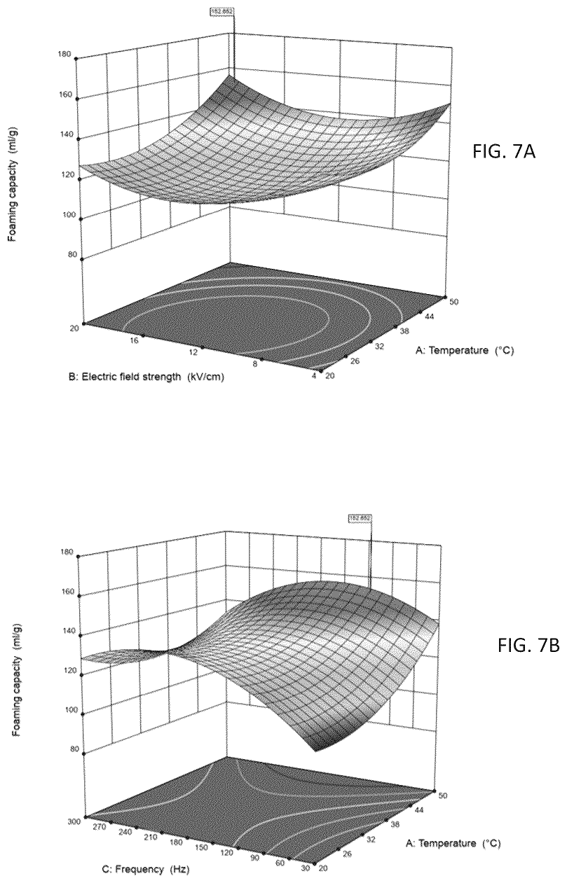

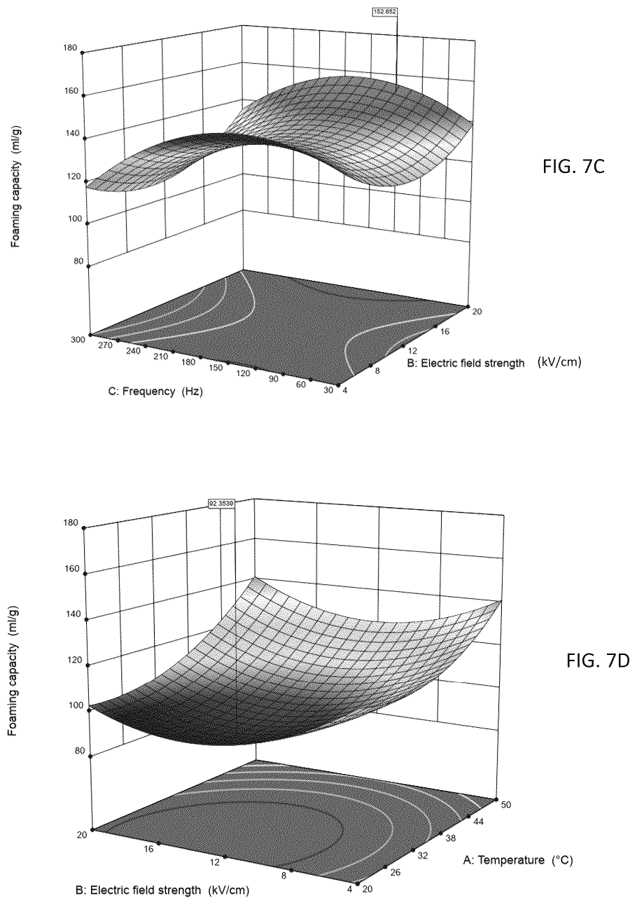

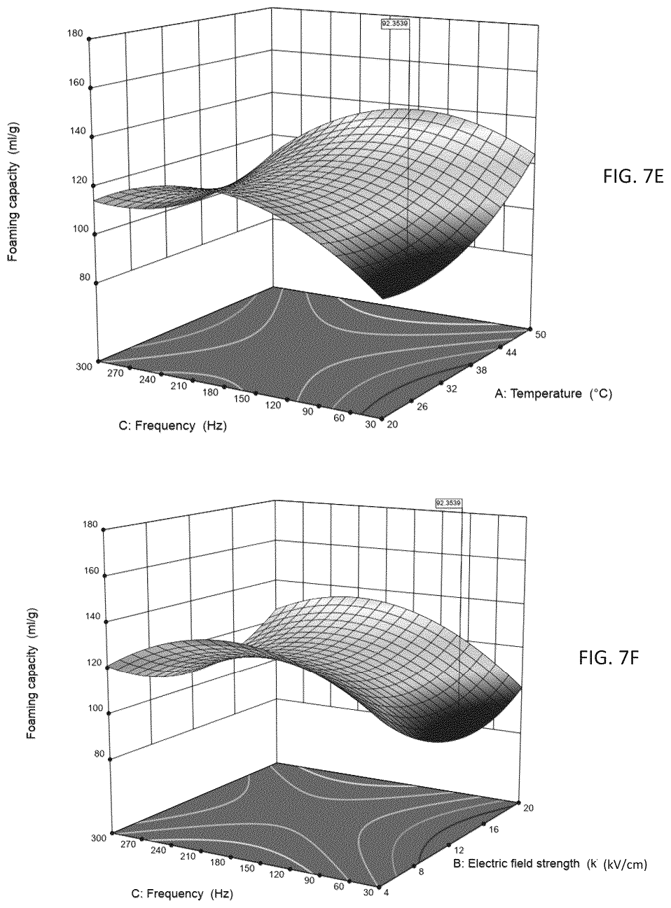

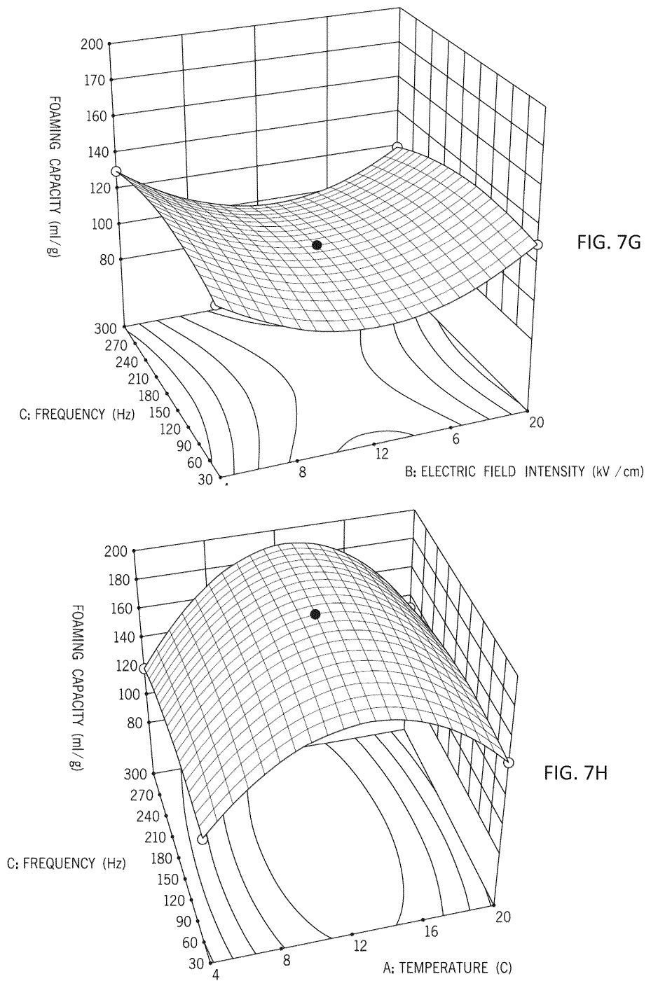

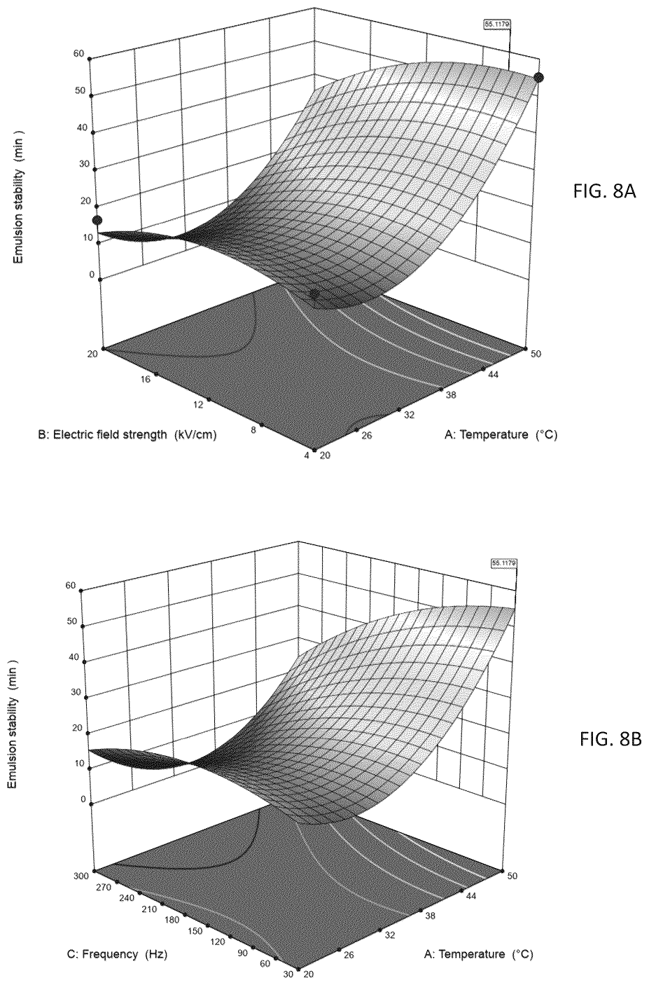

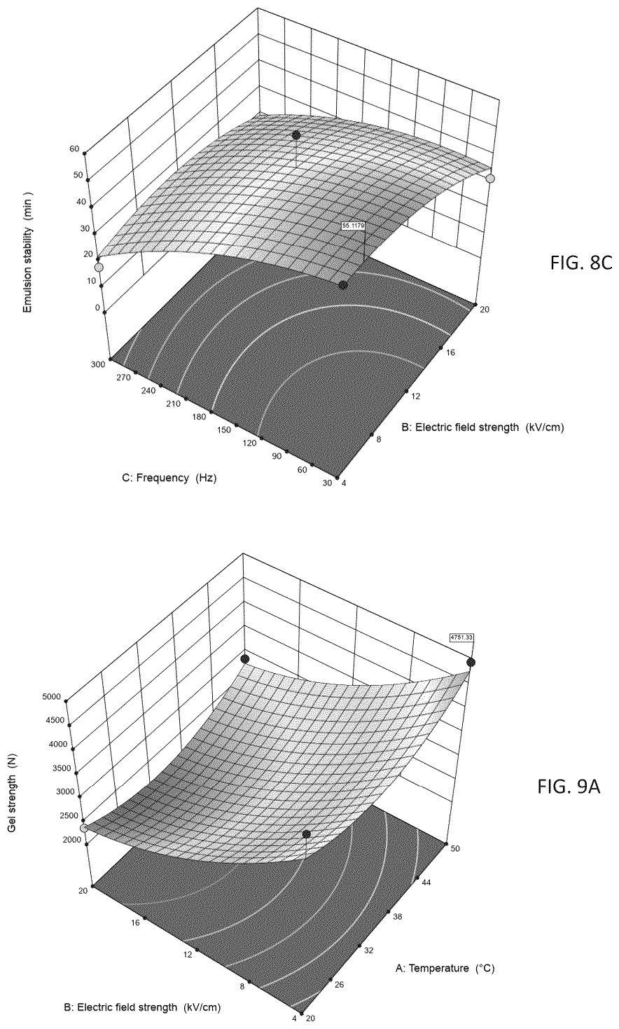

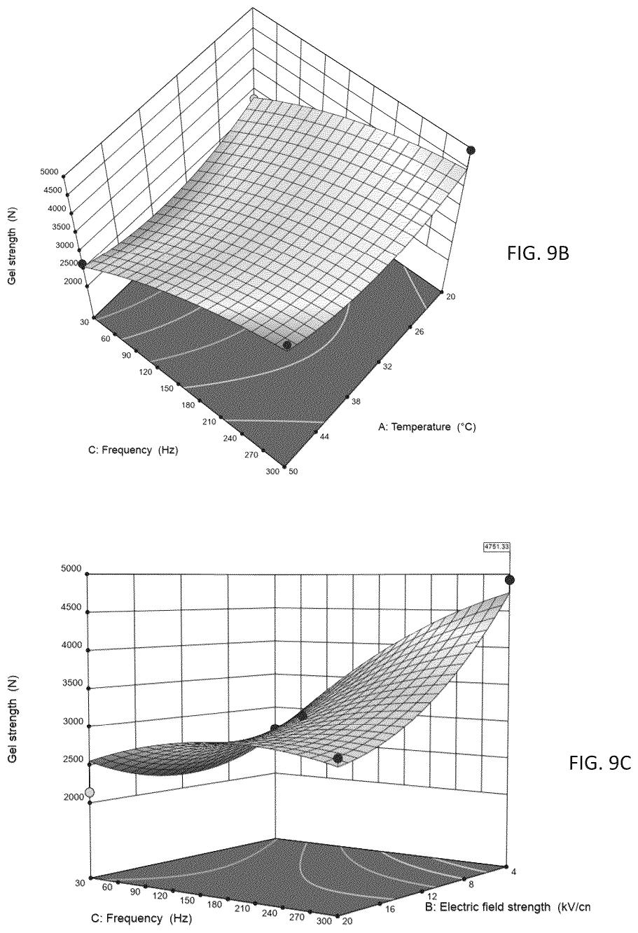

FIGS. 7A-7H illustrate the effects of various treatment parameters on a foaming capacity of a milk protein concentrate treated with a treatment process (i.e., pretreated PEF of MPC85). FIGS. 8A-8C illustrate the effects of various treatment parameters on emulsion stability for pretreated MPC 85. FIGS. 9A-9C illustrate the effects of various treatment parameters on gel strength for PEF pretreated MPC85.

Milk protein concentrates (MPC85—85% protein) are high-protein dairy ingredients significantly used in various food products. Achieving specific functionality attributes with MPC85 is a significant challenge, leading to performance limitations when incorporated in end-product formulations. To overcome this shortcoming, Pulsed Electric Field (PEF) processing has been explored in this study, which has been known to cause changes to the protein behavior and, hence, changes to the functionality. This study explores the impact of PEF processing on the functional properties of liquid MPC85, such as insolubility index, foaming, emulsion stability, flowability, gel strength, and water-holding capacity. Optimization of process parameters to attain the desired functionality was performed using response surface methodology. Critical process parameters such as temperature (ranging from 25° C. to 50° C.), electric field strength (EFS) (ranging from 4 kV/cm to 20 kV/cm), and frequency (ranging from 30 Hz to 300 Hz) of PEF treatment were investigated. The data derived from the experimental design are fitted into polynomial equations and utilized for individual optimizations for foaming capacity, emulsion stability, and gel strength, as well as multiparameter optimization for specific end-use applications. The optimum PEF processing conditions for bar and whipped cream applications are determined to be, 48° C. temperature, 18 kV/cm Electric Field Strength (EFS), and 30 Hz frequency, whereas for beverage applications, they are found to 32° C. temperature, 12 kV/cm Electric Field Strength (EFS), and 30 Hz frequency and for soups and salad dressing 48° C. temperature, 8 kV/cm EFS, and 300 Hz frequency. These developed models serve as practical tools for optimizing and customizing the functionality of MPC85 using PEF during the manufacturing process.

The protein ingredients market is slowly taking over new and innovative products to meet the consumer demands for nutritious food products. Consumers are looking for options to supplement their daily needs for protein consumption through dairy products.

Milk proteins are preferred over other proteins as an ingredient for various food products in the market due to its high nutritional value and key functional characteristics. There are different categories of milk proteins available in the market, mainly whey protein concentrates and isolates, milk protein concentrates and isolates, and caseinates. Milk protein concentrates are manufactured from skim milk with the removal of lactose followed by ultrafiltration and diafiltration. These are classified based on varying amounts of protein in the sample, ranging from 35% protein to 85% protein. Milk protein concentrates contain both whey and casein proteins in their native form. Due to its lower lactose content, it has been in demand as it can minimize any product defects like browning due to Millard reactions or sandiness due to lactose crystallization.

One major problem associated with high protein powders is low solubility. This decreases the stability of the proteins to be used in various applications. Enzymatic and chemical modifications were developed to address the issues with the functional properties of milk proteins. However, these methods have limitations, such as high costs for enzymes or chemicals used, time and temperature requirements and clean label considerations. Hence, there is a need to venture into other processing methods to modify dairy proteins.

Nonthermal processing, like the pulsed electric field, has been studied to improve the quality of proteins in foods. They also fulfill the expectation of minimally processed foods by color retention, flavor, and reduced processing times. Pulsed electric field has a significantly reduced treatment time. Hence, the current research was focused on using pulsed electric fields as a method to modify the structure of protein molecules. The working principle involves the usage of short electric pulses onto the sample when placed between the two electrodes. With pulses, quick ohmic heating is produced thus characterizing it as a nonthermal process. Nonthermal processing involves an exothermic reaction, which, in most cases, leads to heat generation. However, the change in temperature (ΔT) for the nonthermal processes is lower in comparison to conventional thermal processing. Hence, these processes are termed nonthermal processes. The critical factors for a PEF treatment include product conductivity, treatment temperature, electric field strength or intensity, frequency of pulses, output voltage, and pulse width. Changing the range at which these factors are operated, the PEF treatment will induce the desired changes in the protein.

PEF may be advantageous in various aspects, which include shelf-life extension, nutrient and quality preservation, and low-cost efficiency of the treatment. Few studies have shown that PEF can also cause structural and functional modifications to food proteins. PEF has also been proven to increase surface hydrophobicity and lessen unfolding or denaturation. It protects protein functionality like gelation and viscosity more than thermal treatments for dairy proteins. The main advantage of PEF processing is the ability of the treatment to maintain or marginally modify the natural dietary and sensorial aspects of proteins. PEF can also improve energy and cost-saving to the dairy industry. Although several studies are indicating the effect of PEF on milk proteins, they conflict with each other due to variations in the PEF systems and process conditions. To get a better understanding of modifications caused by PEF on milk proteins, a structured experimental design and process optimization should be conducted. In addition, these studies did not capture the customization of milk protein functionality for targeted applications.

The main goal of this study is to understand the improvements to milk protein concentrate 85 subjected to pulsed electric fields. This would only require adding step as treatment step during the inline processing of MPC85 to produce MPC85 with varied and improved functionality according to product specifications. Functional characteristics of protein powders play a significant role in product formulations. The performance of these functionalities depends on factors such as the molecular structure of the protein and the solvent used to dissolve the protein. It also depends on the protein concentration in the formulations, environmental factors like pH, temperature, ionic strength, and composition of the dairy proteins. Thus, alteration of any one of the factors would create a change in the functional properties of the dairy protein. As structural changes impact the protein's functionality, the approach for alteration in protein structure is currently widely used in industries through thermal treatment, chemical, and enzymatic modifications. These modifications can increase the shelf-life storage of the milk proteins thereby aiding the export business of these products.

### Materials and Methods

2× Laemmli sample buffer, Precision plus protein standard, TGX Precast Gels (4-20%), and 10× Tris/Glycine/SDS Buffer was obtained from Bio-Rad Laboratories (Hercules, CA). Imperial™ protein stain was purchased from Thermo Scientific (Waltham, MA). Calcium Chloride Anhydrous (CaCl₂)) from Fisher Scientific (Waltham, MA), β-mercaptoethanol, and Sodium Dodecyl Sulfate from Sigma Life Sciences (St. Louis, MO) were used.

A commercial sample of liquid milk protein concentrates (MPC85) at 12% TS was obtained after the filtration process and subjected to pulsed electric treatment based on the experimental design. To examine the effect of PEF on milk protein concentrate 85, the samples were subjected to various conditions of temperature, electric field strength, and frequency. The conditions were set between ranges temperature: 20 to 50° C., electric field strength: 4 to 20 kV/cm, and frequency: 30 to 300 Hz based on a previous study. The following parameters were constant throughout the study: flow rate at 112l/h, pulse width at 20 μs, and electrode gap at 10 mm. To understand the heat generated by the system, the inlet and outlet temperatures were monitored. For each treatment, 11.33 kg of 12.38% TS was fed into the heat exchanger (Direct/Indirect UHT/HTST Series, Microthermics®, Raleigh, NC) to maintain the temperature followed by PEF treatment. The liquid sample was then subjected to PEF treatments using an industrial scale continuous PEF system (ELEA El-Crack®, HVP 5, German Institute of Food Technologists, Quakenbruck, Germany), and conditions for the process were customary based on the experimental design. After the PEF treatment, the samples were spray dried using a Compact spray dryer type 1 (APV Anhydro, Tonawanda, NY). The inlet temperature was set to 170° C., the outlet to 96° C., and the atomizer speed at 2500 rpm to prevent the use of higher heat in the dryer. The efficiency and yield of the spray dryer were calculated by weighing the amount of sample before and after spray drying. The amount of sample after The PEF system was cleaned and flushed with water after each run-in to prevent cross-contamination. Control samples without treatment at 20, 35, and 50° C. were also fed through the heat exchanger and passed through the PEF system (in off state) to control the environmental parameters concerning the treatment. All the spray dried (PEF treated and control) samples were stored in polythene bags in a temperature-controlled room at 25° C. for further analysis.

TABLE 1.1
Natural and coded levels of independent and dependent
variables pulsed electric field processing of
liquid milk protein concentrate (MPC85)

| Independent variables | Coded levels | | |
|---|---|---|---|
| | −1 | 0 | +1 |
| | Natural levels | | |
| Temperature (° C.) | 20 | 35 | 50 |
| Electric field strength (kV/cm) | 4 | 12 | 20 |
| Frequency (Hz) | 30 | 165 | 300 |

### Solubility

For solubility measurement, 6% protein solutions were made by mixing the spray dried powder samples at 22° C. for 1 hour using a magnetic stirrer. The solution was then transferred into 50 ml centrifuge tubes and centrifuged at 700 g for 10 min. After the centrifugation step, the supernatant was transferred into another tube to measure the weight of the supernatant. The total solids of the sample were calculated using total solids measurement from the CEM Smart Turbo Moisture (CEM Corporation, Charlotte, NC) analyzer, which works on the principle of microwave technology. The solubility of the sample was then calculated using the following expression.

Weigh of the supernatant=‘A’ grams

Percentage solids of the supernatant=‘B’ %

$$Total soluble solids in the suprnatant = ( A * B ) / 100 = C \% Solubility = \frac{Total soluble solods in the supernatant}{Grams of initial powder ( g )} \times 100 \qquad ( 1.1 )$$

### Foaming Capacity and Stability

For foaming capacity and stability, 12% protein solutions were prepared and transferred into a kitchen aid mixer (Whirlpool Corporation, Benton Harbor, MI) to incorporate air while mixing using the whipping attachment. The solution was mixed for a brief period of 2 min and then immediately transferred into a measuring cylinder. The initial liquid and foam levels were recorded, and the timer was started for 30 min. After 30 min, the final liquid and foam levels were recorded for calculations.

Volume of foam (ml)=Total volume of the solution with foam−Total liquid volume

$$Foaming capacity = Initial foam volume ( ml ) / g of protein in the solution . \qquad ( 1.2 )$$

$$Foaming stability ( \% ) = Final foam volume / Initial foam volume \qquad ( 1.3 )$$

### Emulsion Stability

Emulsion stability was evaluated by measuring the turbidity of the oil medium. 30 ml of 0.1% protein solutions (25.5 mg of protein) were stirred overnight at 600 rpm. 5 ml of that protein solution was added with 1.67 ml of pure corn oil and was homogenized utilizing Ika ULTRA-TURRAX® Tube Drive UTTD (IKA Works Inc., Wilmington, NC) at maximum speed of 600 rpm for 1 minute. The turbidity of the sample was measured using a spectrophotometer (Schmedzu) at 500 nm. The samples were held for 10 min, and the final turbidity was measured again.

$$Emulsification Stability E S ( minutes ) = \frac{Initial absorbance}{( Initial absorbance - Final absorbance )} 10 min . \qquad ( 1.4 )$$

### Gel Strength

The gel strength was measured using rennet-induced gelation. For the preparation of Chymosin, 1:60 dilution was prepared, and 2.72 mM of CaCl₂) was added to strengthen the gels. 10 ml of 15% TS solution was prepared and mixed for 30 min and transferred into a 65° C. water bath for 5 min. The samples were taken out and equilibrated to 30° C. 5 ml of this solution was transferred into 15 ml centrifuge tubes, and 250 μl of 2.72 mM of CaCl₂) was added-further 250 μl of 1:60 dilution of 1000 IMU chymosin to the test tube. The samples were vortexed for 5 sec, and immediately, 1 ml was transferred into Eppendorf tubes. The samples were moved into a water bath at 30° C. for 30 mins. After 30 min, the samples were cooled down to ambient temperature. The tip of the Eppendorf tube and the gels were transferred into a glass plate. The gels were analyzed using a texture analyzer (TA. TX plus, Stable Micro Systems, Surrey, United Kingdom) to calculate gel strength utilizing the amount of force required to break the gels.

### Water Holding Capacity

For water holding capacity, a similar procedure to gel strength was carried out with minor modifications. However, after the gelation step, the samples were centrifuged at 1000 g for 5 min. The weight of the gels before and after centrifugation to eliminate water was estimated to determine the water-holding capacity of powders. The water-holding capacity of protein powders is calculated as follows,

$$Water holding capacity ( \% ) = \frac{Sample mass after the removal of excess water}{Initial sample mass} \times 100 \qquad ( 1.5 )$$

### Protein Profiling

Protein profiles of MPC85 samples were performed using the following method. 10 μl of Precision plus protein standard (MW 10-250 KDa) were loaded onto 4-20% precast Tris Glycine SDS gels. For sample preparation, 100 μl of 1% samples diluted in 100 μl of distilled water were used. From the diluted sample 100 μl was added to 100 μl of 2× Laemmli buffer for non-reducing gels. For the reducing gels, 100 μl of diluted samples, 95 μl of Laemmli buffer, and 5 μL 0-mercaptoethanol was added. The samples were heated in the water bath at 75° C. for 15 minutes and cooled to room temperature before loading them onto the gels. 5 μl of these samples were loaded on the gels. The gel was electrophoresed at 200V, stained using Imperial™ Protein stain, and destained using distilled water for 48 hours. Molecular Imager Gel Doc XR system (Bio-Rad Laboratories, Hercules, CA) was used to scan and read the prepared gels.

### Flowability

A revolution powder analyzer (Mercury Scientific Inc, Newtown, CT, USA) was used to analyze the flowability of protein powders. 20 g of sample was weighed and transferred into the 100 cc drums, and the following parameters were set for testing. Rotation rate: 0.3 RPM, imaging rate: 10 FPS, Prep Time: 200 seconds, and the test was stopped after 128 avalanches. The avalanche energy of the powders was analyzed to understand the flowability of the samples.

### Particle Size for Protein Powder

Horiba Laser Scattering Particle size distribution analyzer (LA—960) Horiba Scientific Partica (Horiba Scientific, Piscataway, NJ) was used to analyze the particle size of protein powders. 0.5 g of sample was loaded into the analyzer for particle size analysis. The Refractive index was set at 1.46 for MPC before analysis. The samples were analyzed in triplicates and the mean particle size was averaged and compared.

### Structural Analysis

Response surface design was used to optimize PEF parameters for better functional characteristics of milk protein concentrate. In this study, parameters such as temperature, electric field strength and frequency of PEF were considered for optimization. Central composite face centered design with centrally rotatable design with 4 center points were developed with STAT Ease design expert software. Temperature as A, Electric field strength as B and frequency as C were analyzed at three different levels to understand the effect of the variables on the functional characteristics of MPC85. +1 and −1 indicate the maximum and minimum values of these parameters with mid value coded as 0. Table 1.1 represents the design consisting of both coded and non-coded form resulting in 18 experiments. Six temperature control samples at 20, 35 and 50° C. were performed to understand the effect of temperature om MPC85. The results from various functionality tests were fitted into equations and optimized based on the requirements of each functional properties of MPC85. The interactions coefficients also the responses were analyzed with 95% confidence interval with ANOVA.

$$Y = {β}_{0} + {β}_{1} A + {β}_{2} B + {β}_{3} C + {β}_{12} AB + {β}_{23} BC + {β}_{13} AC + {β}_{11} {A}^{2} + {β}_{22} {B}^{2} + {β}_{33} {C}^{2} \qquad ( 1.6 )$$

In the equation, Y— dependent variable
X₁, X₂, and X₃— Independent variables
β₀—constant-coefficient
β₁, β₂, and β₃—linear regression coefficients
β₁₁, β₂₂, and β₃₃—regression coefficients that are squared.
β₁₂, β₁₃, and β₂₃—interaction coefficients of the independent variable

The multiparameter response for post-processing of MPC85 milk protein concentrate 85 was performed using JMP Pro 17 ® (JMP, Version 17, JMP Statistical Discovery LLC, Cary, NC) software with the help of prediction profiler and prediction stimulator to understand the optimal condition for a variety of responses (functional properties) based on the end product application.

TABLE 1.2
Central composite face centered design for pulse electric field
treatment conditions for MPC 85 processing (randomized design).

| | | | |
|---|---|---|---|
| | Temperature | Electric field | Frequency |
| Runs | (° C.) | strength (kV/cm) | (Hz) |

| | | | | | | |
|---|---|---|---|---|---|---|
| 1 | 35 | (0) | 12 | (0) | 300 | (1) |
| 2 | 35 | (0) | 12 | (0) | 165 | (0) |
| 3 | 35 | (0) | 4 | (−1) | 165 | (0) |
| 4 | 50 | (1) | 4 | (−1) | 300 | (1) |
| 5 | 50 | (1) | 20 | (1) | 300 | (1) |
| 6 | 35 | (0) | 12 | (0) | 165 | (0) |
| 7 | 20 | (−1) | 12 | (0) | 165 | (0) |
| 8 | 20 | (−1) | 20 | (1) | 300 | (1) |
| 9 | 50 | (1) | 12 | (0) | 165 | (0) |
| 10 | 20 | (−1) | 4 | (−1) | 300 | (1) |
| 11 | 20 | (−1) | 4 | (−1) | 30 | (−1) |
| 12 | 50 | (1) | 20 | (1) | 30 | (−1) |
| 13 | 20 | (−1) | 20 | (1) | 30 | (−1) |
| 14 | 35 | (0) | 20 | (1) | 165 | (0) |
| 15 | 50 | (1) | 4 | (−1) | 30 | (−1) |
| 16 | 35 | (0) | 12 | (0) | 30 | (−1) |
| 17 | 35 | (0) | 12 | (0) | 165 | (0) |
| 18 | 35 | (0) | 12 | (0) | 165 | (0) |

| | | | |
|---|---|---|---|
| 19 | 20 | 0 | 0 |
| 20 | 35 | 0 | 0 |
| 21 | 50 | 0 | 0 |

### Temperature Analysis After PEF Treatment

The temperatures of the inlet and outlet throughout the treatment was monitored to investigate the effect of increase in thermal energy during the PEF treatment. Table 1.3 presents the recorded inlet and outlet temperatures MPC85. Following the treatment, temperatures experienced a minimum rise in 1.00° C. and maximum of 13.22° C. This aligns well with previous study on MPC85 and MCC, demonstrating a temperature increase influenced by energy input for higher EFS and frequency which consistent with run 5 in this study at 50° C., 20 kV/cm and 300 Hz. PEF study on casein micelles by also noted a slight temperature increase following PEF treatment. The increase in temperature was also calculated using the formula below:

$$Δ {T}_{estimated} = Ψ / ρ \cdot {C}_{v} K \qquad ( 1.7 )$$

$$Ψ = \frac{{P}_{in}}{Φ} \qquad ( 1.8 )$$

$$Ψ = U . I . τ . f / Φ \qquad ( 1.9 )$$

### Where,

ρ is the density (kg/m³), Cᵥ is the heat capacity (J/(kg·K), Pᵢₙ is the average electric input powder (W), U is the applied voltage (V), I is the current (A), τ is the duration of one square pulse (s), f is the pulse frequency (Hz). And Φ is the flow rate (m³/s).

The temperatures observed in this study showed that the theoretical value is in accordance. The temperature increase is dependent on energy, which implies that it was also dependent on all three parameters of PEF in the study. This increase also implies that there is a greater likelihood of whey protein denaturation within the system. However, considering the maximum temperature reached was 63.22° C., the protein denaturation can be deemed negligible. To ensure the protein quality is maintained after the PEF treatment, SDS PAGE profiling was conducted, and the results will be discussed further. Therefore, observed temperature rise for MPC85 after PEF treatment can be viewed as having a minimal effect on the stability of the milk protein.

TABLE 1.3
Temperature changes before and after PEF treatment to liquid MPC

| | Temperature | Temperature | Difference |
|---|---|---|---|
| Runs | Input (° C.) | output (° C.) | (° C.) |
| 1 | 35.00 | 38.33 | 3.33 |
| 2 | 35.00 | 38.61 | 3.61 |
| 3 | 35.00 | 36.94 | 1.94 |
| 4 | 50.00 | 50.00 | 0.00 |
| 5 | 50.00 | 63.22 | 13.22 |
| 6 | 35.00 | 38.61 | 3.61 |
| 7 | 20.56 | 21.67 | 1.11 |
| 8 | 20.57 | 31.22 | 9.56 |
| 9 | 50.00 | 51.50 | 1.50 |
| 10 | 20.56 | 20.61 | 0.06 |
| 11 | 20.56 | 20.56 | 0.00 |
| 12 | 50.00 | 51.17 | 1.17 |
| 13 | 20.56 | 20.56 | 0.00 |
| 14 | 35.00 | 43.89 | 8.89 |
| 15 | 50.00 | 50.06 | 0.06 |
| 16 | 35.00 | 36.06 | 1.06 |
| 17 | 35.00 | 38.61 | 3.61 |
| 18 | 35.00 | 38.56 | 3.56 |
| 19 | 20 | 20 | 0 |
| 20 | 35 | 35 | 0 |
| 21 | 50 | 50 | 0 |

The retention time for the sample in the PEF chamber for the treatment was calculated to be 25 ms based on equation 1.2 for the diameter of 10 mm, flow rate of 112 l/h, and length of 10 mm.

$$τ = \frac{L}{v} = \frac{L \times A}{Q} \qquad ( 1.1 )$$

where,
τ—Retention time (ms), v—Velocity (mm/h, A—Cross-sectional area (mm²), Q=V/t—Volumetric flow rate (L/h), L—Length (mm).

### Influence of Pulsed Electric Field Pre-Treatment on the Solubility of MPC85

The experimental data, detailed in Table 1.4, reveals that there are differences in the solubility of PEF treated vs control. However, there was no observed pattern to achievable to fit into a predictive model. This could be due to various external factors, or the processing factors may not be ideal for the optimization of solubility for the pretreatment of MPC85. Notably, the control sample at 50° C. exhibited the highest solubility at 60.30%, while a comparable solubility of 59.20% was observed with PEF treatment in run 4 (50° C., 4 kV/cm, and 300 Hz). Conversely, run 15 displayed the lowest solubility at 31.23%, suggesting that PEF treatment may enhance or reduce MPC85 solubility.

Temperature plays a crucial role in protein solubility due to structural changes. Control samples recorded solubilities of 42.07% at 20° C., 55.40% at 35° C., and 60.30% at 50° C. This temperature-induced flexibility may change hydrophobic residues, resulting in a more flexible protein structure and increased solubility. Previous studies propose that higher Electric Field Strength (EFS) contributes to increased solubility through molecular polarization, improved dielectric constants, and the generation of free radicals, leading to the disruption of non-covalent bonds. The data observed also suggest that temperature, as a significant parameter, may induce flexibility, with PEF exhibiting a minimal impact on improving solubility however, the predictability was not achievable.

The solubility data after PEF treatment ranged from 31.23% to 59.20%. Comparison of runs (1&4) suggests that solubility >50% can be observed at a lower temperature of 20° C., EFS 20, and 30 Hz (52.13%) compared to the control at 50° C. and run 4 with 50° C., 4 kV, and 300 Hz (59.20%), which involves higher energy. Further analysis of runs (1, 2 & 16) with constant temperature at 35° C., 12 kV/cm indicated that an increase in frequency enhances solubility, with similar trends observed in runs (2, 3 & 14) with constant temperature 35° C. and 165 Hz, increasing EFS induced slight increase in the solubility. At 50° C. and 4 kV/cm, increasing frequency from 30 to 300 Hz increased the solubility from 31.23% to 59.20%, and increasing the EFS caused an adverse effect of decreasing the solubility (runs 4 and 5). Further analysis at 20° C., with runs 8 and 10, indicated that increasing EFS increased the solubility at 300 Hz from 47.50% to 51.85%, and similar trends were observed with runs 10 & 11 with lower EFS and increasing frequency. The change in solubility was increased and similar trends for runs 8 and 11. However, inconsistent patterns arise with changes in temperature as a processing parameter for PEF. Runs 7, 8, and 17 suggest that temperature increases minimally affect solubility, while runs 11 and 15 indicate a decrease in solubility with an increase in temperature and lower settings of EFS and frequency. In summary, there is substantial evidence that PEF can both increase and decrease MPC85 solubility, depending on the applied treatment. However, the complexity of the observed patterns precludes the modeling for solubility enhancement.

TABLE 1.4
Functional characteristics of PEF treated and untreated MPC85

| | | | | | Water | |
|---|---|---|---|---|---|---|
| | Solubility | Foaming | Foaming | Gel | holding | Emulsion |
| Run | (%) | capacity | stability | strength | capacity | stability |
| 1 | 54.89 ± 2.17 | 97.92 ± 2.08 | 69.46 ± 3.75 | 2005.77 ± 3.77 | 69.17 ± 1.10 | 13.61 ± 1.15 |
| 2 | 43.94 ± 1.47 | 119.44 ± 2.41 | 82.55 ± 0.36 | 2927.61 ± 1.46 | 63.55 ± 0.72 | 23.92 ± 3.19 |
| 3 | 43.79 ± 1.38 | 123.61 ± 2.41 | 75.29 ± 5.02 | 2744.50 ± 1.72 | 66.37 ± 1.53 | 11.19 ± 0.11 |
| 4 | 59.20 ± 1.60 | 122.22 ± 8.67 | 74.15 ± 6.37 | 4923.60 ± 1.77 | 64.71 ± 0.63 | 18.19 ± 1.74 |
| 5 | 39.71 ± 3.06 | 131.94 ± 8.67 | 72.74 ± 3.41 | 2855.26 ± 2.49 | 65.73 ± 1.40 | 15.73 ± 2.36 |
| 6 | 34.78 ± 5.11 | 129.17 ± 0.00 | 77.42 ± 0.00 | 2388.92 ± 2.71 | 58.30 ± 1.66 | 16.51 ± 2.50 |
| 7 | 45.64 ± 4.13 | 119.44 ± 6.36 | 82.73 ± 5.34 | 2684.31 ± 0.64 | 63.46 ± 0.78 | 18.82 ± 1.55 |
| 8 | 51.85 ± 1.36 | 131.94 ± 6.36 | 72.68 ± 2.71 | 2372.28 ± 2.21 | 61.06 ± 0.62 | 23.99 ± 4.04 |
| 9 | 49.93 ± 4.97 | 140.28 ± 4.81 | 71.79 ± 0.82 | 3107.63 ± 3.17 | 61.00 ± 1.14 | 56.84 ± 3.15 |
| 10 | 47.50 ± 2.02 | 131.94 ± 8.67 | 73.69 ± 0.45 | 4955.42 ± 3.02 | 64.07 ± 2.02 | 14.93 ± 0.64 |
| 11 | 49.59 ± 0.76 | 122.22 ± 4.81 | 75.08 ± 3.45 | 2798.40 ± 2.67 | 67.99 ± 1.68 | 19.92 ± 1.32 |
| 12 | 44.16 ± 4.34 | 138.89 ± 2.41 | 78.03 ± 2.73 | 2137.35 ± 2.30 | 63.88 ± 0.35 | 31.71 ± 0.57 |
| 13 | 52.13 ± 2.61 | 98.61 ± 2.41 | 74.70 ± 3.72 | 2591.58 ± 3.12 | 63.90 ± 2.22 | 16.77 ± 2.46 |
| 14 | 48.89 ± 5.41 | 144.44 ± 1.20 | 77.87 ± 1.92 | 2814.94 ± 2.42 | 67.33 ± 1.07 | 16.88 ± 3.05 |
| 15 | 31.23 ± 1.25 | 140.97 ± 3.18 | 76.40 ± 3.43 | 2672.13 ± 2.18 | 66.31 ± 3.30 | 55.18 ± 2.73 |
| 16 | 35.83 ± 4.73 | 185.42 ± 5.51 | 78.66 ± 0.76 | 2272.79 ± 2.61 | 65.90 ± 4.18 | 15.05 ± 2.35 |
| 17 | 51.94 ± 1.00 | 116.67 ± 7.22 | 48.83 ± 1.02 | 2764.86 ± 2.25 | 56.23 ± 1.22 | 19.99 ± 3.04 |
| 18 | 50.33 ± 3.67 | 111.11 ± 6.36 | 44.48 ± 3.05 | 2562.95 ± 3.28 | 55.45 ± 1.50 | 14.68 ± 0.76 |
| 19 | 42.07 ± 6.44 | 130.90 ± 6.77 | 78.89 ± 1.92 | 2055.27 ± 7.70 | 71.04 ± 4.56 | 32.37 ± 4.42 |
| 20 | 55.40 ± 1.49 | 116.32 ± 8.98 | 69.23 ± 1.92 | 2048.72 ± 8.30 | 73.03 ± 3.51 | 27.34 ± 4.11 |
| 21 | 60.30 ± 4.71 | 127.08 ± 6.85 | 73.80 ± 4.40 | 265.67 ± 4.71 | 63.49 ± 9.16 | 17.38 ± 3.78 |

### Influence of Pulsed Electric Field Pre-Treatment on Foaming Properties of MPC85

Foaming pertains to a protein's capacity to generate foam per unit weight and to hold (stabilize) the foam against internal and external forces. This indicates the protein's film-foaming ability at the air-water interface. Proteins exhibit heightened stability when they readily absorb at the surface or form highly viscous solutions. The outcome of the foaming treatment aligns with the previous research from SPI and egg proteins and as a post-treatment to MPC85, indicating improved foaming properties following the PEF treatment.

For MPC85, processing parameters for PEF were analyzed to ascertain maximum and minimum foaming capacity and maximizing foaming stability. ANOVA results for the quadratic model fit are presented in Table 1.5, revealing that the foaming capacity model is statistically significant (p<0.05), with a lack of fit insignificance at p-value<0.01. The R² value for the model stands at 0.82, consistent with all model parameters.

TABLE 1.5
ANOVA for foaming capacity model of pretreated MPC85
with PEF and fitted into the quadratic model.

| | Sum of | | Mean | | | |
|---|---|---|---|---|---|---|
| Source | Squares | df | Square | F-value | p-value | |
| Model | 2447.19 | 9 | 271.91 | 3.70 | 0.0492 | significant |
| A-Temperature | 492.10 | 1 | 492.10 | 6.70 | 0.0361 | |
| B-Electric | 2.36 | 1 | 2.36 | 0.0321 | 0.8628 | |
| field strength | | | | | | |
| C-Frequency | 28.01 | 1 | 28.01 | 0.3813 | 0.5565 | |
| AB | 122.07 | 1 | 122.07 | 1.66 | 0.2384 | |
| AC | 590.82 | 1 | 590.82 | 8.04 | 0.0252 | |
| BC | 156.73 | 1 | 156.73 | 2.13 | 0.1875 | |
| A² | 327.92 | 1 | 327.92 | 4.46 | 0.0725 | |
| B² | 593.95 | 1 | 593.95 | 8.08 | 0.0249 | |
| C² | 739.57 | 1 | 739.57 | 10.07 | 0.0157 | |
| Residual | 514.32 | 7 | 73.47 | | | |
| Lack of Fit | 316.06 | 4 | 79.02 | 1.20 | 0.4599 | not |
| | | | | | | significant |
| Pure Error | 198.26 | 3 | 66.09 | | | |
| Cor Total | 2961.52 | 16 | | | | |

Utilizing the data from Table 1.4 for foaming capacity, a quadratic polynomial equation was represented as follows:

$$Foaming Capacity = 11 \; 9.15 + 7.02 A + 0.48 B + 1.83 C + 3.91 AB - 8.59 AC + 4.43 BC + 12.04 {A}^{2} + 16.21 {B}^{2} - 20.4 {C}^{2} \qquad ( 1.11 )$$

Here, A represents temperature, B denotes electric field strength, and C signifies frequency with AB, BC, and AC defining interaction terms, and A2, B2, and C2 describing quadratic terms. Equation (1.11) provides predictions regarding the response for specific levels of each factor. Examining Table 1.4, it was observed that runs 1 & 13 yielded a minimum foaming capacity of 97.92 ml/g, while runs 9, 14, and 15 resulted in a maximum foaming capacity of 144.44 ml/g.

The foaming capacity of MPC85 adhered to a quadratic model, and the optimum conditions for both minimum and maximum foaming capacity were determined. For the minimum, the conditions were identified as Temperature 25° C., Electric field strength (EFS) at 12.45 kV/cm, and frequency at 32.21 Hz, resulting in a minimum foaming capacity of 92.35 ml/g. For the maximum, the optimized conditions were Temperature at 49.35° C., EFS at 19.58 kV/cm, and frequency at 119.06 Hz, yielding a maximum foaming capacity of 153.86 ml/g. The desirability of both optimized conditions was 1, indicating a good fit for the model under these conditions.

As per the ANOVA for the model, temperature, temperature*frequency, EFS*EFS, and frequency*frequency interaction terms exhibited the highest significance in the foaming capacity model. Analyzing the impact of temperature, with data, and 3D surface plots from runs 1&2, and 5 &12 showed that increased frequency decreased foaming capacity at 35° C. and 50° C. However, at 20° C., an increase in frequency led to a rise in foaming capacity. Consistency is observed in runs 2, 7, and 9, where an increase in temperature from 20° C. to 50° C. resulted in increased foaming capacity at 12 EFS and 165 Hz frequency.

Examining runs 12&15, an increase in EFS at 50° C. led to a decrease in foaming at 30 Hz. However, at 50° C. and 300 Hz (runs 4&5), an increase in EFS caused an increase in foaming capacity. This pattern aligns with similar EFS, and frequencies observed at 20° C. This suggests that foaming is influenced by EFS, but it acts in conjunction with frequency at 50° C. and 20° C. In runs 8 & 13 and 10 & 11, an increase in frequency at 20° C., regardless of EFS, resulted in increased foaming capacity, indicating the significance of frequency as a crucial parameter in foaming capacity. The model also underscores the individual significance of temperature for the foaming capacity model, while the interaction and mutual influence between temperature and frequency carry greater significance. Understanding the effect of the frequency when temperature and EFS are variable: At lower frequencies (30 Hz), from runs 11&15 and 12&13, increasing the temperature from 20° C. to 50° C. increases the foaming capacity of MPC85 immaterial of whether an increase in the EFS is. At higher frequencies (300 Hz), from runs 4 & 10 and 5 & 8, increasing the temperature from 20° C. to 50° C. led to a decrease, indicating that frequency plays a mutual interaction effect with temperature. It is also evident from the control samples that temperature impacts foaming capacity. However, when comparing the control at 20° C. with PEF-treated optimized condition for minimum foaming capacity, it was 27.52% lesser and 20.74% increase for the maximum foaming capacity.

Generally, the stability of protein foams hinges on rheological properties, elasticity, and disjoining pressure between the protein layers of the films. However, this study revealed that PEF treatment had varying effects on foaming stability, resulting in both maximum and minimum values. The models derived from the data indicated insignificance, suggesting that factors beyond EFS, frequency, and temperature could influence the foaming stability of pretreated MPC85, implying the potential impact of external factors on optimizing the foaming stability of MPC85 with PEF treatment.

Upon further examination of foaming stability, it was noted that at 35° C. and 165 Hz, increasing the EFS from 4 kV/cm to 12 kV/cm observed an increased the foaming stability to 81.36% and attained a local maximum and then decreased to 77.94% with EFS at 20 kV/cm (Runs 2, 3 and 14). Similarly, at 35° C. and 12 kV/cm, increasing the frequency from 30 Hz to 165 Hz increases foaming stability to 81.36% from 78.66% and attained a local maximum and then decreased to 69.46% at 300 Hz. Also, there is no pattern with the temperature controls at 20° C., 35° C., and 50° C. At higher (50° C.) temperatures and higher electric field strength, increasing the frequency from 30 Hz to 300 Hz led to a decrease in foaming stability (Run 5 & 12). On the other hand, having a combination of higher temperature and lower Hz, increasing EFS from 4 to 20 kV/cm increases foaming stability, whereas at higher temperature and higher frequency of 300 Hz, the same increase in EFS caused a decrease in foaming stability (Runs 12, 15, 4 and 5). The data thus indicating it was complex to fit the data into a prediction model. Understanding that there is also a decreasing effect of foaming stability with increasing temperature at mid-level of EFS and frequency. At 20° C., increasing the EFS from 4 to 20 kV/cm and increasing frequency from 30 to 300 Hz (Runs 8, 10, 11, 13) resulted in a decrease in foaming stability, indicating that both EFS and frequency of the PEF treatment resulted in a negative impact on the foaming stability.

Consistent reports of MPC exhibiting lower solubility, emulsion, foaming, and WHC properties compared to other protein powders align with the findings in this study. The results agree with the finding from PEF-treated SPI and egg proteins on enhancing foaming properties and, in this case, MPC85. Consequently, PEF treatment emerges as a potential alternative to optimize both the maximum and minimum foaming capacity of MPC85, but the same doesn't hold for foaming stability.

### Influence of Pulsed Electric Field Pre-Treatment on Emulsion Properties of MPC85

The data collected for emulsion stability was analyzed and fit into a quadratic model. The data was fitted into a quadratic polynomial equation given by,

$$Emulsion stability = 19. 55 + 8.32 A - 1.43 B - 5.22 C - 3.98 AB - 6.9 AC + 4.15 BC + 17.5 {A}^{2} - 6.3 {B}^{2} - 6. {C}^{2} . \qquad ( 1.12 )$$

In the context of this study, A denotes temperature, B represents electric field strength, and C signifies frequency. The terms AB, BC, and AC indicate interaction terms, while A2, B2, and C2 represent quadratic terms. Equation (1.12) serves as a predictive tool for the response at specific levels of each factor for emulsion stability. Upon analysis of Table 1.4, it was observed that runs 1 and 13 exhibited a minimum stability of 11.19±0.14 min, while run 9 demonstrated a maximum stability of 56.84±4.95 min. It is essential to understand that, utilizing this equation for assessing the relative influence of each factor is impractical due to the coefficients being scaled to match the units of individual characteristics, and the intercept not being centered within the design space.

TABLE 1.6
ANOVA for emulsion properties model
of pretreated MPC85 with PEF.

| | Sum of | | Mean | | | |
|---|---|---|---|---|---|---|
| Source | Squares | df | Square | F-value | p-value | |
| Model | 2460.50 | 9 | 273.39 | 4.88 | 0.0179 | significant |
| A-Temperature | 692.56 | 1 | 692.56 | 12.37 | 0.0079 | |
| B-Electric | 20.53 | 1 | 20.53 | 0.3668 | 0.5615 | |
| field strength | | | | | | |
| C-Frequency | 272.28 | 1 | 272.28 | 4.86 | 0.0585 | |
| AB | 126.72 | 1 | 126.72 | 2.26 | 0.1708 | |
| AC | 380.88 | 1 | 380.88 | 6.80 | 0.0312 | |
| BC | 137.95 | 1 | 137.95 | 2.46 | 0.1551 | |
| A² | 829.45 | 1 | 829.45 | 14.82 | 0.0049 | |
| B² | 107.51 | 1 | 107.51 | 1.92 | 0.2032 | |
| C² | 97.68 | 1 | 97.68 | 1.74 | 0.2230 | |
| Residual | 447.82 | 8 | 55.98 | | | |
| Lack of Fit | 397.98 | 5 | 79.60 | 4.79 | 0.1137 | not |
| | | | | | | significant |
| Pure Error | 49.85 | 3 | 16.62 | | | |
| Cor Total | 2908.33 | 17 | | | | |

ANOVA results for the quadratic model fit are presented in table, revealing that the gel strength model is statistically significant (p<0.05), with a lack of fit insignificance at p-value<0.05. The R² value for the model stands at 0.80 consistent with all model parameters. From the table, electric field strength, frequency and their interaction terms are considered to be significant parameters to the model.

From the 3D surface models and data, 35° C. & 165 Hz, increasing the EFS from 4 to 12 kV/cm attains a maximum at 2927.61 N and then decreases with increase in EFS to 20 kV/cm (Run 2, 3 and 14). On the other hand, at 35° C. and 12 kV/cm, increasing the frequency from 30 Hz to 165 Hz attains a maximum and decreases when frequency is further increased to 300 Hz (Run 1, 2 and 16). At temperatures 20° C. and 50° C. and 30 Hz (runs 12, 11, 13 and 15), increasing the EFS from 4 to 20 kV/cm decreases the gel strength. Similar results were observed at 300 Hz with similar combinations of temperature and EFS (Runs 4, 5, 8, 10).

With runs 8 and 13, at 20° C. and 20 kV/cm, increasing the frequency from 30 to 300 Hz decreases the gel strength. On the other hand, at 50° C. and 20 kV/cm, increasing frequency increased the gel strength (Runs 5 & 12). Similarly at 20° C. and 50° C., at lower EFS, increasing the frequency let to increase in gel strength. These findings indicate that the gel strength is dependent on higher temperature and also combination of lower EFS and higher frequency which is consistent with the model created (Runs 10, 11, 4 and 15). Analyzing the temperature changes at 12 kV/cm and 165 Hz, increasing temperature increases the gel strength.

Therefore, gel strength of PEF pretreated MPC85 followed a quadratic model with an R² value of 0.80. The optimized conditions for achieving the maximum gel strength were determined as follows: Temperature at 50° C., Electric Field Strength (EFS) at 4 kV/cm, and frequency at 300 Hz with maximum gel strength of 4751.33N and desirability of 0.9, indicating a good model fit.

### SDS Protein Profiling

The molecular weight profile for pre-treated MPC85 was analysis with SDS-PAGE analysis. SDS profiles of PEF treated samples could be divided into reduced and non-reducing bands where the S—S bonds are cleaved. The lower portion of the gels indicate α-, β-, κ-casein, β-Lg, α-La and some minor whey proteins most of the milk protein bands and the upper portion consists of disulphide linked aggregates which are further broken down by reducing agent. The reducing bands show a clear differentiation of κ-casein in addition to α-, β-caseins.

The investigation on the molecular weights have indicated that the quality of the protein remains the same after PEF treatment in comparison to MPC85 samples without PEF treatment (Run 19, 20 and 21). From the bands shown in gels, it is evident that all the proteins remained intact after PEF treatment and no increase in protein aggregation was observed due indicating that changes associated are minor. These results are comparable with the results obtained from post treatment of MPC85 and pretreatment of MCC. Overall, SDS profile showed no significant difference between the control and pre-treated PEF treated samples. Similar results were across usage of ultrasound as a treatment to MPC85 and in many studies the minor changes to the protein were not captured by PAGE analysis. This indicates that the changes are predominantly minor leading to physical modification to the protein at the macrolevel and the milk proteins reminds unchanged after the treatment. Therefore, any changes in the functional characteristics of these MPC85 due to PEF was not likely to be caused by denaturation effects as no visible difference was detected.

### Powder Characteristics of PEF Pre-Treated MPC85

The table 1.3 displays the flow behavior of pretreated MPC85 powders, presenting results in terms of avalanche energy using the revolutionary powder analytical method. A lower avalanche energy is associated with an increased flow behavior of the sample. Powder flow characteristics significantly contribute to the ease of ingredient usage in applications and scale-up. Upon analysis, the data did follow any pattern to validate the application of any prediction models and thus not significant although minor changes were observed.

The pretreated MPC85 exhibited a minimum mean avalanche energy of 35.3±3.84 kJ/kg and a maximum of 51.53±11.73 kJ/kg. In comparison to the control samples at 48.73±15.38 kJ/kg for 20° C., there was a 27% reduction with PEF-treated MPC85 (run 9) and a 20% decrease from the 35° C. control (44.17±2.14 kJ/kg). However, a temperature effect was observed, reducing flowability or avalanche energy to 34.97±1.26 kJ/kg at 50° C. MPCs find diverse applications due to the increasing market demand for high proteins. These results suggest that PEF does alter the flow characteristics of MPC85 at 20° C. and 35° C. Similar effects on the powders were noted at 50° C., with a decrease in avalanche energy.

The particle size analysis of PEF treated MPC85 were analyzed, and results are presented in the table. The values are represented in terms of D(v,0.1), D(v,0.5), D(v,0.9) representing 10%, 50% and 90% of particle size below which MPC85 volume exists. From the results, the mean particle size for MPC85 samples were observed to be in the range of −21 to 32 μm. It was evident that mean particle size of MPC85 did not have significant changes with PEF treatment. The largest media particle size MPC85 was 27.113 Gm and the minimum were 21.259 μm. Inconsistencies in the drier efficiency may lead to these minor differences as particle size of MPC85. From the literature, the particle size of MCC was found to be d10=29.44 μm, d50=82.46 μm, d90=110.3 μm and the particle size for MPC85, d10=9.6, d50=26, d90=51 SSA=0.74. The PEF treated MPC85 samples were found to be similar in comparison to controls in run 19, 20 and 21. The majority of the d90 for PEF treated MPC85 ranges between 44-54 μm and d50 at 21-30 μm with is within the control particle sizes from run 19-21. These results provide an understanding that there is minimal reduction in particle size in comparison to controls but insignificant for any models. The reduction in particle size of the PEF treated samples would accompany the increase in flowability because of increased in surface area providing more cohesive flow of the MPC85 powder. Thus, the PEF treated samples indicated to have a potential effect in particle size reduction. These reduction in particle size is concurrent with the studies with MPC85 post treated with PEF and MCC pretreated with PEF treatment. From previous studies with PEF, as a mean particle size of MPC85 after PEF treatment was range of 26-31 μm and MCC was in the range of 36-40 μm and the results are found to be in accordance with this study.

TABLE 1.9
Average particle size analysis and flowability of pretreated MPC85 with PEF.

| | | | | | | Flowability |
|---|---|---|---|---|---|---|
| | | | | | | (Avalanche |
| | Mean ± SD | | | | | energy) |
| Runs | (μm) | Median | D(v, 0.1) | D(v, 0.9) | D(v, 0.5) | kJ/kg |
| 1 | 25.896 ± 17.438 | 21.405 | 11.058 | 45.354 | 21.405 | 50.83 ± 6.07 |
| 2 | 29.016 ± 17.646 | 25.083 | 11.712 | 50.603 | 25.083 | 43.37 ± 0.59 |
| 3 | 28.918 ± 16.937 | 25.087 | 12.236 | 49.922 | 25.087 | 40.2 ± 0.87 |
| 4 | 28.4 ± 17.103 | 24.25 | 11.848 | 49.923 | 24.25 | 51.53 ± 11.73 |
| 5 | 26.862 ± 15.852 | 23.019 | 11.692 | 46.556 | 23.019 | 46.83 ± 1.66 |
| 6 | 28.822 ± 16.255 | 25.454 | 11.873 | 49.844 | 25.454 | 43.97 ± 3.21 |
| 7 | 27.097 ± 16.556 | 22.986 | 11.61 | 47.364 | 22.986 | 43.57 ± 2.98 |
| 8 | 25.595 ± 16.21 | 21.259 | 11.077 | 44.99 | 21.259 | 43.57 ± 7.28 |
| 9 | 26.356 ± 15.927 | 22.362 | 11.003 | 46.613 | 22.362 | 35.3 ± 3.84 |
| 10 | 31.17 ± 17.562 | 27.664 | 12.602 | 54.016 | 27.664 | 49.43 ± 7.42 |
| 11 | 27.596 ± 16.287 | 23.85 | 11.341 | 48.46 | 23.85 | 42.67 ± 2.1 |
| 12 | 31.133 ± 18.616 | 27.113 | 12.638 | 54.085 | 27.113 | 38.93 ± 3.81 |
| 13 | 27.979 ± 23.372 | 21.892 | 11.205 | 49.222 | 21.892 | 45.57 ± 2.32 |
| 14 | 29.282 ± 18.378 | 24.954 | 12.11 | 50.889 | 24.954 | 44.73 ± 0.86 |
| 15 | 32.981 ± 17.318 | 30.176 | 13.862 | 55.233 | 30.176 | 47.33 ± 6.76 |
| 16 | 30.044 ± 16.79 | 26.625 | 12.461 | 51.528 | 26.625 | 42 ± 3.47 |
| 17 | 29.132 ± 15.389 | 26.411 | 12.171 | 49.483 | 26.411 | 39.63 ± 0.68 |
| 18 | 28.38 ± 15.723 | 25.173 | 11.837 | 48.917 | 25.173 | 46.73 ± 5.87 |
| 19 | 30.39 ± 2.19 | 27.03 | 12.59 | 52.20 | 27.03 | 48.73 ± 15.38 |
| 20 | 30.22 ± 3.93 | 26.73 | 12.47 | 51.32 | 26.73 | 44.17 ± 2.14 |
| 21 | 27.96 ± 3.50 | 24.92 | 11.79 | 47.73 | 24.92 | 34.97 ± 1.26 |

### Multiparameter Design

The primary aim of this research was to develop a multiparameter design to enhance the functionality of MPC85 using PEF as a pre-treatment. The optimized conditions and predicted values of functional properties are discussed below. Stimulations were conducted using the multiparameter model as evaluated in the study, as outlined in the table. Additionally, the prediction profiler for model is depicted in FIG. 10.

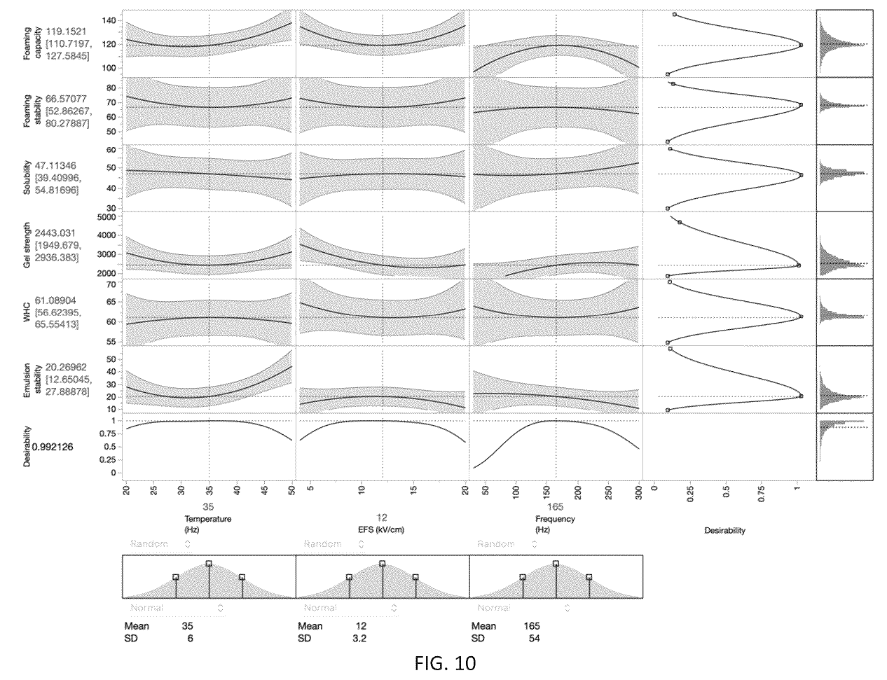

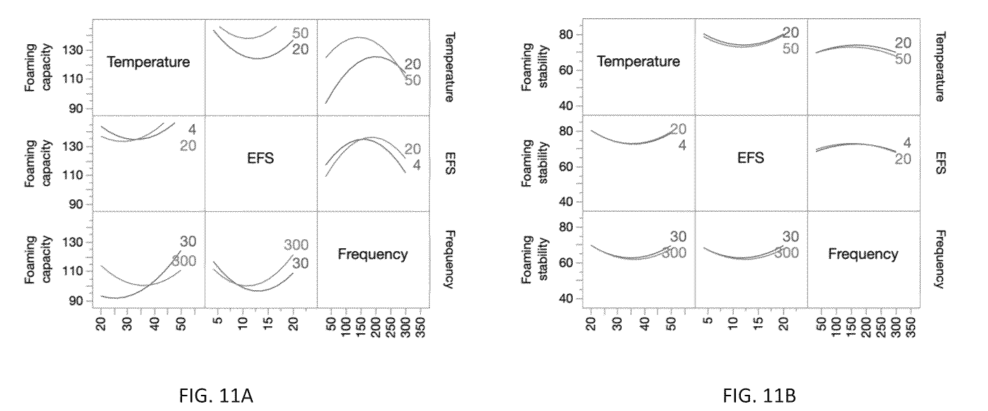

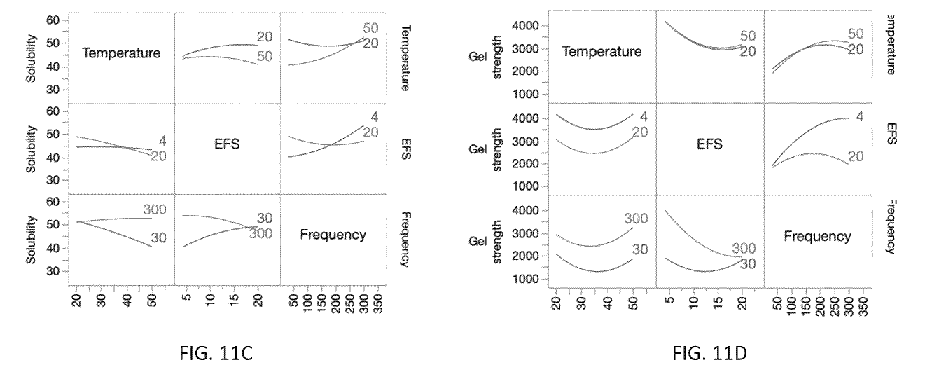

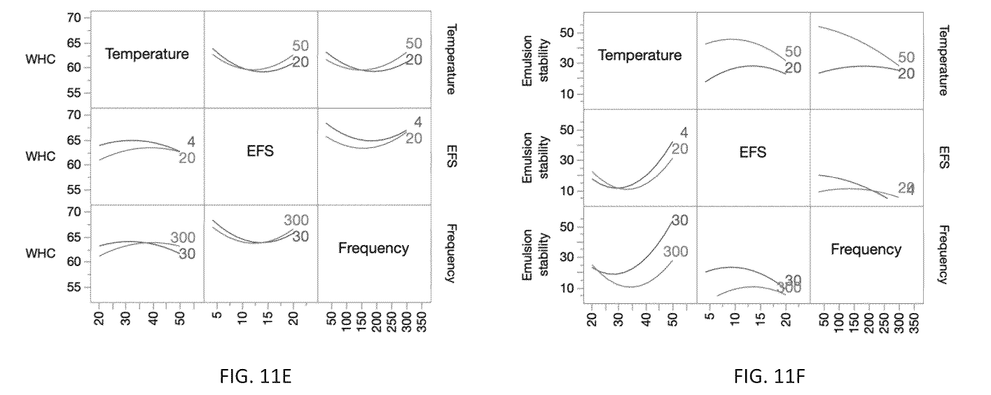

FIGS. 11A-11F illustrate the interaction profiles for each response considered in the optimization study. The crossover points within the graph distinctly highlight the interaction between PEF processing parameters. These crossover regions signify the interplay between two distinct parameters concerning the functionality under investigation. In contrast, parallel lines in the interaction profiles suggest minimal or no interaction between the parameters for each response.

The optimized conditions for model 1, as outlined in the table, were identified as 48° C. temperature, 18 kV/cm Electric Field Strength (EFS), and 30 Hz frequency. The predicted values for the process responses in model 1 are as follows: Foaming capacity (128.17 ml/g), foaming stability (72%), solubility (43.2%), gel strength (2044.15 N), Water Holding Capacity (WHC) (63.66), and emulsion stability (34.47 min), with a model desirability of 0.62. This suggests a favorable fit for the multiparameter design. The resulting PEF-treated MPC85, with enhanced functionality, holds potential applications in ingredient addition for whipping cream, cream cheese spreads, and butter spreads. Table 1.11 presents an effect summary for the multiparameter designs, encompassing all functionality and effects. The interaction effects display a β-value <0.05, affirming the significance of the studied PEF parameters.

TABLE 1.11
Summary of effects for PEF treated MPC85 - Pre-treatment

| Source | Logworth | PValue |
|---|---|---|
| Temperature(20, 50) | 1.940 | 0.01148 |
| EFS(4, 20) | 1.916 | 0.01215 |
| Frequency(30, 300) | 1.831 | 0.01477 |
| Frequency*Frequency | 1.805 | 0.01565 |
| Temperature*Temperature | 1.773 | 0.01687 |
| EFS*EFS | 1.603 | 0.02493 |
| Temperature*Frequency | 1.599 | 0.02520 |
| EFS*Frequency | 1.549 | 0.02824 |
| Temperature*EFS | 0.723 | 0.18941 |

The optimized conditions for model 2, as detailed in Table 1.12, were determined to be 32° C. temperature, 12 kV/cm Electric Field Strength (EFS), and 30 Hz frequency. The predicted values for the process responses in model 2 are as follows: Foaming capacity (94.35 ml/g), foaming stability (63.10%), solubility (48.79%), gel strength (1372.89 N), Water Holding Capacity (WHC) (64.15%), and emulsion stability (20.22 min). The desirability of this model was found to be 0.68, indicating a good fit for the model. This PEF-treated MPC85 exhibits potential applications in beverages, nutritional supplements, medical nutrition, and sports nutrition.

For model 3, the optimized conditions presented in Table 1.12 were identified as 48° C. temperature, 8 kV/cm EFS, and 300 Hz frequency. The predicted values for the process responses in model 3 are as follows: Foaming capacity (93.27 ml/g), foaming stability (68.34%), solubility (55.15%), gel strength (2882.28 N), WHC (63.9%), and emulsion stability (23.20 min). The desirability of this model was found to be 0.65, indicating a commendable fit. This PEF-treated MPC85 holds potential applications in soups, salads, and various other food products. These results are based on understanding that these likely conditions would help optimize the end product results.

TABLE 1.12
Stimulation table for three different multiparameter models using JMP Pro 17.

| Optimization | | | | | | | |
|---|---|---|---|---|---|---|---|
| model | Emulsion | Foaming | Foaming | | | Gel | |
| stimulation | stability | capacity | stability | WHC | Solubility | strength | Applications |
| Model 1 | Maximize | Maximize | Maximize | Maximize | Maximize | Minimize | Whipping cream, |
| | | | | | | | Cream cheese |
| | | | | | | | spreads, butter |
| | | | | | | | spreads |
| Model 2 | Maximize | Minimize | Minimize | Maximize | Maximize | Minimize | Beverages |
| Model 3 | Maximize | Minimize | Minimize | Maximize | Maximize | Maximize | Salad dressings, |
| | | | | | | | soups |

The analysis of individual responses and corresponding 3D surface plots for each parameter revealed notable impacts on dependent variables such as the foaming capacity, gel strength and emulsion stability. These variables exhibited sensitivity to manipulation and optimization based on the independent variables. Conversely, variables like foaming stability, solubility, and water holding capacity were also influenced by the independent variables, but their responses did not adhere to a pattern, making it challenging to establish a model for PEF pre-treatment to milk protein concentrates. The desirability value, however, suggests that the optimized conditions are favorable, providing predicted values that meet desired outcomes approximately 99% of the time the experiment is conducted.

The use of Pulsed Electric Field (PEF) as a pre-treatment proved successful in modifying the functional properties of MPC85. This treatment induced changes in function and structure of protein molecules, resulting in a substantial increase in gel strength, emulsion stability and foaming capacity. Furthermore, the particle sizes of MPC85 demonstrated a reduction post PEF treatment, decreasing to −21 μm and increasing flowability by reducing the avalanche energy to 35.3±3.84 kJ/kg. Application of lower EFS and highest frequency at 50 C led to decreased particle sizes (˜28 μm), expanding the surface area and subsequently enhancing protein solubility to maximum of 59%. Quadratic models and optimized models were developed for foaming capacity, gel strength and emulsion stability with maximum desirability of 0.9 and R²>0.8 indicating a good model fit. Multiparameter design was also developed based on the desired end production application for MPC85. This study suggests that PEF could be potentially used as a pre-treatment during the processing to enhance the functional characteristics of MPC85 with minimal structural changes in 25 milliseconds of treatment. SDS data provided evidence of quality of proteins was maintained after the PEF treatment and major protein bonds were not affected.

The observed changes in the functional properties of MPC85 due to PEF treatment primarily resulted from in theory from polarization effects, subsequent formation of free radicals, exposure of covalent groups, and formation of hydrophobic and S—S bonds. Employing large sample in this study proved sufficient for an industrial-scale proof-of-concept demonstration and thereby indicating the development for potential use in commercial settings. In conclusion, we strongly recommend further investigation into the impact of PEF treatment on other proteins and processing parameters.

Optimizing Pulsed Electric Field Processing for Improving Functionality of Reconstituted Milk Protein Concentrate (MPC85) with Response Surface Methodology.

Milk protein concentrates (MPC85—85% protein) consist of both casein and whey proteins in their native state. They are manufactured from skim milk through ultrafiltration and diafiltration to remove lactose and minerals followed by spray drying. Obtaining desired functionality for MPC85 is a well-known industrial challenge, leading to performance issues as an ingredient in finished product applications. Hence, modifying and customizing the functional property of this high-protein dairy ingredient could create a wide ingredient range for product-specific applications in the current protein-rich food market. The present study investigated the effect of PEF processing on the insolubility index, foaming, emulsion, flowability and water-holding characteristics of MPC85 using a response surface experimental design. The response surface models were used to optimize process conditions for obtaining desired functionality. Process conditions such as temperature (25° C.-65° C.), electric field strength (EFS) (4 kV/cm-20 kV/cm), and frequency (30 Hz300 Hz) of PEF treatment were considered. The data obtained from the experimental design was fitted into polynomial equations and were used for individual optimizations for insolubility index and foaming, multiparameter optimization for specific end use applications. The optimum PEF processing condition for bars and whipped cream applications was found to be 27° C. Temperature, 4.6 kV/cm EFS and 30 Hz frequency and for beverage and soup application it was found to be 25° C. Temperature, 11.9 kV/cm EFS and 133.98 Hz frequency. The models developed could be used as a practical mathematical tool to optimize and customize the functionality of MPC85 for various product applications.

Dairy proteins are increasingly used as ingredients for various new food products. They are gaining importance as they provide nutritional value to foods by boosting the amount of proteins in beverages, ice cream, infant formulas, and cookies. These dairy ingredients also satisfy the requirement for product-specific functional attributes. Dairy proteins also aid in developing products based on market trends and can replace most plant proteins, which are expensive to process. Among these proteins, milk protein concentrate (MPC) has the potential to be added to many value-added products in the market. MPC are known to contain a similar ratio of casein to whey proteins as natural milk and are considered second-generation dairy ingredients with protein concentrations ranging from 35 to 89%.

Widely known functionality challenges associated with high protein MPC are solubility and formation of insoluble aggregates, leading to issues with caking and reduced rehydration abilities during storage. In this study, the insolubility index was considered a significant functionality parameter as protein solubilization takes the first step in any product development. In general, the degree of solubility of a protein will have a more substantial influence on other functional properties such as foaming, emulsification, and gelation. Proteins that are less soluble or have a higher insolubility index will decrease overall functionality. In addition, solubility can also be used to understand the extent of denaturation of the milk protein concentrations. During the reconstitution of MPC in water at 20° C., a portion of milk solids remains undissolved, forming sediments. Previous studies have proposed mechanisms for MPC insolubility, including developing a protein network on the powder's surface, hindering hydration, residual fat movement, and slow release of casein micelles. Analyses of aged MPC samples revealed that large insoluble particles were primarily composed of casein micelles held together by protein-protein interactions in MPC85. Insolubility in protein-rich systems also arises from covalent and non-covalent interactions, such as disulfide bonds and hydrophobic associations. The hydrophobic interactions between casein molecules and minor whey significantly contribute to insolubility. The protein interactions also increase during storage, while disulfide-linked aggregates of specific proteins do not significantly contribute to this insoluble material. Insolubility is a major driver for all the other functional properties of MPCs, so understanding this challenge would improve and enhance the other functional properties.

To address functionality challenges, many different methods like chemical, enzymatic, and heat treatments have been researched; however, with the constant lookout for new technologies for improvement, pulsed electric field (PEF) processing, a nonthermal technique, has been on the radar in the food industry. PEF treatment uses electric fields to alter the protein functionalities like viscosity, particle size, and gelation of liquid products such as milk. The working principle involves the usage of short electric pulses onto the sample when placed between the two electrodes.

Previous studies on the effect of PEF on milk proteins have reported an increase in surface hydrophobicity, formation of new matrices and enhanced coagulation properties due to a decrease in the size of the casein micelle with higher electric field strength. Studies on soy, whey, and egg white proteins showed reduced thermal stability increased surface hydrophobicity, decreased enthalpy, modified denaturation temperature, reduced gel strength and increased gelation time for heat-induced gel due to structural modification and denaturation caused by PEF. In addition, though several studies are indicating the effect of PEF on milk proteins, they conflict with each other due to variations in the PEF systems (bench top and inbuilt lab-scale systems) and process conditions. A structured experimental design and process optimization were required to understand better and optimize modifications caused by PEF on milk proteins. Thus, the overall objective of this study is to understand and optimize the effects of pulsed electric field treatment using an industrial scale system on the solubility, foaming, emulsion, flow behavior and water-holding properties of reconstituted MPC85 by potentially modifying the structure of the proteins.

### Materials and Methods

2× Laemmli sample buffer, Precision plus protein standard, TGX Precast Gels (4-20%), and 10× Tris/Glycine/SDS Buffer was obtained from Bio-Rad Laboratories (Hercules, CA). Calcium Chloride Anhydrous (CaCl₂)) from Fisher Scientific (Waltham, MA); β-mercaptoethanol and Sodium Dodecyl Sulfate from Sigma Life Sciences (St. Louis, MO) and Imperial™ protein stain from ThermoFisher Scientific (Waltham, MA).

### Pulsed Electric Field Treatment

A commercial industrial-grade sample of milk protein concentrates (MPC85) was obtained and reconstituted to 10% total solids (TS). The required amount of sample was mixed thoroughly with water at 37° C. for 30 minutes using a high-speed stand mixer with a 3-inch propeller blade at 1750 rpm in a mixer tank. To investigate the effect of PEF on milk protein concentrates, the reconstituted sample was subjected to various PEF treatment conditions: temperature, electric field strength, and frequency. The independent variables, i.e., parameters, were set to temperature: 25 to 65° C., electric field strength: 4 to 20 kV/cm, and frequency: 30 to 300 Hz based on a preliminary study. The flow rate (87 l/h), pulse width (20 μs), and electrode gap (10 mm) were set as constants. The inlet and outlet temperatures were monitored throughout the study to understand the heat generated by the system. For each treatment 11.35 kg of 10% TS reconstituted samples was fed into the heat exchanger (Direct/Indirect UHT/HTST Series, Microthermics®, Raleigh, NC) to maintain the temperature followed by a 2-stage homogenizer (Direct/Indirect UHT/HTST Series, Microthermics®, Raleigh, NC) with 13,790 kPa 1st stage and 3448 kPa in 2-stage to homogenize the sample before the treatment. The liquid sample was then subjected to various PEF treatment conditions using industrial-scale continuous PEF system (ELEA El-Crack®, HVP 5, German Institute of Food Technologists, Quakenbruck, Germany) and conditions for the process were set based on the response surface experimental design. The spray dryer (Compact spray dryer type 1, APV Anhydro, Tonawnda, NY) inlet temperature was set to 180° C. and outlet to 90° C. and atomizer speed at 2300 rpm to prevent the use of higher heat in the dryer. The feed amount of the sample after treatment and the amount of the sample after spray drying were weighed and monitored to calculate the efficiency of the spray drying process and yield. The PEF system was cleaned and flushed with water after each run. Control samples without treatment at room temperature were also fed through Microthermics® (for pumping and temperature control) and homogenizer to control the environmental parameters for the treatment. All the powder samples were stored in polythene bags in a temperature-controlled room at 25° C. for further analysis.

### Functional Characterization of the Protein Powder

Following the treatment of PEF, 6% protein solutions at pH seven were made, and insolubility index tests were performed. The insolubility index was measured by IDF standard method 129A, where six grams of the sample was mixed with 100 ml of distilled water at 4000 rpm for 90 min. An anti-foaming agent (6 to 8 drops, approximately 1 ml) was added to prevent foam formation. The samples were transferred to 50 ml centrifuge tubes and centrifuged (Beckman GS6 series, GH 3.8 horizontal rotor, Beckman Coulter Inc., Brea, CA) at 940 rpm for 5 min. The sediment-free liquid was cleared, distilled water was added to fill the centrifuge tubes, and once again centrifuged for 5 min at 900 rpm, and the amount of sediment in ml was calculated as the insolubility index of the samples. All the analysis was carried out in triplicates.

The method for assessing foams has been derived from Boyle, Hansen, Hinnenkamp, & Ismail, (2018F) with minor modifications. To evaluate foaming capacity and stability, 12% protein solutions were prepared and added to a kitchen aid mixer (Whirlpool Corporation, Benton Harbor, MI) to incorporate air. This was achieved using whipping attachment during the process. Following a brief period of mixing for 2 minutes, the solution was promptly transferred into a 250 ml measuring cylinder. The initial liquid and foam volumes were meticulously noted, and a timer was initiated for a 30-minute interval. After 30 minutes, the final liquid and foam volumes were noted.

Volume of foam (ml)=Total volume of the solution with foam−Total liquid volume

$$Foaming capacity = Initial foam volume ( ml ) / g of protein in the solution \qquad ( 2.1 )$$

$$Foaming stability ( \% ) = Final foam volume / Initial foam volume \qquad ( 2.2 )$$

Emulsion stability was evaluated by measuring the turbidity of the oil medium. 30 ml of 0.1% protein solutions (25.5 mg of protein) were stirred overnight at 600 rpm. 5 ml of that protein solution was added with 1.67 ml of pure corn oil and was homogenized utilizing Ika ULTRA-TURRAX® Tube Drive UTTD (IKA Works Inc., Wilmington, NC) at maximum speed of 600 rpm for 1 minute. The turbidity of the sample was measured using spectrophotometer (Schmedzu) at 500 nm. The samples were held for 10 min and final turbidity of the samples were measured again.

$$Emulsification Stability ES ( minutes ) = \frac{Initial absorbance}{( Initial absorbance - Final absorbance )} \times 10 min . \qquad ( 2.3 )$$

The assessment of gel formation and water holding capacity was conducted using the method of rennet-induced gelation. Chymosin with 1:60 dilution and 2.72 mM of CaCl₂) were added to enhance the gel's structural integrity. 10 ml solution containing 15% total solids (TS) was mixed for 30 minutes and then introduced into a water bath at 65° C. for 5 minutes. Following this, the samples were carefully withdrawn from the water bath and allowed to equilibrate to a temperature of 30° C. Subsequently, a volume of 5 ml from this solution was transferred into 15 ml centrifuge tubes, adding 250 μl of a 2.72 mM CaCl₂) solution and 250 μl of Chymosin. The solution was mixed thoroughly, transferred into Eppendorf tubes, and placed within a water bath at 30° C. for 30 minutes. The samples were then gradually cooled to ambient room temperature. After the gelation procedure, the centrifugation step was introduced for water holding capacity, where the samples were subjected to centrifugal forces of 1000 g for 5 minutes. The weight of the gels before and after centrifugation after eliminating water was calculated as follows.

$$Water holding capacity ( \% ) = \frac{Sample mass after the removal of excess water}{Initial sample mass} \times 100. \qquad ( 2.4 )$$

Protein profiling of MPC85 samples was conducted. To initiate the procedure, 10 μl of Precision Plus Protein Standard (MW 10-250 kDa) was loaded onto 4-20% precast Tris Glycine SDS gels. As for the preparation of the samples, 100 μl of 1% samples (w/v) diluted with 100 μl of distilled water were utilized. For non-reducing gels, 100 μl of the diluted sample was mixed with 100 μl of 2× Laemmli buffer. On the other hand, in the case of reducing gels, a combination of 100 μl of diluted samples, 95 μl of Laemmli buffer, and 5 μl of β-mercaptoethanol was used. The samples were heated in a water bath at 75° C. for 15 minutes and then cooled to 25° C. before loading onto the gels. A volume of 5 μl from these samples was loaded onto the gels. Electrophoresis of the gel was performed at 200V, followed by staining using Imperial™ Protein Stain. De-staining was conducted using distilled water for 48 hours. The Molecular Imager Gel Doc XR system (Bio-Rad Laboratories, Hercules, CA) was employed to scan and analyze the prepared gels.

A revolution powder analyzer (Mercury Scientific Inc, Newtown, CT, USA) assessed the protein powders' flowability. A precise 20 g sample was carefully weighed and transferred into a 100 cc drum designated for testing. The testing parameters were meticulously configured as follows: a rotation rate of 0.3 RPM, an imaging rate set at 10 FPS, a preparation time of 200 seconds, and the test concluded automatically after 128 avalanches were recorded. The analysis centered on evaluating the energy of these avalanches, providing valuable insights into the flowability characteristics of the examined samples.

Utilizing the Horiba Laser Scattering Particle Size Distribution Analyzer (LA—960), specifically the Horiba Scientific Partica model (Horiba Scientific, Piscataway, NJ), particle size distribution analysis of the protein powders was conducted. 0.5 g of the sample was added to the analyzer for each analysis. Before analysis, the refractive index was calibrated to 1.46, a value sourced from the work of Crowley et al. for MPC. The resultant mean particle size was computed using a triplicate analysis approach, facilitating a comprehensive data comparison.

The functional properties were considered individual responses or dependent variables, and the behavior or response changes were evaluated and predicted using response surface methodology. A central composite face-centered design system with 16 experiments was used to investigate the effects of independent variables on the dependent variables. The optimum conditions of PEF processing parameters for dependent functionality variables were predicted with the maximum desirability of the model. The predictions were based on minimum and maximum optimum parameters of independent variables of PEF processing—Temperature, electric field strength, and frequency for a desired product functionality using Design of Experiments software (Design Expert, Version 14, Stat-Ease Inc, Minneapolis, MN). The temperature as A, electric field strength as B, and frequency C were analyzed at three different levels to investigate and optimize the effect of PEF on the functionality of MPC85. Based on the previous study, the operating parameters were selected for modeling the data: temperature: 25 to 65° C., electric field strength: 4 to 20 kV/cm, and frequency: 30 to 300 Hz at three different levels. Table 2.1 represents the data matrix with designs with all the natural and coded variables. The parameters' highest and lowest values are coded as +1 and −1, with the mid value of the sample coded as 0. The results that were obtained were fitted into a quadratic equation. The coefficients of responses were analyzed with analysis of variance (ANOVA), 95% confidence interval. The obtained experimental results were fitted into the following quadratic equation as:

$$Y = {β}_{0} + {β}_{1} A + {β}_{2} B + {β}_{3} C + {β}_{12} AB + {β}_{23} BC + {β}_{13} AC + {β}_{11} {A}^{2} + {β}_{22} {B}^{2} + {β}_{33} {C}^{2} \qquad ( 2.5 )$$

In the equation, Y— dependent variable, A, B, and C, Independent variables, β₀-constant-coefficient, β₁, β₂, and β₃—linear regression coefficients, β₁₁, β₂₂, and β₃₃—regression coefficients that are squared. β₁₂, β₁₃, and β₂₃—interaction coefficients of the independent variables

The multiparameter response for post-processing of MPC85 milk protein concentrate 85 was performed using JMP Pro 17 ® (JMP, Version 17, JMP Statistical Discovery LLC, Cary, NC) software with the help of prediction profiler and prediction stimulator to understand the optimal condition for a variety of responses (functional properties) based on the end product application.

TABLE 2.1
Natural and coded levels of independent and dependent
variables of pulsed electric field processing.

| Independent variables | Coded levels | | |
|---|---|---|---|
| | −1 | 0 | +1 |
| | Natural levels | | |
| Temperature (° C.) | 25 | 45 | 65 |
| Electric field strength (kV/cm) | 4 | 12 | 20 |
| Frequency (Hz) | 30 | 165 | 300 |

The pH of the samples was within the range of 6.7-6.9. We have used two control samples: Control 1 (Run 1)—commercial sample without reconstitution and Control 2 (Run 2)—sample which was reconstituted, homogenized at 25° C., and spray dried. This allows us to eliminate environmental changes from respray drying as much as possible.

The spray-dried powders were analyzed for the efficiency of the spray-drying process from total solids input to the total solids that was recovered after spray drying. The spray drying process provided 92% efficiency on average throughout all the processes. The inlet and outlet temperatures for all the PEF-treated samples and the controls were monitored to understand the amount of thermal energy input into the process during the PEF treatment (Table 2.2). There was a minimum rise of 1° C. average to a maximum of 16° C. on the treatments involving higher electric field strength and frequency which was also in accordance with literature. The temperature increase with PEF treatment was also theoretically calculated with the following formula from Lindgren et al.,

$$Δ {T}_{estimated} = Ψ / ρ \cdot {C}_{v} K \qquad ( 2.6 )$$

$$Ψ = \frac{{P}_{in}}{Φ} \qquad ( 2.7 )$$

$$Ψ = U \cdot I \cdot τ \cdot f / Φ \qquad ( 2.8 )$$

Where, ρ is the density (kg/m³), Cᵥ is the heat capacity (J/(kg·K), Pᵢₙ is the average electric input powder (W), U is the applied voltage (V), I is the current (A), τ is the duration of one square pulse (s), f is the pulse frequency (Hz), Φ is the flow rate (m³/s).

The experimental temperature of this study was in accordance with the theoretical value for temperature. The temperature increase is dependent on energy, which implies that it was also dependent on all three parameters of PEF in the study. The temperature rise indirectly states there are higher possibilities of whey protein denaturation in the system; however, since the maximum temperature was 65° C., the denaturation of protein can be taken negligible, but in order to understand the extent of the denaturation, process analysis must be further carried out with SDS PAGE. This might positively or negatively impact the functional properties of the spray-dried protein powders used for further applications. The inlet and outlet temperatures were varied in most cases, and factors such as temperature, total solids, and size of the droplets affect the protein denaturation characteristics.

TABLE 2.2
Face-centered central composite design and temperature
difference after PEF treatment for reconstituted
MPC 85 generated using Stat Ease 360 software

| | | | | Temperature rise |
|---|---|---|---|---|
| | Temperature | EFS | Frequency | (° C.) |
| Runs | (° C.) | (kV/cm) | (Hz) | ΔT |
| 1 (Industry | 0 | 0 | 0 | 0 |
| control) | | | | |
| 2 (Respray | 0 | 0 | 0 | 0 |
| dried control) | | | | |
| 3 | 65 | 20 | 300 | 12 |
| 4 | 65 | 4 | 300 | 0 |
| 5 | 25 | 4 | 30 | 7 |
| 6 | 45 | 12 | 165 | 3 |
| 7 | 65 | 20 | 30 | 0 |
| 8 | 65 | 4 | 30 | 0 |
| 9 | 25 | 20 | 300 | 16 |
| 10 | 25 | 20 | 30 | 7 |
| 11 | 25 | 4 | 300 | 5 |
| 12 | 45 | 4 | 165 | 1 |
| 13 | 45 | 12 | 165 | 3 |
| 14 | 45 | 12 | 30 | 2 |
| 15 | 45 | 12 | 300 | 5 |
| 16 | 25 | 12 | 165 | 6 |
| 17 | 65 | 12 | 165 | 0 |
| 18 | 45 | 20 | 165 | 9 |

The retention time for the sample in the PEF chamber for the treatment was calculated to be 33 ms based on equation (2.4) for the diameter of 10 mm, flow rate of 87 l/h, and length of 10 mm.

$$τ = \frac{L}{v} = \frac{L \times A}{Q} \qquad ( 2.9 )$$

Where, τ—Retention time (ms), v—Velocity (m/s), A—Cross-sectional area (mm²), Q=V/t—Volumetric flow rate (L/s), L—Length (mm).

The effect of PEF processing on functional properties was analyzed using a face-centered central composite design with α=1. ANOVA was used to analyze the coefficients of the interaction terms and linear and quadratic terms. Each parameter's impact was calculated based on β-value (p<0.05) as statistically significant or insignificant. A lack of fit test was used to evaluate the quadratic model for each functionality test, and 3D plots were developed using STAT-EASE 360® software. The desirability of the optimized conditions was evaluated, and the best condition was chosen to optimize the target functional properties.

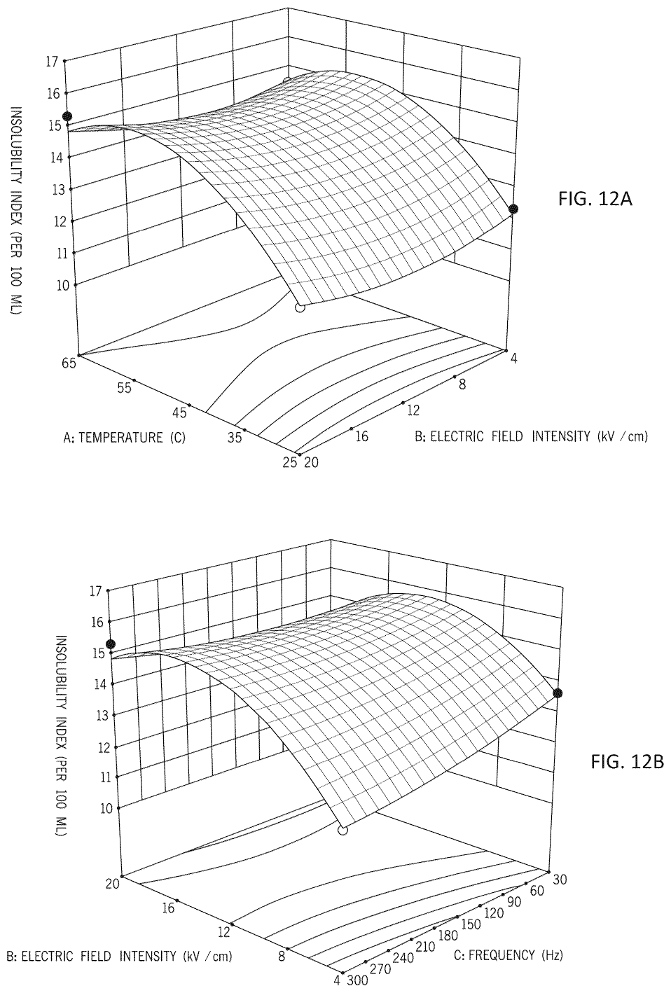

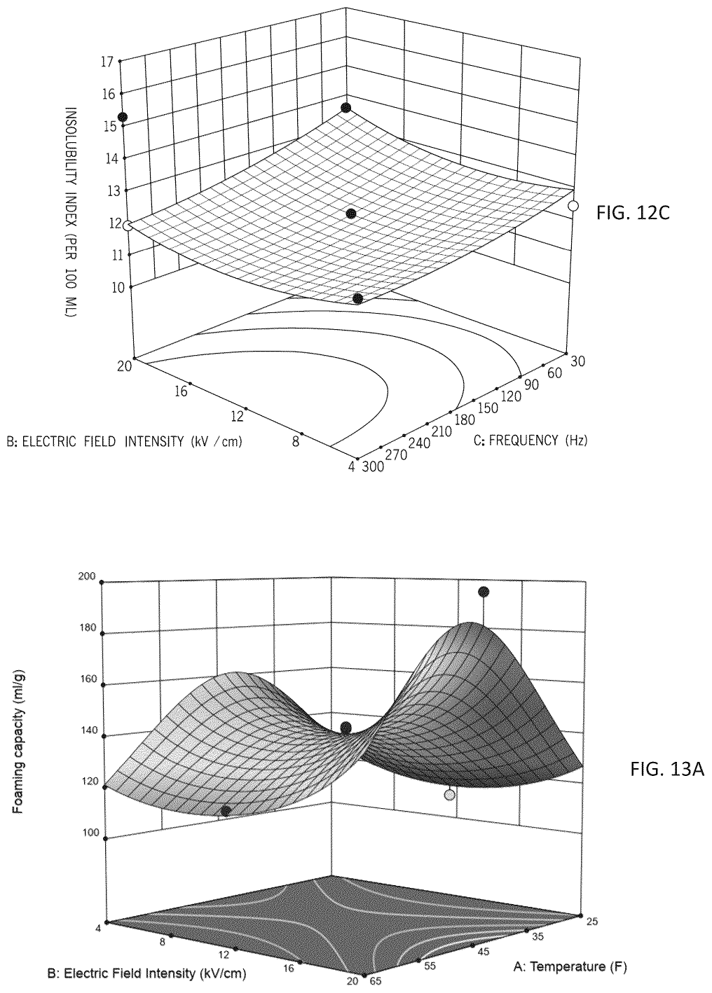

The processing parameters for PEF were analyzed for the minimum insolubility index of MPC85. The 3D surface models FIGS. 12A-12C concluded that with a decrease in temperature and middle range for EFS and frequency, reconstituted milk protein concentrates 85 has a minimal insolubility index. From the results, the temperature played the most significant parameter in the study with insolubility index since the interaction effect showed that increasing EFS and increasing frequency for the decrease in temperature considerably reduced the insolubility index. Thus, increasing both EFS and frequency plays a significant role in decreasing the insolubility, with temperature being the mutual factor of interaction. This interaction effect might be due to the changes in the protein structure caused by the EFS applied, exposing hydrophilic groups, making them more soluble, and decreasing the insolubility index.

During PEF processing, the electric fields ionize some chemical groups in the protein structure. The movement of amino acids in the polypeptide chain due to the unfolding of the protein could have a positive or negative effect on the hydrophobicity, hydrophilicity, and distribution of charge in the protein molecule depending on the electric field applied which can be observed from this study. These changes in the conformation of the protein, expose its hydrophobic and hydrophilic amino acids and other sulfhydryl amino acids to the surface which is in accordance with the results that increased the solubility.

The insolubility index has been shown to increase as more hydrophobic groups are exposed to the surface. Moreover, with PEF treatment, it can be expected that more hydrophilic groups are exposed on the surface, hence increased protein solubility. Therefore, PEF treatment leads to conformational changes in the protein structure by modifying the ionic interactions between proteins. Table 2.4 shows the ANOVA of the quadratic model fit, and since p<0.05, the model proves a significant fit, and the lack of fit was not significant.

From the data obtained, insolubility index data was fitted into a quadratic polynomial equation 2.10 given by,

$$Insolubility index ( MPC 85 ) = 6.46 + 39.72 \times {10}^{- 2} A - 15.38 \times {10}^{- 2} B - 11.51 \times {10}^{- 3} C + 6.48 \times {10}^{- 4} AB + 1.93 \times {10}^{- 4} AC - 1.75 \times {10}^{- 4} BC - 44.19 \times {10}^{- 4} {A}^{2} + 76.16 \times {10}^{- 4} {B}^{2} + 1.3 \times {10}^{- 5} {C}^{2} \qquad ( 2.1 )$$

The data followed a quadratic model with R² of 0.90 and satisfying conditions for a good model fit. The optimized model has an 11 ml insolubility index and desirability of 0.9, thereby minimizing the insolubility from 19.83 ml (Run 1) or 14.83 ml (Run 2) to 11.99 ml, essentially causing a 20% decrease in comparison to re-spray dried powder and 39.5% decrease to control.

Observations indicated that PEF treatment can induce positive or negative effects on the insolubility index depending on the treatment conditions applied. From runs 3, 7, 9, and 14 produced a lower insolubility index with a minimum of 12 ml per 100 ml of 6% protein sample. Similarly, runs 10, 12, and 16 produced a higher insolubility index with a maximum of 15.50±0.71 ml per 100 ml of 6% protein sample. Optimizing the treatment conditions of PEF to provide a minimum insolubility index is essential to prevent excessive treatment and denaturation of the protein, leading to a higher insolubility index. From the results from Table 2.4 and FIGS. 12A-12C, the minimum insolubility index of 12 ml/100 ml of 6% protein sample was obtained at a temperature of 25° C., EFS 20 kV/cm, and frequency at 300 Hz. The maximum insolubility index was 15.50±0.71 ml/100 ml of 6% protein sample at 45° C., EFS 12 kV/cm, and frequency at 30 Hz. The outcomes signify that pulsed electric field processing improves the solubility of MPC85 compared with commercial samples without PEF treatment. The insolubility index of PEF-treated MPC85 was 1.3 times less than control 2 and 1.7 times less than control 1.

The data obtained from runs 1 and 2, with constant EFS at 20 kV/cm and frequency at 300 Hz and varying temperatures from 65° C. and 25° C., suggests that an increase in temperature leads to 15.33±0.47 per 100 ml of 6% protein sample and drop in temperature provided the minimum of 12 ml per 100 ml of 6% protein sample. A similar trend can be observed with runs 2 and 9, 14 and 15. For the EFS, having a constant temperature at 25° C. and frequency at 30 Hz, and varying EFS of 4 and 20 kV/cm for runs 3 and 8, it can be observed that lower the EFS minimized the insolubility index to 12.50±0.71 ml per 100 ml of 6% protein sample and a similar trend can be observed for runs 7 and 9. For runs 3 and 8, the increase in frequency leads to a decrease in the insolubility index. The higher insolubility index might be due to exposure to more hydrophobic residues in milk protein concentrates. This could infer that the milk proteins have undergone extensive denaturation due to PEF treatment, leading to the opening and exposure of the protein core containing the hydrophobic residues. The minimum insolubility index might be potentially caused by partial denaturation to the optimal treatment, leading to partial exposure of hydrophilic and hydrophobic groups hidden from the milk proteins' surface. Thus, PEF treatment could potentially lower surface hydrophobicity and higher surface charge.

TABLE 2.4
Anova for the fitted model for the insolubility index

| | Sum of | | Mean | F- | p- | |
|---|---|---|---|---|---|---|
| Source | Squares | df | Square | value | value | |
| Model | 18.03 | 9 | 2.00 | 6.09 | 0.0197 | significant |
| A-Temperature | 6.13 | 1 | 6.13 | 18.63 | 0.0050 | |
| B-Electric | 0.5476 | 1 | 0.5476 | 1.66 | 0.2445 | |
| Field Intensity | | | | | | |
| C-Frequency | 0.0706 | 1 | 0.0706 | 0.2144 | 0.6596 | |
| AB | 0.0861 | 1 | 0.0861 | 0.2617 | 0.6272 | |
| AC | 2.17 | 1 | 2.17 | 6.61 | 0.0423 | |
| BC | 0.2850 | 1 | 0.2850 | 0.8662 | 0.3879 | |
| A² | 8.24 | 1 | 8.24 | 25.03 | 0.0024 | |
| B² | 0.6263 | 1 | 0.6263 | 1.90 | 0.2169 | |
| C² | 0.1486 | 1 | 0.1486 | 0.4516 | 0.5266 | |
| Residual | 1.97 | 6 | 0.3290 | | | |
| Lack of Fit | 1.63 | 5 | 0.3260 | 0.9463 | 0.6489 | not |
| | | | | | | significant |
| Pure Error | 0.3445 | 1 | 0.3445 | | | |
| Cor Total | 20.01 | 15 | | | | |

MPC85 are known to have lower solubility of 53% after storage for two days and solubility index >14.0 ml which is in alignment with the results. However, it is essential to understand that the reasoning behind the difference in values could be due to the source of the milk protein, and methodology could make a difference in calculating the insolubility index of the protein. A similar enhancement of protein was observed to improve solubility for soy protein isolate upon PEF treatment. Thus, having a lower temperature, higher frequency, and lower EFS would assist in producing MPC85 with a lower insolubility index. Since the ranges selected for the study for temperature is from 25° C., the optimized results will only be conclusive for this parameter under study. Also, increasing the frequency of the system might not be ideal since the increase causes a rise in temperature of a few degrees, and based on the current study, the maximum is about 16° C.

### Foaming Capacity and Foaming Stability

Foaming refers to the ability of the protein to produce foam per unit weight of protein and to stabilize the foam against internal and external forces. It is referred to as the forming ability of the protein at the air-water interface. Highly stable forms are formed by proteins if they readily absorb at the surface or form highly viscous solutions. Data shows the effects of PEF treated on the foaming capacity and stability. The study's results agree with the findings from where research indicates enhancement of foaming properties for SPI and egg proteins on application of PEF treatment.

The processing parameters for PEF were analyzed for the maximum and minimum foaming stability and capacity for MPC85. A power transformation of the model was employed for better understanding and diagnostics where X=−1.99 and constant=0 (based on the data diagnostics and dataset). Table 2.5 shows the ANOVA for the quadratic model fit for foaming capacity and since p<0.05, the q model proves to be a significant fit with lack of fit not significant at p value <0.01. The R² for the model was at 0.89 and in agreement with all the model parameter graph diagnostics.

TABLE 2.5
ANOVA for foaming capacity of MPC85
with the fitted quadratic model.

| | Sum of | | Mean | | | |
|---|---|---|---|---|---|---|
| | Squares | | Square | F- | p- | |
| Source | (·10⁻¹¹) | df | (·10⁻¹¹) | value | value | |
| Model | 364.2 | 9 | 0.40 | 5.85 | 0.0217 | significant |
| A-Temperature | 2.60 | 1 | 2.60 | 0.3768 | 0.5618 | |
| B-Electric | 22.13 | 1 | 0.22 | 3.20 | 0.1238 | |
| Field Intensity | | | | | | |
| C-Frequency | 17.14 | 1 | 0.17 | 2.48 | 0.1664 | |
| AB | 24.78 | 1 | 0.24 | 3.58 | 0.1071 | |
| AC | 26.87 | 1 | 0.26 | 3.89 | 0.0961 | |
| BC | 53.95 | 1 | 0.54 | 7.80 | 0.0314 | |
| A² | 184.0 | 1 | 0.018 | 26.62 | 0.0021 | |
| B² | 77.06 | 1 | 0.77 | 11.15 | 0.0156 | |
| C² | 0.24 | 1 | 23.81 | 0.0344 | 0.8589 | |
| Residual | 41.47 | 6 | 6.91 | | | |
| Lack of Fit | 41.46 | 5 | 8.29 | 744.44 | 0.0278 | Not |
| | | | | | | significant |
| Pure Error | 0.011 | 1 | 111.4 | | | |
| Cor Total | 405.6 | 15 | | | | |

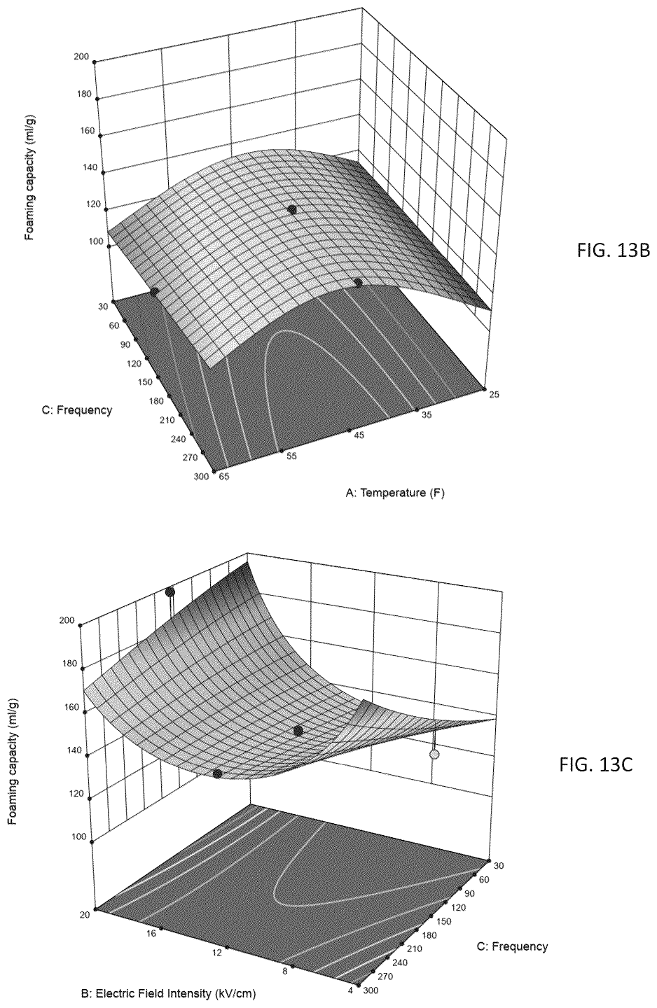

From the 3D surface models (FIGS. 13A-13C), temperature and EFS played a critical role in the foaming capacity of MPC85. The interaction effect between EFS and Frequency was vital for enhancing the foaming capacity of MPC85. The interaction effects between temperature and EFS and frequency, with EFS being the mutual interaction factor, lead to maximizing foaming capacity. However, the interaction effect between frequency and temperature decreased the EFS, with frequency having a minor effect on enhancing or reducing the foaming capacity of MPC85. These combination effects could be caused by changes in the secondary structure of the protein, exposing the hydrophobic and hydrophilic proteins and increasing the capacity of MPC85 to form foams.

From the data obtained for foaming capacity, data was fitted into a quadratic polynomial equation with powers transform and given by,

$${( Foaming capacity )}^{- 1.99} = 1.47 \times {10}^{- 4} - 5.25 \times {10}^{- 6} A + 6.13 \times {10}^{- 6} B - 4.25 \times {10}^{- 8} C - 3.47 \times {10}^{- 8} AB - 2.14 \times {10}^{- 9} AC + 7.6 \times {10}^{- 9} BC + 6.6 \times {10}^{- 8} {A}^{2} - 2.67 \times {10}^{- 7} {B}^{2} + 5.21 \times {10}^{- 11} {C}^{2} . \qquad ( 2.11 )$$

Where, —temperature, B—Electric field strength, and C— frequency and, AB, BC, AC represents interaction terms, and A², B², C² represent quadratic terms. Equation (2.4) was used to predict the response for given levels of each factor. Runs 8 and 16 produced a minimum foaming capacity of 105.33±1.89 (ml/g). Similarly, runs 4, 6, 7, 12, 13, 15, and 18 produced a maximum foaming capacity with a maximum of 195.33±3.77 (ml/g). The foaming capacity of MPC85 followed a quadratic model. The optimized conditions for minimum and maximum foaming capacity were calculated as follows: Temperature 65° C., EFS at 6.6 kV/cm and frequency at 30.4 Hz for a minimum of 105.665 (ml/g), and Temperature 45.5° C., EFS at 20 kV/cm and frequency at 30 Hz for a maximum of 197.09 (ml/g). The optimized processing conditions for minimum and maximum had a desirability of 1 and 0.75 satisfying conditions for good model fit.

Foaming is a fundamental functional property where proteins play a significant role in forming and stabilizing foams for aeration. Heat treatment, pH, and ionic environment influence the foaming properties of milk protein concentrates. In general, the stability of the protein foams depends on rheological properties, elasticity, and disjoining pressure between the protein layers of the protein films. The stability of proteins is higher when their ability to form cohesive, elastic, and viscous films is enhanced. However, it is essential to note that from this study, the foaming stability was affected due to PEF treatment with a range of 10.83±2.01% to 101.23±1.75%. The models from the data obtained were proven to be insignificant, indicating that the parameters EFS, frequency, and temperature were not the only factors that could potentially affect the foaming stability of MPC85. Other external factors could be a possibility to optimize foaming stability for maximum and minimum.

Further analysis on foaming stability observed that, with higher temperature at 65° C., increased or decreased EFS affects the foaming stability with increased frequency. However, with decreased EFS and frequency, the foaming stability increased to 101.23%. At lower temperatures of 45° C. and 25° C., mid and lower EFS, mid and higher frequency had an increased foaming stability up to 87.83% but not as high as 65° C. Overall, the data obtained does not follow a pattern on the EFS or frequency. However, slight differences exist in the increase or decrease in foaming stability. Therefore, the data was not optimized for foaming stability since the model was insignificant.

In addition, the foaming properties of proteins are related to protein hydrophobicity and surface charge. Protein that are highly charged and with less hydrophobic groups do not form cohesive network due to solid repulsion on the other hand, highly hydrophobic protein molecules tend to coagulate or precipitate on interfacial denaturation process and form less stable foams, which could be possible reason. Constant reports of MPC having lower solubility, emulsion, foaming, and water holding almost agree with other protein powders. Thus, PEF treatment could serve as an alternative option to maximize and minimize the foaming capacity of MPC85 but not for foaming stability.

### Emulsion Stability

The data does not follow a quadratic model. However, the data provided an understanding of the effect of parameters required for changes in emulsion stability after PEF treatment. Keeping the temperature constant at 65° C., the increase in frequency and decrease in electric field strength had an increased effect on emulsion stability at 20.14 min. At 45° C., a combination effect was observed where EFS and frequency together alter the emulsion stability of the sample. The emulsion stability was observed to slightly increase with EFS and frequency. However, at higher conditions of EFS and frequency, the emulsion stability decreases. At 25° C., a decrease in both EFS and frequency tends to increase emulsion stability. However, at the highest EFS (20 kV/cm) and frequency (300 Hz), the emulsion stability was 23.08 min. Keeping EFS constant, at 4 kV/cm, with 45° C., better emulsion stability could be achieved at 165 Hz. At 12 kV/cm, the lowest frequency at 30 Hz has the emulsion stability of 20.05 min. Similarly with temperature, lower temperature had a better emulsion stability. From the observed analysis, lower temperature at 25° C., mid EFS 12 kV/cm, and mid frequency 165 Hz attained higher emulsion stability of 22.83 min. The lower temperature at 25° C., highest EFS of 20 kV/cm, and frequency of 300 Hz attained the highest stability of 23.08 min. Although these minor changes were observed the data was not significant for predictive modelling.

Individual milk proteins are known to have excellent emulsifying properties but are limited when they are aggregated or micellar. Emulsifying properties are usually dependent on type of oil, protein concentration, and homogenization. Heat treatment has varying effects on whey and casein proteins and has adverse effects. MPCs are known to be excellent emulsifiers due to the inherent amphiphilic structure of their proteins. MPCs are reported to have lower emulsion ability when compared to other milk proteins. They form stable emulsions at higher protein concentrations in solution. Stable emulsions are obtained using physical methods such as classic rotors, homogenizers, and ultrasound. Also, it needs to be considered that emulsion stability can be correlated to other functional parameters tested. Emulsion stability is negatively correlated to foaming capacity at −0.33 and −0.21 for foaming stability with the observed data. This is also an indication that the samples can be optimized for specific parameters; however, having a higher foaming stability or capacity could necessarily indicate that there would be lower emulsion stability. Hence, prediction of emulsion stability was not achievable with this study.

### Water Holding Capacity

Similar to Emulsion stability, the water holding capacity did not follow a quadratic equation and the model prediction was not achieved. The data was analyzed to understand the effect of processing parameters on the water-holding capacity of MPC85. Water holding capacity (WHC) for MPC85, at 65° C., an increase in EFS at the highest 20 kV/cm and a decrease in frequency to 30 Hz improved the water holding capacity to 68.83%. Similarly, decreasing the EFS to 4 kV/cm and increasing the frequency to 300 Hz enhanced the WHC to 60.89%. However, at 45° C., the mid-EFS range of 12 kV/cm and the mid-frequency of 165 Hz increased WHC to 66.94%. Notably, at 45° C., when keeping the frequency at 165 Hz, lowering the EFS to 4 kV/cm or increasing it to 20 kV/cm decreased the WHC to 36.99% and 56.04%, indicating that EFS affects the WHC of MPC85. At 25° C., keeping the EFS at 4 kV/cm and frequency at the lowest 30 Hz improved WHC to 84.44%. Both EFS and frequency tend to impact increasing the WHC of MPC85 positively. The temperature was also observed to play a role since EFS and frequency changes to the temperature used to attain the highest WHC. Keeping the EFS constant at 4 kV/cm to analyze the effect of frequency and temperature, it was observed that lowering temperature and frequency increased the WHC to 84.44%, and increasing Temperature and frequency decreased water holding capacity to 64.79%. At 12 kV/cm, a lower temperature of 25° C. and mid-frequency enhanced the WHC to 70.36% but lower than 88.37% when EFS was at 20 kV/cm and temperature and frequency were kept constant. Increasing temperature or decreasing frequency at 20 kV/cm tends to decrease the WHC of MPC85. The PEF treatment at 25° C. with 20 kV/cm and 300 Hz and 4 kV/cm and 30 Hz increased WHC to 88.37% and 84.44%, which is an increase of 24.41% and 18.87% in comparison to commercial control (71.03%). The PEF treatment also decreased the WHC to 33% at 45° C., 12 kV/cm EFS, and 300 Hz frequency. Although there are some observed differences in WHC between the PEF treated and control samples, the changes were not significant to obtain model. There cannot be a conclusive result drawn from the observed data.

### Flowability Analysis

The flow properties of powder depend on the ingredient's composition and play a critical role in understanding the flow behavior. MPC are known to cake and hence have been affected in their flow behavior, which in turn causes trouble during the mixing process. MPC usually are stored in silos, and in general, the flow characteristics depend on the composition and other rehydration characteristics affected by the processing, storage environment and increased humidity. These factors could cause potential liquid bridges between MPC particles, making them challenging to flow. Particle size is essential when understanding the flow behavior of dairy protein powders. Smaller particle size has led to poor flow properties of MPC85 previously studied by and higher SSA due to particle-particle interactions.

More cohesive interactions have occurred between particles due to the higher protein content of MPC85. Larger particle size (decreased surface area) improves flowability. Most of the flowability challenges are caused by core flow or no flow when the powder forms a funnel and does not end up collapsing until mobile particles in the powder flow through it, sometimes the particles could stick to the sides of the inner wall and not flow from the hopper and this is generally termed as “Rat Holing”. In order to prevent “Rat Holing,” the MPC was optimized for better flow behavior.

TABLE 2.6
ANOVA for flowability of MPC85 with fitted quadratic model

| | Sum of | | Mean | F- | p- | |
|---|---|---|---|---|---|---|
| Source | Squares | df | Square | value | value | |
| Model | 523.53 | 9 | 58.17 | 4.13 | 0.0493 | significant |
| A-Temperature | 208.85 | 1 | 208.85 | 14.81 | 0.0085 | |
| B-Electric | 6.56 | 1 | 6.56 | 0.4654 | 0.5206 | |
| Field Intensity | | | | | | |
| C-Frequency | 156.82 | 1 | 156.82 | 11.12 | 0.0157 | |
| AB | 9.14 | 1 | 9.14 | 0.6481 | 0.4515 | |
| AC | 24.68 | 1 | 24.68 | 1.75 | 0.2340 | |
| BC | 40.28 | 1 | 40.28 | 2.86 | 0.1419 | |
| A² | 1.60 | 1 | 1.60 | 0.1138 | 0.7473 | |
| B² | 31.02 | 1 | 31.02 | 2.20 | 0.1885 | |
| C² | 3.37 | 1 | 3.37 | 0.2388 | 0.6424 | |
| Residual | 84.59 | 6 | 14.10 | | | |
| Lack of Fit | 77.56 | 5 | 15.51 | 2.21 | 0.4694 | not |
| | | | | | | significant |
| Pure Error | 7.03 | 1 | 7.03 | | | |
| Cor Total | 608.12 | 15 | | | | |

The analytical test for flowability was represented based on the avalanche energy.

The data obtained flowability (Avalanche energy) for MPC85 was fitted into a quadratic polynomial equation given by,

$$( Flowability ) = + 29.12 + 4.57 A - 0.81 B + 3.96 C - 1.07 AB + 1.76 AC - 2.24 BC + 0.78 {A}^{2} + 3.43 {B}^{2} + 1.13 {C}^{2.} \qquad ( 2.12 )$$

Where, A, B, and C represent temperature, electric field strength, and frequency.

However, this equation cannot be used to determine the relative impact of each factor because the coefficients are scaled to accommodate the units of each factor, and the intercept is not at the center of the design space. The flowability of MPC85 followed a quadratic model with R²=0.86, and the optimized conditions for minimum avalanche energy for maximum flowability were as follows: Temperature 32.8° C., EFS 12.46 kV/cm, and frequency 47.780 Hz with predicted avalanche energy at 25.08 kJ/kg and desirability of 1.0. Table 2.6 provides the ANOVA for the quadratic model, which is significant, and also the insignificant lack of fit. The temperature and frequency have significant effect on flowability which is evident from the ANOVA table where p<0.05.

Accordingly, lower avalanche energy was indicated to have better flow characteristics. The avalanche energy for flowability followed a quadratic model, and the optimum condition gave a minimum of 25.08 kJ/kg avalanche energy. This caused a 52.5% decrease from commercial sample control (52.9 kJ/kg) and 17.2% to respray dried control (30.3 kJ/kg). From the response surface graphs, lower frequency and electric field strength decrease the avalanche energy, implying higher flowability. Similarly, the mutual effect between temperature and frequency also shows a decrease in avalanche energy. The protein powder flowability was optimized, possibly due to the change in the protein structure with partial unfolding. This optimization using PEF could benefit the usage of ingredients in dry mixes and blends for MPC85 making the powder easy to flow.

### Particle Size Analysis

Particle powders were observed with similar mean particle sizes for control and PEF treated samples. The values are represented in Table 2.7. Spray-dried protein powders are ubiquitous ingredients of use for product applications. Flow characteristics are critical physical characteristics of powder for ease of handling and processing. The largest median particle size observed for MPC85 was 29.82 μm. The difference in mean particle size values could be explained by the difference from the industrial control representing volume. The input feed raw material with high solid content tends to yield larger particle sizes in the spray dryer due to higher viscosity, which can impair the atomization process. Additionally, the high solid content of the raw material will imply decreased droplet size with a consistent increase in the size of the particle. Increased atomization efficiency and droplet shrinkage can lead to a small particle size of MPC85. The particle size for MPC85 is d10=9.6, d50=26, d90=51, and SSA=0.74. The significant difference in particle size between the samples vs. literature could be attributed to the type of dryer used for commercial scale and pilot scale, total solids, the concentrate, atomizer speed, and drying efficiency. The mean particle size of MPC85 from the PEF-treated samples was 26-31 μm), and the median particle size was 23-28 μm). The mean range of the samples observed a 25% decrease from run 2 (respray dried sample) and a 50% decrease from run 1 (commercial sample). The data provided an understanding of reduced particle size from the commercial and respray-dried samples, indicating an increased surface contact area. Reduced particle size increases the surface contact area between particles and enhances the contact between cohesive forces. But there is no model prediction for the dataset for the same.

TABLE 2.7
Particle size analysis of reconstituted MPC85 after PEF treatment

| | Mean | Median | Mode | Std | | | |
|---|---|---|---|---|---|---|---|
| Runs | ( [symbol] m) | ( [symbol] m) | ( [symbol] m) | Dev | D(v, 0.1) | D(v, 0.9) | D(v, 0.5) |
| 1 | 52.703 | 41.549 | 41.954 | 39.103 | 17.648 | 100.976 | 41.549 |
| 2 | 35.383 | 28.404 | 27.943 | 26.549 | 13.529 | 63.37 | 28.404 |
| 3 | 26.65 | 23.166 | 24.321 | 15.036 | 11.997 | 45.117 | 23.166 |
| 4 | 31.422 | 25.148 | 18.582 | 21.982 | 10.727 | 60.123 | 25.148 |
| 5 | 32.512 | 28.476 | 32.094 | 19.51 | 12.392 | 57.3 | 28.476 |
| 6 | 29.456 | 23.017 | 18.59 | 21.557 | 10.397 | 56.407 | 23.017 |
| 7 | 34.512 | 29.825 | 36.712 | 21.941 | 12.332 | 62.327 | 29.825 |
| 8 | 29.735 | 26.287 | 27.948 | 16.389 | 12.635 | 50.982 | 26.287 |
| 9 | 31.016 | 24.963 | 24.405 | 23.48 | 10.962 | 56.883 | 24.963 |
| 10 | 31.195 | 26.398 | 27.959 | 19.634 | 11.863 | 56.524 | 26.398 |
| 11 | 32.637 | 27.245 | 31.99 | 21.62 | 11.773 | 59.935 | 27.245 |
| 12 | 28.503 | 23.267 | 21.311 | 19.47 | 10.682 | 52.478 | 23.267 |
| 13 | 31.213 | 27.083 | 31.961 | 19.082 | 11.97 | 55.313 | 27.083 |
| 14 | 31.361 | 27.704 | 31.943 | 18.076 | 12.52 | 54.525 | 27.704 |
| 15 | 31.237 | 26.171 | 27.886 | 21.845 | 12.354 | 54.398 | 26.171 |
| 16 | 34.206 | 28.29 | 32.025 | 23.506 | 12.009 | 63.285 | 28.29 |
| 17 | 31.04 | 26.079 | 27.888 | 21.294 | 12.211 | 54.365 | 26.079 |
| 18 | 31.523 | 27.168 | 28.011 | 19.141 | 12.39 | 55.905 | 27.168 |

Molecular Weight Distribution with SDS

MPC was characterized for the molecular weight distribution using SDS-PAGE. The SDS PAGE was performed to understand whether there were inherent changes in the protein composition of the PEF-treated protein powders vs the control samples. The electrophoretic patterns obtained from the MPC85 samples revealed that the intensity of all the protein bands in MPC85 does not show any visible changes in the system based on the PEF treatment. The reports confirm this observation about no visible changes in the SDS protein structure bands if the samples are treated to appropriate EFS and intensity. This indicated that MPC85 treatment did not affect the composition, and there was no protein loss. The results from protein-protein linkages are mostly noncovalent bonds, and disulfide linkages are aggregated on top of the reducing gels and within the stacking region of the samples. Visual representation of the gels showed that protein bands of casein and whey protein are well defined and significant to note that the major protein bands such as as casein, R casein, x casein, β-lactoglobulin and α-lactalbumin in MPC85 treatment samples did not undergo any significant changes. Similar representations were obtained when non-reducing gels were analyzed. This implies that all the protein could be recovered as a monomeric protein in electrophoresis, and minimal covalent links were formed. Compared with the control, no significant difference was found in the electrophoretic patterns of MPC 85. Moreover, MPCs included several peptides ranging from 10 to 250 kDa. Overall, the SDS-PAGE analysis explained that no significant changes in the molecular weight of casein or whey protein were observed due to PEF treatment.

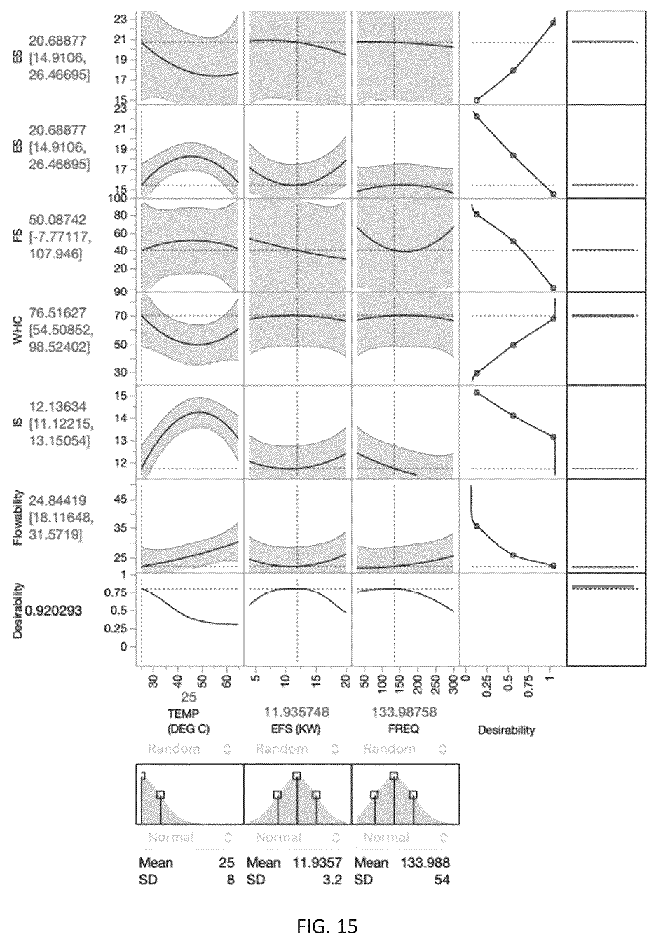

The multiparameter design for the improved functionality of reconstituted MPC85 was the primary objective of this research. Simulations were performed based on the multiparameter model assessed in the study from Table 2.10. FIG. 15 represents the prediction profiler for model 1.

The optimized condition for model 1, as shown in the table, was found to be 27° C. Temperature, 4.6 kV/cm EFS, and 30 Hz frequency. The predicted values for the process responses are as follows for model 1: Emulsion stability 21.48 min, Foaming capacity 120.52 m/g, Foaming stability 96.76%, Water holding capacity 74.25%, Insolubility index 13.31 g of sediment/100 ml and flowability at 25.04 KJ/kg with a model desirability of 0.86. This indicates a good fit for the multiparameter design. This functional PEF-treated MPC85 could be used for ingredient addition in bars, sports nutrition supplements, whipping cream, and medical nutrition. Table 2.9 provides an effect summary for the multiparameter designs based on all the functionality, and all the effects and the interaction effects have a β-value <0.05, indicating that the PEF parameters under study are significant.

The optimized condition for model 2, as shown in Table 2.10, was 25° C. Temperature, 11.9 kV/cm EFS, and 133.98 Hz frequency. The predicted values for the process responses are as follows for model 2: Emulsion stability 20.68 min, Foaming capacity 110.50 m/g, Foaming stability 50.08%, Water holding capacity 76.51%, Insolubility index 12.13 g of sediment/100 ml and flowability at 24.84 KJ/kg. The desirability of this model was found to be 0.92. This indicates a better fit of the model, and this PEF-treated MPC85 could be used in beverages, soups, salads, and nutritional supplements.

TABLE 2.10
Stimulation table for two different multiparameter models using JMP Pro 17

| Optimization | | | | | | | |
|---|---|---|---|---|---|---|---|
| model | Emulsion | Foaming | Foaming | | | | |
| simulation | stability | capacity | stability | WHC | IS | Flowability | Applications |
| Model 1 | Maximize | Maximize | Maximize | Maximize | Minimize | Minimize | Bars, Sports |
| | | | | | | | nutrition |
| | | | | | | | ingredients, |
| | | | | | | | whipping cream |
| Model 2 | Maximize | Minimize | Minimize | Maximize | Minimize | Minimize | Beverages, |
| | | | | | | | soups, salad |
| | | | | | | | dressings |

FIG. 15 indicates the interaction profiles for each response studied for optimization, the cross over shows better the interaction between processing parameters of PEF. The cross-over in the interaction profiles indicate interaction between two different parameters for the effects/responses under study, and the parallel line indicates less interaction or no interaction.

The individual responses and 3D surface plots for each parameter represented that the dependent variables, such as insolubility index, foaming capacity, and flowability, were affected and could be optimized. Variables such as foaming stability, emulsion stability, and water-holding capacity were also affected due to the independent variables. However, they did not follow a pattern to assign a model for PEF treatment for reconstituted milk protein concentrates. Based on the desirability value, it can be concluded that the optimized condition will be suitable and provide a predicted value 99% of the time the experiment is conducted.

This study evaluated the impact of pulsed electric field (PEF) on the functional properties of reconstituted MPC85. One of the significant findings of this study is that PEF can be used as an alternative post-treatment technology to improve the specific functionality of reconstituted MPC85. Overall, this study strengthens the idea that specific functional properties can be improved following the PEF, which may be due to the change in the protein structure with surface modifications and partial unfolding of the proteins. Despite these advantages, while using PEF, one has to ensure that the product is free of air bubbles, which can affect the treatment and lead to sparks. This study's empirical findings lay the groundwork for PEF and better usage of MPC85 in food applications.

The optimized condition for minimum insolubility index (11.99 g/100 ml) was 25° C., EFS at 9.98 kV/cm and frequency at 165.43 Hz, minimum foaming (105.66 m/g) was 65° C., EFS at 6.6 kV/cm and frequency at 30.4 Hz; maximum foaming capacity (197.09 ml/g) was 45.5° C., EFS at 20 kV/cm and frequency at 30 Hz, maximum flowability (25.08 kJ/kg) for reconstituted MPC85 was 32.8° C., EFS at 12.46 kV/cm and frequency at 47.78 Hz. The optimum multiparameter PEF processing condition for maximum functionality of MPC85 was found to be 27° C. Temperature, 4.6 kV/cm EFS and 30 Hz frequency for bars and whipped cream applications and 25° C. Temperature, 11.9 kV/cm EFS and 133.98 Hz frequency for beverage and soup applications. All the optimized conditions had a maximum desirability value for the models and provided evidence that the runs would have 99% success in obtaining the predicted value.

In conclusion, this research facilitated the understanding that critical physicochemical properties of MPC85 can be altered due to treatment with pulsed electric fields. The results presented can be further explored using PEF technology to alter other dairy and plant proteins. Further research should be conducted to explore the effect of other processing parameters and functional properties of MPC85.

### Optimization of Pulsed Electric Field Processing to Reduce the Viscosity of Micellar Casein Concentrate.

Due to its high casein content, micellar casein concentrate (MCC) is a stable protein currently used for various product applications. Our objective was to reduce the viscosity of MCC using a pulsed electric field (PEF), a non-thermal technology, as a pretreatment while manufacturing dry dairy ingredients. The multiparameter effect for PEF processing conditions such as temperature (15-45° C.), electric field strength (4-20 kV/cm), and frequency on functional properties (30-300 Hz) of micellar casein concentrate was investigated as a pretreatment to optimize the conditions to reduce viscosity and enhance powder properties. The optimized conditions for the minimum consistency coefficient were Temperature at 35° C., EFS at 4 kV/cm and frequency at 63 Hz, the consistency coefficient was 1440.57 Pa sⁿ which was 46% less than control at 30° C. The model had an R² of 0.91 and was significant with p<0.05 with a model desirability value of 1.0. Temperature and EFS were found to be the most critical parameters that affect the functionality. This study provides the optimized process conditions for reducing the viscosity of MCC using PEF, which would benefit the application of MCC in various end-product applications.

Most American consumers seek increased protein but of good quality in their everyday diet. In addition to protein-rich ingredients, customers also seek clean ingredients and minimally processed foods. Dairy proteins being the most desirable has led to an increase in milk proteins, a growing segment in the protein market, and is expected to increase in the future. Various milk proteins are available in the market depending on their end product usage and the desired functional attributes. The most used dairy protein ingredients are milk protein concentrates, isolates, caseinates, and micellar casein concentrates. Micellar casein has been gaining attention lately due to its unique features like high casein content, cold set gels, and heat stability. They are predominantly used in beverages that involve sterilization without affecting the native quality of the protein.

Micellar casein is a high-protein ingredient, generally manufactured in stages with microfiltration and diafiltration processes. Various methods, such as acidification, rennet utilization, co-precipitation, and filtration, are employed in the production of MCC, resulting in distinctive characteristics and protein-related challenges. Micellar casein concentrate (MCC), obtained through microfiltration, mainly consists of CN (kappa casein) in micellar form, lactose, minerals, and serum proteins. Skim milk is sent through a membrane where casein will be on the retentate, and serum proteins will be the permeate based on size. The retentate is termed micellar casein concentrate and consists mainly of casein. The serum proteins will be removed from the milk up to 95%. The final composition of MCC is dependent on the end product use.

The characteristics of casein have been utilized in food applications and added as an ingredient in confectionaries, meat, and cheese; meal replacers, nutritional products, whipped toppings, coffee whiteners, and healthy add-ons. MCCs are known to form thermally reversible gels and are generally tricky to rehydrate. Due to this phenomenon, MCC exhibits challenging functional properties as affected by process conditions such as time and temperature. The viscosity characteristic of MCC increased with increased protein content and higher casein proteins. Casein proteins are known for their reduced solubility due to non-polar residues; however, this issue is mitigated by the presence of carbohydrates in kappa casein and a low sulfhydryl content. MCC is well-known for its heat stability and has a rapid onset of cold gelation and thickening with time. These functionality variations are not entirely explained in the literature. However, there are various theories about the phenomena.

MCC faces challenges during processing as it can only concentrate up to 32% solids due to its highly viscous nature and susceptibility to gelling. This means that drying MCC is costly as the spray dryer uses much more energy to remove water from highly viscous fluids than evaporators for water removal. The primary issues faced during the processing of MCC involve viscosity and the formation of low-concentration gels, and there has been constant exploration around improving the viscosity of MCC for ingredient applications. Many methods, including chemical, physical, and enzymatic modification, have been explored, but with drawbacks. Due to this, there is an increasing value and demand for alternative process technologies such as ultrasound and pulsed electric fields (PEF).

PEF treatment utilizes electric fields to alter functional properties such as viscosity, particle size, and gelation. PEF improves the functional properties of proteins through structural modifications, minimizing nutrition loss, reducing the microbial load, and improving ingredients' quality. Specific effects of PEF on proteins would also depend on processing parameters. Previous studies have shown mixed results on dairy protein ingredients. Protein studies on PEF have caused no significant changes in the covalent bond group, surface hydrophobicity, and protein unfolding behavior, and the droplet size remained the same in the case of Whey Protein Isolate. In another study, PEF treatment improved surface hydrophobicity and caused secondary structure alteration for whey proteins combined with ohmic heating. It has also been reported that treatments with PEF on milk have reduced viscosity with enhanced coagulation properties of proteins due to a decrease in the size of the casein micelle with higher electric field strength. They have also been shown to reduce viscosity and smaller aggregates for whey proteins. It was also reported to protect the integrity of milk proteins due to reduced unfolding. The modifications of charges in casein micelle and ionic interaction between casein in milk protein were also observed with PEF processing. However, with BSA and applying PEF, the tertiary structure changed with EFS, leading to structural changes in hydrogen bonds. All these studies have indicated various levels of PEF treatment used, different systems at batch or lab scale, and more research is needed into the practical application and translatability of the industrial scale approach. Additionally, while the effect of PEF on various proteins was studied, more research needs to be done on optimizing process parameters for PEF to have desirable functional properties for dairy proteins, such as reducing the viscosity of MCC.

As PEF has been demonstrated to alter protein structure and reduce viscosity, this study aimed to investigate the effect of processing parameters of pulsed electric field processing on the rheological properties of MCC and optimize the parameters to obtain a maximum reduction in the viscosity of MCC. This could allow for higher concentrations of MCC to be used in end-product applications and potentially modify its functional properties.

### Materials and Methods

The Imperial™ protein stain was bought from Thermo Scientific in Waltham, MA. Calcium Chloride Anhydrous (CaCl₂)) was sourced from Fisher Scientific in Waltham, MA. 0-mercaptoethanol and Sodium Dodecyl Sulfate were utilized from Sigma Life Sciences, based in St. Louis, MO. Two times of Laemmli sample buffer, the Precision Plus protein standard, TGX Precast Gels (4-20%), and 10 times of Tris/Glycine/SDS Buffer were acquired from Bio-Rad Laboratories in Hercules, CA.

Commercial liquid micellar casein concentrate with 21% TS was obtained post-filtration, Pulsed electric treatment was applied based on the experimental design created using JMP Pro 17 ® (JMP, Version 17, JMP Statistical Discovery LLC, Cary, NC) and Design of Experiments software (Stat-Ease360, Version 14, Stat-Ease Inc, Minneapolis, MN). To assess PEF's impact on MCC, samples were exposed to various process conditions: temperature (15-45° C.), electric field strength (4-20 kV/cm), and frequency (30-300 Hz) as per prior research. Constants included a flow rate of 106.7 L/h, pulse width of 20 μs, and electrode gap of 10 mm. Inlet and outlet temperatures were monitored to understand system-generated heat. For each treatment, 11.34 kgs (25 lbs.) of the sample were processed through a heat exchanger (Direct/Indirect UHT/HTST Series, Microthermics®, Raleigh, NC) followed by PEF treatment. An industrial-scale continuous PEF system was used (ELEA El-Crack®, HVP 5, German Institute of Food Technologists, Quakenbruck, Germany) to apply the conditions per the experimental design. Post-PEF, samples underwent spray drying (Compact spray dryer type 1, APV Anhydro, Tonawanda, NY) with operating parameters: inlet temperature 170° C., outlet temperature 96° C., and atomizer speed 2500 rpm. The PEF system was cleaned after each run to prevent cross-contamination. Control samples at 15, 30, and 45° C. underwent heat treatment using the heat exchanger without PEF treatment. All treated/control samples were stored at 25° C. for analysis.

TABLE 3.1
Natural and coded levels of independent and dependent variables
pulsed electric field processing of micellar casein concentrate.

| Independent variables | Coded levels | | |
|---|---|---|---|
| | −1 | 0 | +1 |
| | Natural levels | | |
| Temperature (° C.) | 15 | 30 | 45 |
| Electric field strength (kV/cm) | 4 | 12 | 20 |
| Frequency (Hz) | 30 | 165 | 300 |

### Apparent Viscosity

Viscosity testing was carried out with Anton Paar Rheo Compass™ MCR 92 S/N 82312459 (Anton Paar GmhH, 8054 Graz, Austria) with a jacketed bob and cup fixture. A concentric cylinder (part number 6670) with an active length of 60 mm and a bob diameter of 42 mm was used for testing. 12% protein samples were prepared and mixed thoroughly and allowed to stand at room temperature for 15 min to equilibrate the condition. Each sample was tested in triplicates and was analyzed for shear stress, shear rate, viscosity, and torque. The apparent viscosity for each shear rate was log-transformed, and calculations were performed.

### Molecular Weight Profile

Protein profiling of MCC samples was conducted following the established method previously detailed by Walter, Greenberg, Sriramarao, and Ismail (2016). 10 μl of Precision Plus Protein Standard (MW 10-250 kDa) was loaded onto 4-20% precast Tris Glycine SDS gels. 100 μl of 1% samples diluted with 100 μl of distilled water were utilized for the samples. For non-reducing gels, 100 μl of the diluted sample was mixed with 100 μl of 2× Laemmli buffer. On the other hand, in the case of reducing gels, a combination of 100 μl of diluted samples, 95 μl of Laemmli buffer, and 5 μl of β-mercaptoethanol was used. The treated samples were kept at 75° C. for 15 min and further cooled to 25° C. A volume of 5 μl from these samples was loaded onto the gels. Electrophoresis of the gel was performed at 200V, followed by staining using Imperial™ Protein Stain. De-staining was conducted using distilled water for 48 hours. The Molecular Imager Gel Doc XR system (Bio-Rad Laboratories, Hercules, CA) was used to scan and analyze gels.

### Flowability

The revolution powder analyzer (Mercury Scientific Inc, Newtown, CT, USA) assessed the flowability of the protein powders. 20 g sample was carefully weighed and transferred into a 100 cc drum for testing. The testing parameters were rotation rate of 0.3 RPM, an imaging rate set at ten frames per second (fps), a preparation time of 200 seconds, and the test concluded automatically after 128 avalanches were recorded. The analysis centered on evaluating the energy of these avalanches, providing valuable insights into the flowability characteristics of the samples.

### Particle Size Analysis

Utilizing the Horiba Laser Scattering Particle Size Distribution Analyzer (LA—960), specifically the Horiba Scientific Partica model (Horiba Scientific, Piscataway, NJ), particle size distribution analysis of the protein powders was conducted. 0.5 g of the sample was added to the analyzer for each analysis. Before analysis, the refractive index was calibrated to 1.39, a value sourced from the work of Crowley et al. for MCC. A triplicate analysis approach established the resultant mean particle size, enabling a comprehensive data comparison.

### Response Surface Methodology

The consistency coefficient was calculated from shear stress and apparent viscosity. The consistency coefficient was considered as an individual response or dependent variable and used to predict viscosity using response surface methodology. A central composite face-centered design system with 18 experiments to explore the effects of PEF parameters on viscosity (i.e., consistency coefficient) was investigated. The optimum conditions of PEF processing parameters like temperature, electric field strength, and frequency were considered independent variables for reducing viscosity and were predicted with maximum desirability using Design of Experiments software (Stat-Ease360, Version 14, Stat-Ease Inc, Minneapolis, MN). The temperature as X1, electric field strength as X2, and frequency X3 were analyzed at three different levels to investigate and optimize the reduced viscosity of MCC. Based on the previous study, the operating parameters were selected for modeling the data: temperature: 15 to 45° C., electric field strength: 4 to 20 kV/cm, and frequency: 30 to 300 Hz at three different levels. Table 3.1 represents the data matrix with designs with all the natural and coded variables. The parameters' highest and lowest values are coded as +1 and −1, with the mid value of the sample coded as 0. The results that were obtained were fitted into a polynomial equation. The coefficients of responses were analyzed with analysis of variance (ANOVA), 95% confidence interval. The interaction profiles and actual vs predicted plots were analyzed using JMP Pro 17 ® (JMP, Version 17, JMP Statistical Discovery LLC, Cary, NC).

The obtained experimental results were fitted into the following quadratic equation as

$$Y = {β}_{0} + {β}_{1} A + {β}_{2} B + {β}_{3} C + {β}_{12} AB + {β}_{23} BC + {β}_{13} AC + {β}_{11} {A}^{2} + {β}_{22} {B}^{2} + {β}_{33} {C}^{2} \qquad ( 3.1 )$$

In the equation, Y— dependent variable A, B, and C—Independent variables—Temperature, electric field strength, frequency β₀—constant-coefficient β₁, β₂, and β₃—linear regression coefficients β₁₁, β₂₂, and β₃₃—regression coefficients that are squared. β₁₂, β₁₃, and β₂₃—interaction coefficients of the independent variables.

TABLE 3.2
Face-centered central composite design for
industrial scale PEF treatment of MCC

| | | Electric field | | |
|---|---|---|---|---|
| | Temperature | strength | Frequency | |
| Runs | (° C.) | (kV/cm) | (Hz) | |
| 1 | 45 | 12 | 165 | |
| 2 | 45 | 20 | 30 | |
| 3 | 15 | 12 | 165 | |
| 4 | 30 | 4 | 165 | |
| 5 | 30 | 12 | 165 | (Center) |
| 6 | 45 | 4 | 30 | |
| 7 | 15 | 20 | 30 | |
| 8 | 15 | 4 | 30 | |
| 9 | 45 | 4 | 300 | |
| 10 | 30 | 20 | 165 | |
| 11 | 15 | 4 | 300 | |
| 12 | 15 | 20 | 300 | |
| 13 | 30 | 12 | 300 | |
| 14 | 45 | 20 | 300 | |
| 15 | 30 | 12 | 165 | (Center) |
| 16 | 30 | 12 | 30 | |
| 17 | 30 | 12 | 165 | (Center) |
| 18 | 30 | 12 | 165 | (Center) |
| 19 | 15 | 0 | 0 | (Control) |
| 20 | 30 | 0 | 0 | (Control) |
| 21 | 45 | 0 | 0 | (Control) |

### Retention Time

The total retention or residence time for the MCC samples per run in the PEF chamber was calculated to be 26 ms using the formula.

$$τ = \frac{L}{v} = \frac{L \times A}{Q} \qquad ( 3.2 )$$

where, τ—Retention time (ms), v—Velocity (m/s), A—Cross-sectional area (mm²), Q=V/t—Volumetric flow rate (L/s), L—Length (mm).

The following values, diameter 10 mm, flow rate 106.7 L/h, and length 10 mm, were used to calculate the retention time based on the experimental setup.

### Temperature Changes in MCC Due to PEF Treatment

The inlet and outlet temperatures for all the MCC samples were monitored throughout the treatment process to understand the thermal energy footprint during the PEF treatment. The inlet and outlet temperatures for MCC are shown in Table 3.3. Based on the results, there was a minimum rise of 1.11° C. on average and a maximum of 12.50° C. in temperature after the PEF treatment. This is consistent with previous studies with MPC, where temperature rise was influenced by energy input for higher EFS and frequency. The study on casein micelles by Taha et al., also observed a slight increase in temperature after the PEF treatment.

The temperature increase could affect protein denaturation; however, the quantity of whey protein in MCC is much lower compared to MPC. Since whey denaturation occurs at 65° C. and casein protein undergoes changes at more significant than 100° C. (Farooq, 2019), the denaturation effect due to PEF treatment with MCC can be considered negligible as the maximum temperature after treatment was <47° C. The casein micelles also tend to offer more resistance to heat treatment than whey; thus, the effect on MCC can be considered minimal. To understand that the protein quality is still maintained after PEF treatment, SDS PAGE profiling was performed. Therefore, the observed temperature rise for MCC after the PEF treatment could be seen as a minimal effect on the casein stability as a protein.

TABLE 3.3
Temperature changes observed before and after
PEF treatment to MCC Temperature output (° C.)

| Temperature | Temperature | |
|---|---|---|
| Input (° C.) | output (° C.) | ⊗T(° C.) |
| 45.00 | 46.11 | 1.11 |
| 45.00 | 45.00 | 0.00 |
| 15.00 | 23.28 | 8.28 |
| 30.00 | 30.00 | 0.00 |
| 30.00 | 30.56 | 0.56 |
| 45.00 | 45.00 | 0.00 |
| 15.00 | 21.67 | 6.67 |
| 15.00 | 21.67 | 6.67 |
| 45.00 | 45.00 | 0.00 |
| 30.00 | 31.67 | 1.67 |
| 15.00 | 20.01 | 5.00 |
| 15.00 | 35.83 | 12.50 |
| 30.00 | 32.78 | 2.78 |
| 45.00 | 47.17 | 2.17 |
| 30.00 | 31.61 | 1.61 |
| 30.00 | 30.56 | 0.56 |
| 30.00 | 31.39 | 1.39 |
| 30.00 | 32.22 | 2.22 |

### Apparent Viscosity Analysis

The effect of PEF processing on the viscosity of micellar casein concentrate was analyzed using a face-centered central composite design, and Table 3.4 represents the results obtained. In theory, many models describe the relationship between viscosity and shear rate, including the power law, Bingham, and Herschel Bulkley models. Different equations have been used to understand the nonlinear flow behavior of micellar casein concentrate; however, due to its simplicity and applicability, the power law model has been used for this study. Equation (3.3) was selected for this model. In particular, the power law model has been employed previously to predict whether the shear thinning or shear thickening based on n value where n<1 denoted that the samples are shear-thinning fluids. The apparent viscosity collected from the study was used to calculate the consistency coefficient (m) and flow behavior index (n). The Consistency coefficient and flow behavior index are the two parameters that were calculated based on the apparent viscosity based on the following formula:

Apparent viscosity is calculated by the equation assuming yield stress=0,

$${μ}_{app} = - K {γ}^{n - 1} \qquad ( 3.3 )$$

Where, μₐₚₚ represents Apparent viscosity (Pa s), K represents the consistency coefficient (Pa sⁿ), γ represents shear rate (s¹), n represents the flow behavior index.

Applying the log function to equation (3.3),

$$Log ( {μ}_{app} ) = Log ( K ) + ( n - 1 ) Log γ \qquad ( 3.4 )$$

Equation (3.4) can be transformed to a line equation of y=ax+b where b represents intercept and a represents slope. y-Log (μₐₚₚ), b-Log(K)—intercept, a—(n−1)—slope, x-Log γ.

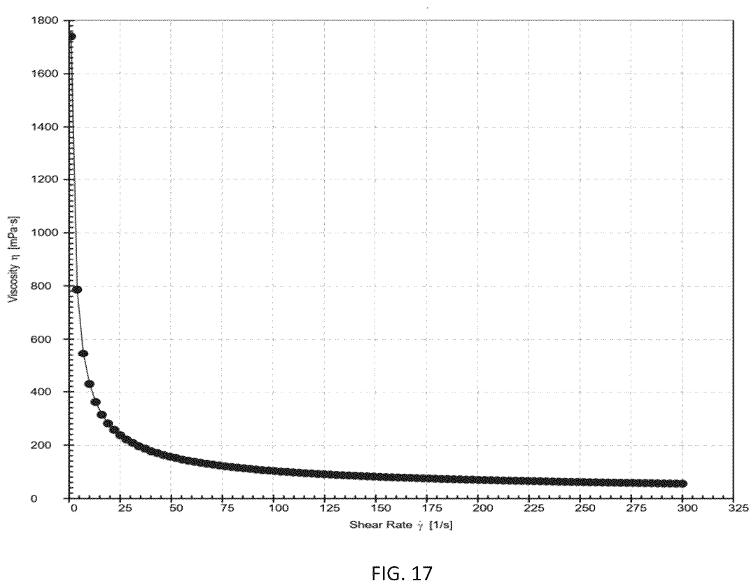

The micellar casein concentrates exhibited a shear thinning behavior with increased shear stress. Moreover, it is evident from the literature that MCC >7.5% casein concentration exhibited non-Newtonian or shear thinning behavior, which is on par with this study by Sauer et al. The casein concentration has been identified as a significant contributor previously to the viscosity characteristic of MCC but is also affected by the interference of other components in MCC, such as casein-casein interaction which can lead to reduced viscosity. Also, it has been shown that the shear thinning behavior of MCC is influenced by composition, concentration, temperature, and storage time. The results from this study also confirmed this shear thinning behavior of MCC after the PEF treatment with n<1. The result for the apparent viscosity of PEF-treated MCC (typical run) is shown in FIG. 17. The samples exhibited a shear stress thinning behavior at low shear rates, which differs from other ingredients where shear stress grows at a constant shear rate. Because all the MCC samples showed non-Newtonian behavior across the investigated range of shear rates, the consistency coefficient was calculated keeping n=0.5 constant (using the line equation, the average was calculated) and to keep the calculations consistent. Both m and n are considered functions of the protein content present in MCC.

Additionally, the apparent viscosity of MCC has also been noted to increase with increased concentration of casein due to beta-casein exclusion into the solution at lower temperatures. For this reason, 12% MCC solutions were tested, and the concentration was kept constant to avoid variation in its apparent viscosity and to understand the effect of PEF on the viscosity characteristic of MCC. The apparent viscosity of MCC is also known to decrease with an increase in temperature. However, this study used 15-45° C. to test the viscosity behavior to avoid heat-induced treatments and minimize the structural effect of protein changes, which would indirectly impact the function.

### Response Surface Analysis of Viscosity

PEF was analyzed for the minimum consistency coefficient of MCC as a reduction in consistency coefficient would indicate reduced viscosity. ANOVA was used to analyze the interaction terms' coefficients for MCC's consistency coefficient. The effect of process parameters was evaluated based on the β-value obtained (p<0.05) as statistically significant or insignificant, and finally, the model was assessed for significance. Compared with conventional and other heat, chemical, or enzymatic processing methods, pulsed electric field processing protects the protein functionality like gelation and viscosity more than the thermal treatments for dairy proteins. PEF is also shown to improve energy and cost-saving in the dairy industry.

TABLE 3.4
The face-centered central composite design and
temperature difference after PEF treatment for
MCC were generated using Stat Ease 360 software.

| | | Electric field | | Consistency |
|---|---|---|---|---|
| | Temperature | strength | Frequency | coefficient, K |
| Runs | (° C.) | (kV/cm) | (Hz) | (Pa sⁿ) |
| 1 | 45 | 12 | 165 | 865.59 |
| 2 | 45 | 20 | 30 | 2664.98 |
| 3 | 15 | 12 | 165 | 3809.31 |
| 4 | 30 | 4 | 165 | 1963.55 |
| 5 | 30 | 12 | 165 (Center) | 2316.87 |
| 6 | 45 | 4 | 30 | 1613.89 |
| 7 | 15 | 20 | 30 | 2749.28 |
| 8 | 15 | 4 | 30 | 2946.94 |
| 9 | 45 | 4 | 300 | 1781.77 |
| 10 | 30 | 20 | 165 | 1538.45 |
| 11 | 15 | 4 | 300 | 2995.77 |
| 12 | 15 | 20 | 300 | 2741.32 |
| 13 | 30 | 12 | 300 | 2565.07 |
| 14 | 45 | 20 | 300 | 3056.02 |
| 15 | 30 | 12 | 165 (Center) | 2348.72 |
| 16 | 30 | 12 | 30 | 2495.49 |
| 17 | 30 | 12 | 165 (Center) | 2537.74 |
| 18 | 30 | 12 | 165 (Center) | 2695.84 |
| 19 | 15 | 0 | 0 | 2787.28 |
| 20 | 30 | 0 | 0 | 2669.03 |
| 21 | 45 | 0 | 0 | 3011.36 |

### Interaction Profiles of PEF Processing Parameters.

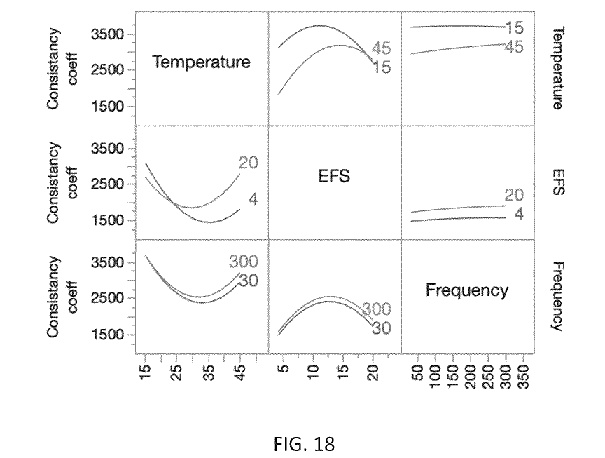

Additionally, interaction profiles were studied with JMP Pro® version 17 software. FIG. 18 indicates the interaction profiles for each response reviewed for optimization; the cross-over shows the interaction between processing parameters of PEF. The cross-over and curve in the interaction profiles indicate an interaction between two different parameters for the consistency coefficient under study, and the parallel line indicates less interaction or no interaction. From the figure for the interaction profiler, it can be observed that the frequency factor has the most minor interaction profile, followed by temperature and EFS, which have the maximum interaction, which is also evident from ANOVA from Table 3.4. Additionally, the individual effect of temperature is highly significant at a 95% confidence interval with a β-value of 0.0112 (from Table 3.4), indicating that the temperature had the maximum effect on PEF treatment with MCC.

The plot temperature* EFS interaction shows that the effect on the consistency coefficient is relatively constant at higher levels of EFS and variable at lower levels of EFS. However, the effect on the consistency coefficient was higher at different temperature levels. This interaction is significant with a β-value of 0.0061 (from Table 3.5), which is p<0.05 at a 95% confidence interval. On the other hand, with frequency, the interaction profiles with EFS and temperature need to be more robust to prove an effect on the consistency coefficient of MCC.

TABLE 3.5
Summary of effects for PEF treated MCC - Pre-
Treatment and ANOVA for the fitted model.

| | Sum of | | Mean | F- | P- | |
|---|---|---|---|---|---|---|
| Source | squares | Df | square | value | value | |
| Model | 4.774 × 10⁶ | 9 | 5.305 × 10⁵ | 8.25 | 0.0055* | *significant |
| A-Temperature | 7.511 × 10⁵ | 1 | 7.511 × 10⁵ | 11.69 | 0.0112* | |
| B-Electric | 2.097 × 10⁵ | 1 | 2.097 × 10⁵ | 3.26 | 0.1138 | |
| field strength | | | | | | |
| C-Frequency | 44805.62 | 1 | 44805.62 | 0.6971 | 0.4313 | |
| AB | 9.643 × 10⁵ | 1 | 9.643 × 10⁵ | 15.00 | 0.0061* | |
| AC | 33546.98 | 1 | 33546.98 | 0.5220 | 0.4934 | |
| BC | 3459.87 | 1 | 3459.87 | 0.0538 | 0.8232 | |
| A² | 1.452 × 10⁶ | 1 | 1.452 × 10⁶ | 22.58 | 0.0021* | |
| B² | 1.486 × 10⁶ | 1 | 1.486 × 10⁶ | 23.12 | 0.0019* | |
| C² | 2241.95 | 1 | 2241.95 | 0.0349 | 0.8571 | |
| Residual | 4.499 × 10⁵ | 7 | 64270.81 | | | |
| Lack of Fit | 3.562 × 10⁵ | 4 | 89059.37 | 2.85 | 0.2078 | not significant |
| Pure Error | 93658.18 | 3 | 31219.39 | | | |
| Cor Total | 5.224 × 10⁶ | 16 | | | | |

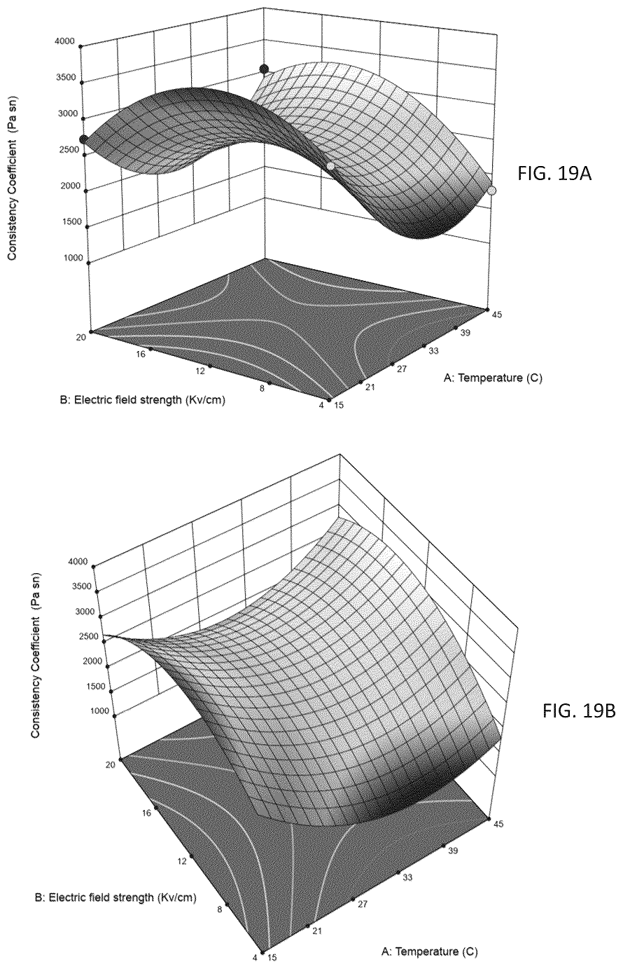

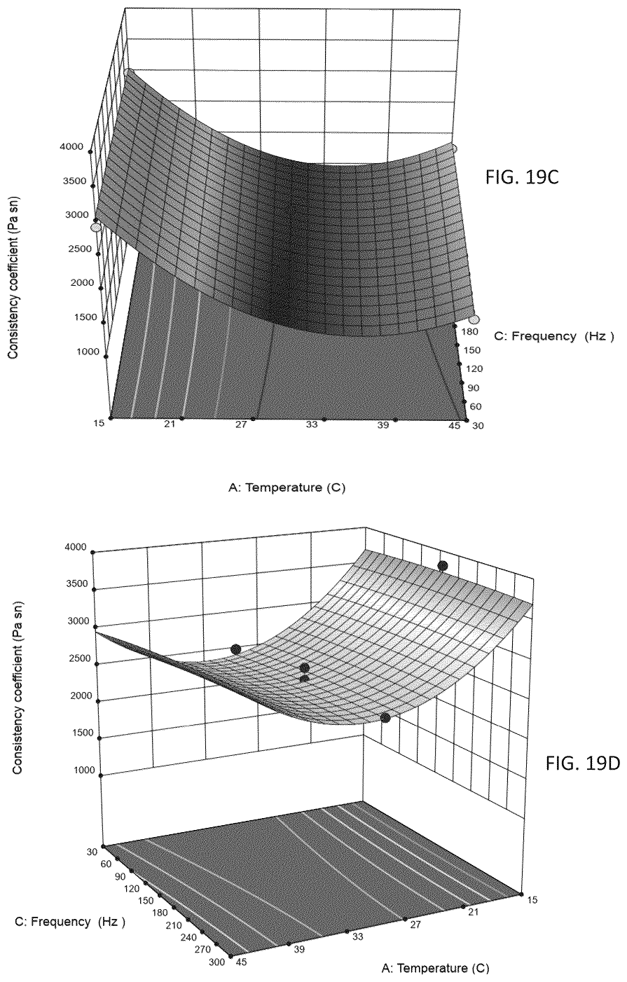

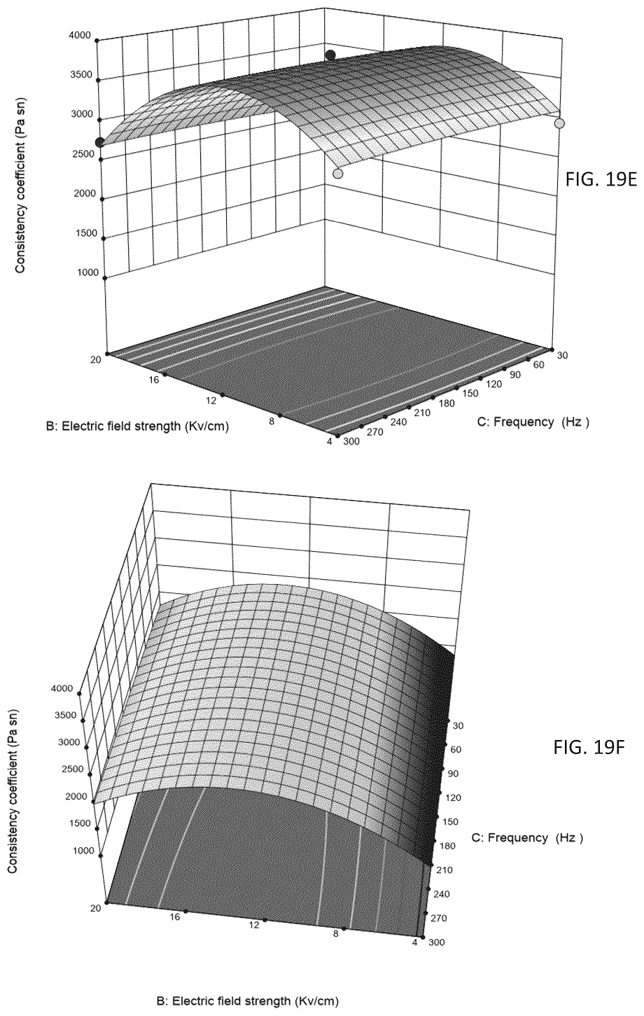

The 3D surface models shown in FIGS. 19A-F can assist in concluding that an increase in temperature had a maximum effect on the MCC consistency coefficient. At 45° C. temperature, 20 kV/cm electric field strengths, results showed a high consistency coefficient of 2664.98 Pa sⁿ. At 30° C., it exhibits a more varied response; at 12 kV/cm, the consistency coefficient varies with frequency. The highest value was recorded when the frequency was 165 Hz at 2695.84 Pa sⁿ, indicating that specific frequency-temperature combinations influence the fluid's viscosity, which is also the center point in the experimental design. Experiments conducted at center points represent the central points in the experimental design. These values remain crucial in understanding the reproducibility of the experiments in specific, well-defined conditions. At 20 kV/cm, the consistency coefficient was 1538.45 Pa sⁿ, indicating that higher electric field strength will be more effective at 30° C. This also suggests that the interaction between temperature and electric field strength is crucial and not a linear relationship. At 15° C., the consistency coefficient is at its maximum at 12 kV/cm and 165 Hz to 3809.31 Pa sⁿ; however, the consistency coefficient decreases at 20 kV/cm and 30 Hz. This suggests that viscosity is influenced by both temperature and frequency, with the electric field being a significant factor. Higher temperature and higher electric field strength correspond to an increase in the consistency coefficient. The results suggest a positive correlation between temperature and the consistency coefficient. Overall, across the temperature range, there is a trend of decrease or increase in consistency coefficient, emphasizing the synergistic effect of temperature and EFS on viscosity more. The temperature-dependent behavior also indicates that MCC viscosity is sensitive to changes in temperature. Combining high temperature, lower EFS, and low-frequency results in a lower consistency coefficient of 1613.89 Pa sⁿ, meaning reduced viscosity. This suggests that these conditions collectively contribute to an optimal state for maintaining the consistency coefficient.

At 20 kV/cm and 45° C., the consistency coefficient was 2664.98 Pa sⁿ, significantly higher than at 12 kV/cm (865.59 Pa sⁿ). Reverse trends were observed at 30° C., at 20 kV/cm; the consistency coefficient was lower (1538.45 Pa sⁿ) compared to 4 kV/cm at (1613.89 Pa sⁿ) and 12 kV/cm was 2348.72 Pa sⁿ. Also, at 30° C., the consistency coefficient is higher at 12 kV/cm (2348.72 Pa sⁿ) than at 4 kV/cm (1963.55 Pa sⁿ). Similar trends were observed for 15° C., suggesting that the effect of electric field strength is temperature-dependent. The influence of electric field strength is often interwoven with temperature, as observed in the experimental data, which also agrees with the model (Table 3.4 and FIG. 17), where interaction between temperature and EFS is significant. Also, it is essential to note that at 30° C., the effect of electric field strength is complex, with variations in consistency coefficients observed at different frequencies tested. Again, as indicated before, the temperature-electric field strength interaction is not straightforward and may depend on other factors. Although EFS may also interact with frequency to influence the viscosity profile, according to the model and data obtained, frequency does not significantly affect MCC's consistency coefficient. At 30° C., the consistency coefficient varies with frequency at 4 kV/cm and 12 kV/cm. This suggests that the impact of electric field strength on consistency is modulated by the frequency of the applied electric field but is not significant enough to cause a major change according to the model generated.

Analyzing Table 3.3 runs 4, 6, and 9 produced a lower consistency coefficient with a minimum of 1613.89 Pa sⁿ. Similarly, runs 3, 8, and 11 had a higher consistency coefficient with a maximum of 3809.31 Pa sⁿ. The reduced consistency coefficient could be due to changes in the protein backbone structure caused by PEF treatment, for the PEF treatment conditions that have consistently observed minimum viscosity might be caused by partial denaturation and optimal treatment leading to partial exposure of certain groups on the surface of the casein protein. Previous research has shown that PEF is also known to increase the volume of the casein micelles and create pores. The outcomes signify that pulsed electric field processing reduces MCC's viscosity in less time than control samples without PEF treatment. PEF can be used as a pre-treatment to modify the viscosity in a short period of 26 milliseconds.

To understand the model and interaction profiles, the data was thoroughly analyzed using JMP for outliers. Run 1 (temperature 45° C., EFS 12 kV/cm and 165 Hz) with a consistency coefficient of 865.59 Pa sⁿ was identified as an outlier. The value obtained for the consistency coefficient is way less than all the other experimental runs, potentially due to environmental factors, time or temperature-dependent changes, or excessive treatment of MCC. In this study, temperature controls were used to eliminate any changes to the samples due to changes in temperature during the treatment. Therefore, viscosity analysis was still performed at 25° C.; hence, the effect of temperature on modifying the viscosity was not considered.

Having EFS at 4 kV/cm for both runs 6 and 9 at a temperature of 45° C. and runs 8 and 11 at a temperature of 15° C. and varying frequency from 30 to 300 Hz suggests that an increase in frequency leads to a maximum of 2995.77 Pa sⁿ and a drop in frequency provided a minimum of 1613.89 Pa sⁿ. Similarly, at the same EFS, runs 6 & 8 and 9 & 11 with varying temperatures from 15° C. to 45° C. led to a decrease in consistency coefficient despite an increase in frequency. At 12 kV/cm and 30° C., varying the frequency from 30 to 165 Hz increased the consistency coefficient to a maximum of 2695.84 Pa sⁿ, and further increasing to 300 Hz decreased the consistency coefficient to 2565.07 Pa sⁿ. Compared to the runs at mid-temperature and EFS, increasing the frequency to a certain extent had a maximum and then dropped when the frequency was extreme. At 20 kV/cm and lower frequency, the increase in temperature led to a decrease in consistency coefficient to 2664.98 Pa sⁿ (Run 2 and 7). However, increasing the frequency to 300 Hz with the same EFS (Run 12 & 14) leads to an increase in consistency coefficient despite the rise in the temperature. This might be caused by a combined effect of all the three parameters. Run 14 accounts for the highest conditions in the experimental run, with the highest consistency coefficient of 3056.02 Pa sⁿ. With runs 7 and 12, at 20 kV/cm and a lower temperature of 15° C., the consistency coefficient relatively remains constant with an increase in frequency. However, it is notable that the mid-temperature range of 30° C. mid-frequency of 165 Hz, and higher EFS of 20 kV/cm (Run 10) minimizes the consistency coefficient to 1538.45 Pa sⁿ, which is also indicative that optimizing the PEF processing parameters could potentially assist in reducing the viscosity of MCC. Overall, alteration to the temperature and EFS was concluded to have a maximum effect on MCC viscosity, and a minor role with the frequency was observed.

The viscosity characteristic of dairy protein in solution is affected by concentration, size, surface properties, and interactions with other protein particles. The result from this study shows that pretreatment with a pulsed electric field could lead to changes in the viscosity of MCC. These findings follow a study by, where changes in apparent viscosity and shear stress were observed in skim milk after PEF treatment. Similar results have been reported to have reduced viscosity of milk and changes in apparent viscosity in soy milk. PEF processing has been known to ionize certain chemical groups of the protein backbone and cause changes in the secondary structure. Depending on the electric field strength applied, PEF could have a positive or negative effect. Studies state that the increase in hydrophobic amino acids from the inner core of protein structure could make the protein more flexible and hence change the function of the protein and in this study is viscosity. Therefore, PEF treatment leads to conformational changes in the protein structure by modifying the ionic interactions between proteins.

Protein Profiling Analysis with SDS

The molecular weight distribution of PEF-treated MCC was characterized using SDS-PAGE. The SDS-PAGE analysis provides an understanding of inherent protein molecular weight distribution changes. The SDS PAGE profile of PEF-treated MCC samples under both reducing and non-reducing conditions. From the electropherogram, between the control and treated samples, they displayed bands of BSA, αs-CN, and β-CN.

The proteins were recorded in the range of 10 to 250 kDa. The electrophoretic patterns also represented a mix of low and high-molecular-weight proteins. The MW patterns from PEF-treated MCC showed no intensity changes in the bands after the PEF treatment. The present MW pattern findings conform with the results from Zhang et al., Similar results were reported for no changes in molecular weight distribution for whey protein isolate and milk protein isolate treated with PEF. Based on the results, the milk protein fractions were similar to the literature, and the bands obtained were in the range.

This analysis has proven that the protein quality and composition in MCC were unaffected by the PEF treatment. The gels also show di-sulfide linkages aggregated at the stacking region of reducing gels. Both the reducing and the non-reducing gels show an apparent visual confirmation of protein bands such as as casein, β casein, κ casein, β-lactoglobulin and α-lactalbumin. This also suggests that recovering the protein fractions as monomeric protein is possible, redefining that protein fractions were not lost during the PEF treatment. Overall, the SDS-PAGE analysis justified that no significant changes in the MW distribution of MCC were observed due to PEF treatment.

### Flow Behavior Analysis

The results of the flowability analysis of MCC are represented in terms of avalanche energy. According to the analytical method, the lower the avalanche energy correlated to the sample's increased or easy flow behavior. PEF-treated MCC had a mean avalanche energy range of 63.35 kJ/kg (control)-38.47 kJ/kg. Overall, when comparing with the controls, the avalanche energy for PEF-treated MCC, there was a minor difference; however, it was not significant to be analyzed as a model. Protein powders like MCC are used as ingredients in various applications as the demand for high-protein powders in the market keeps increasing (Mahadev and Meena, 2020). MCCs form more casein-casein interactions due to spray drying and dipole effects, altering the surface composition. This will, in turn, lead to the aggregation of protein powders during the mixing process and make the MCC difficult to flow. The flow behavior of these MCCs is also highly influenced by the particle size of the MCC and the composition. PEF is known to cause changes to the particle size of the powder, and a decrease in particle sizes will have increased flow properties, which was also observed as part of the particle size analysis from Table 3.6. However, the changes are not significant. In general, high protein powders like MCC tend to have higher protein-protein interactions and protein-causing interactions due to the absence of lactose, leading to higher aggregation and particle size of the MCC samples. Thus, pre-treatment with PEF for MCC was beneficial to improving viscosity at 12%, but there was no significant model to predict the flow behavior pattern of PEF-treated MCC. A possible reason for this could be the initial lower solids content (12%) as a raw material for the PEF treatment, which may not result in a significant difference in spray drying efficiency. Conducting further research to understand how increasing the total solids content might affect flow behavior could help determine if there are any significant differences in the system.

### Powder Particle Size Analysis

The particle size analysis of powders was analyzed. Values are represented as D(v,0.1) representing particle size below 10% of the powder volume, D (v,0.5) representing particle size below which 50% of the volume exists, and D(v,0.9) representing particle size below which 90% of the material volume exists along with the mean particle size in Table 3.6. From the table, the mean particle size for all the MCC samples, including the controls, was similar, with minor differences. The largest median particle size MCC was observed to be 45.827 m, and the minimum was found to be 36.638 m. MCC samples with PEF treatment had similar particle size distribution compared to the sample controls from runs 19, 20, and 21. The mean particle size of MCC from PEF-treated samples was 36-40 m, and the medium particle size was 30-34 m. The minimum differences in the particle size of the powders could be attributed to spray dryer efficiency, consistency, electric field-induced particle size agglomeration, or reduction in the process. The TS content from the raw material could affect the particle size of the spray drying process in which case it was constant at 12%. From the literature, the MCC particle size was d10=29.44 m, d50=82.46 m, and d90=110.3 m. The differences in the particle size between samples could be due to various environmental factors, total solids, concentration of the solution, atomizer speed used for the drying process, and the dryer's efficiency. Most of the d90 for PEF-treated MCC ranges between 70-74 m and d50 at 30-33 μm, which is a ˜30% decrease from what is seen in the literature. The particle size analysis provided an understanding that there is a minor difference in particle size compared with the temperature control samples and increased surface area contact. The reduced particle size increased flowability because the surface area increased and provided a more cohesive flow of the powder particles. Overall, the particle size analysis indicated that the samples under PEF treatment would have a potentially minor difference in particle size for MCC; however, it is not significant enough to provide a model prediction.

TABLE 3.6
Average Particle size analysis of reconstituted MCC (PEF treatment) and Average
flow behavior represented by mean avalanche energy after PEF treatment of MCC.

| | | | | | | | | Mean of |
|---|---|---|---|---|---|---|---|---|
| | | | | | | | | avalanche |
| | | | | | | | | energy |
| | | | | Std | | | | (Mean ± SD) |
| Runs | Mean | Median | Mode | Dev | D(v, 0.1) | D(v, 0.9) | D(v, 0.5) | kJ/kg |
| 1 | 40.559 | 34.802 | 41.899 | 26.302 | 14.472 | 73.048 | 34.802 | 53 ± 8.09 |
| 2 | 39.818 | 32.075 | 41.997 | 30.207 | 12.942 | 74.226 | 32.075 | 51.5 ± 1.22 |
| 3 | 39.332 | 32.932 | 41.926 | 27.139 | 13.576 | 72.073 | 32.932 | 45.33 ± 2.05 |
| 4 | 39.068 | 32.72 | 36.698 | 26.441 | 14.063 | 70.957 | 32.72 | 61.97 ± 3.26 |
| 5 | 37.892 | 30.613 | 42.026 | 26.761 | 12.605 | 72.34 | 30.613 | 52.1 ± 2.62 |
| 6 | 39.689 | 33.412 | 41.939 | 26.736 | 13.594 | 73.109 | 33.412 | 45.76 ± 4.39 |
| 7 | 41.673 | 35.000 | 48.195 | 28.893 | 13.085 | 78.296 | 35 | 50.93 ± 1.16 |
| 8 | 38.853 | 32.939 | 41.969 | 25.341 | 13.528 | 71.623 | 32.939 | 44.27 ± 3.26 |
| 9 | 37.917 | 30.907 | 41.955 | 26.955 | 12.499 | 71.78 | 30.907 | 36.43 ± 2.99 |
| 10 | 39.109 | 31.233 | 42.073 | 28.587 | 12.742 | 74.724 | 31.233 | 44.7 ± 4.16 |
| 11 | 39.579 | 33.241 | 48.035 | 26.517 | 12.725 | 74.841 | 33.241 | 44.7 ± 8.03 |
| 12 | 37.61 | 31.707 | 47.834 | 25.018 | 12.283 | 70.766 | 31.707 | 38.47 ± 2.47 |
| 13 | 38.683 | 32.012 | 41.971 | 26.974 | 13.17 | 71.913 | 32.012 | 48.57 ± 3.38 |
| 14 | 36.638 | 31.531 | 36.703 | 22.554 | 13.5 | 66.336 | 31.531 | 49.37 ± 6.81 |
| 15 | 39.103 | 32.500 | 41.925 | 27.372 | 13.309 | 72.177 | 32.5 | 46.5 ± 2.26 |
| 16 | 38.604 | 31.451 | 41.886 | 27.647 | 13.265 | 71.919 | 31.451 | 49.37 ± 19.56 |
| 17 | 40.639 | 33.705 | 48.118 | 28.193 | 12.954 | 76.838 | 33.705 | 53.4 ± 6.9 |
| 18 | 45.827 | 41.583 | 48.36 | 28.084 | 14.982 | 80.881 | 41.583 | 39.73 ± 4.12 |
| 19 | 39.647 | 32.949 | 42.026 | 27.379 | 13.425 | 73.612 | 32.945 | 63.35 ± 12.35 |
| 20 | 39.197 | 33.317 | 39.336 | 25.565 | 14.081 | 71.15 | 33.317 | 47.35 ± 5.35 |
| 21 | 39.526 | 33.267 | 42.009 | 27.087 | 13.456 | 72.552 | 33.267 | 42.16 ± 0.94 |

### Optimization of Process Variables

The experimental dataset observed that customization of MCC for reduced viscosity can be achieved through the pulsed electric field as a pre-treatment during manufacturing. Table 3.5 shows ANOVA results, and since p<0.05, the model proves a significant fit, and the lack of fit is not significant.

The experimental data (Table 3.4) was fitted into a quadratic polynomial given by,

$$Consistency Coefficient ( Pa {s}^{n} ) for MCC = 2518.28 - 300.45 A + 144.81 B + 66.94 C + 347.18 AB + 64.76 AC + 20.8 BC + 903.6 {A}^{2} - 810.77 {B}^{2} - 31.49 {C}^{2} . \qquad ( 3.5 )$$

A, B, and C represent temperature, electric field strength, and frequency; AB, BC, and AC represent interaction terms; and A², B², and C² represent quadratic terms in equation (3.5). The data followed a quadratic model with R² of 0.91 and adjusted R² of 0.80, satisfying conditions for a good model fit. This equation can predict the consistency coefficient of PEF-treated MCC. The 3D surface plots (FIG. 19A-19F) for processing parameters of PEF have been represented with the independent variables that affected the consistency coefficient. Based on the desirability value, it can be concluded that the optimized condition will agree with the predicted value 99% of the time when the experiment is conducted.

This research observed that PEF treatment can increase or decrease the consistency coefficient depending on the treatment conditions applied. Thus, optimizing the PEF treatment to provide a reduced viscosity profile is very trivial in preventing excessive treatment and denaturation of the protein. The optimized conditions for minimum consistency coefficient/reduced viscosity of PEF-treated MCC were obtained using a numerical optimization procedure in DOE. They are as follows: Temperature at 34.7° C., EFS at 4.26 kV/cm, and frequency at 62.76 Hz. The optimized model has a consistency coefficient of 1440.57 Pa sⁿ and desirability of 1.0, thereby minimizing the consistency coefficient. The PEF treatment using optimized process conditions resulted in a consistency coefficient that is 48.31% less than that of the 15° C. control (2787.28 Pa sⁿ), 46.02% less than that of the 30° C. control (2669.03 Pa sⁿ), and 52.16% less than that of 45° C. control (3011.36 Pa sⁿ). With maximum viscosity improvement, using PEF will allow MCC to be used as an ingredient in many new product applications, including bars, supplements, and medical nutrition.

Thus, having mid-temperature, lower frequency, and mid-EFS would assist in producing MCC with enhanced. Since ranges were selected for the study, the optimized results will only be conclusive for these parameters. From runs 12 and 3, increasing the system's frequency and EFS might not be ideal since the increase causes a rise in temperature of a few degrees, and based on the current study, the maximum is about 12° C.

In conclusion, this study analyzed and optimized the effect of the pulsed electric field (PEF) on the viscosity of MCC. For many practical applications of methods, it has always been helpful to have these mathematically optimized models to accurately predict the viscosity behavior of MCC and how it can be optimized and reduced. One such method, pulsed electric field, was studied. The study showed that PEF could be used as a pre-treatment to reduce the viscosity of MCC. RSM indicated that the interaction effect between temperature and EFS, as well as temperature as an individual factor, played a significant role in optimizing the conditions for the treatment. The optimized conditions for PEF to produce MCC with a low viscosity profile include Temperature at 34.7° C., EFS at 4.26 kV/cm and frequency at 62.76 Hz with 1440.57 Pa sⁿ which was 46% less than control at 30° C. The power law model indicated that the PEF-treated MCC samples exhibited shear thinning behavior. SDS protein profiling of PEF-treated MCC displayed that the quality of the proteins is still maintained in their native state with minor surface modifications.

On the other hand, the particle size analysis showed a slight reduction in the particle size for PEF-treated samples compared to the control, indicating a change in aggregation of molecules and improved flowability of the MCC powders with PEF treatment; however the data was not fitted to model to be considered significant. Overall, this research supports the idea that reduced viscosity following the PEF treatment is achievable due to the changes in casein micelle structure with minor surface modifications. Further research might explore the effect of other processing parameters and the different TS and functional properties of MCC. The optimized model thus developed will provide the dairy industry with low-viscosity MCC, which would be necessary for new product innovations from the end consumer.

Accordingly, FIGS. 4-19 quantitatively illustrate, by way of example, that variations in treatment parameters can produce variations in characteristics of milk product output. Therefore, according to embodiments of the invention, treatment parameters of milk product concentrates and micellar casein concentrates can be controlled via inputs to produce desired or optimized milk product properties.

Furthermore, according to some embodiments of the invention, cold plasma and pulsed electric field processes can be optimized according to a variety of optimization parameters. For example, a cold plasma treatment process can be optimized according to the following polynomial equation:

$$Q = E + {α}_{2} B 1 + {α}_{3} C 1 + {α}_{4} D 1 + {α}_{5} E 1 + {α}_{6} A 1 B 1 + {α}_{7} A 1 C 1 + {α}_{8} A 1 D 1 + {α}_{9} A 1 E 1 + {α}_{10} B 1 C 1 + {α}_{11} B 1 D 1 + {α}_{12} B 1 E 1 + {α}_{13} C 1 D 1 + {α}_{14} C 1 E 1 + {α}_{15} D 1 E 1$$

Cold Plasma Process

| Variable | Variable Representation |
|---|---|
| Q | Response variable (type of functionality, e.g., |
| | foaming, emulsion, etc.) or dependent variable |
| A1 | Type of gas |
| B1 | Gas flow rates |
| C1 | Treatment time |
| D1 | Radio frequency power |
| E1 | Temperature |

Likewise, a pulsed electric field treatment can be optimized according to the following equation:

$$Q = E + {α}_{1} A + {α}_{2} B + {α}_{3} C + {α}_{4} AB + {α}_{5} AC + {α}_{6} BC + {α}_{7} {A}^{2} + {α}_{8} {B}^{2} + {α}_{9} {C}^{2} + {α}_{10} ABC + {α}_{11} {A}^{2} B + {α}_{12} {A}^{2} C + {α}_{13} {AB}^{2} + {α}_{14} {AC}^{2} + {α}_{15} {B}^{2} C + {α}_{16} {BC}^{2} + {α}_{17} {A}^{3} + {α}_{18} {B}^{3} + {α}_{19} {C}^{3}$$

Puled Electric Field Process

| Variable | Variable Representation |
|---|---|
| Q | Response variable (type of functionality, e.g., |
| | foaming, emulsion, etc.) |
| A | Temperature |
| B | Electric field intensity |
| C | Frequency |

Thus, examples of the disclosed technology can provide an improvement over conventional milk product treatment processes. The previous description of the disclosed examples is provided to enable any person skilled in the art to make or use the disclosed technology. Various modifications to these examples will be readily apparent to those skilled in the art, and the generic principles defined herein may be applied to other examples without departing from the spirit or scope of the disclosed technology. Thus, the disclosed technology is not intended to be limited to the examples shown herein but is to be accorded the widest scope consistent with the principles and novel features disclosed herein.

Unless otherwise specified or limited, the terms “about” and “approximately,” as used herein with respect to a reference value, refer to variations from the reference value of ±15% or less, inclusive of the endpoints of the range. Similarly, the term “substantially,” as used herein with respect to a reference value, refers to variations from the reference value of ±5% or less, inclusive of the endpoints of the range.

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “either,” “one of,” “only one of,” or “exactly one of” For example, a list of “one of A, B, or C” indicates options of: A, but not B and C; B, but not A and C; and C, but not A and B. A list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of A, one or more of B, and one or more of C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C.

In some examples, aspects of the disclosed technology, including computerized implementations of methods according to the disclosed technology, can be implemented as a system, method, apparatus, or article of manufacture using standard programming or engineering techniques to produce software, firmware, hardware, or any combination thereof to control a processor device (e.g., a serial or parallel general purpose or specialized processor chip, a single- or multi-core chip, a microprocessor, a field programmable gate array, any variety of combinations of a control unit, arithmetic logic unit, and processor register, and so on), a computer (e.g., a processor device operatively coupled to a memory), or another electronically operated controller to implement aspects detailed herein. Accordingly, for example, configurations of the disclosed technology can be implemented as a set of instructions, tangibly embodied on a non-transitory computer-readable media, such that a processor device can implement the instructions based upon reading the instructions from the computer-readable media. Some examples of the disclosed technology can include (or utilize) a control device such as an automation device, a special purpose or general-purpose computer including various computer hardware, software, firmware, and so on, consistent with the discussion below. As specific examples, a control device can include a processor, a microcontroller, a field-programmable gate array, a programmable logic controller, logic gates etc., and other typical components that are known in the art for implementation of appropriate functionality (e.g., memory, communication systems, power sources, user interfaces and other inputs, etc.). In some examples, a control device can include a centralized hub controller that receives, processes and (re)transmits control signals and other data to and from other distributed control devices (e.g., an engine controller, an implement controller, a drive controller, etc.), including as part of a hub-and-spoke architecture or otherwise.

Certain operations of methods according to the invention, or of systems executing those methods, may be represented schematically in the FIGS. or otherwise discussed herein. Unless otherwise specified or limited, representation in the FIGS. of particular operations in particular spatial order may not necessarily require those operations to be executed in a particular sequence corresponding to the particular spatial order. Correspondingly, certain operations represented in the FIGS., or otherwise disclosed herein, can be executed in different orders than are expressly illustrated or described, as appropriate for particular embodiments of the invention. Further, in some embodiments, certain operations can be executed in parallel, including by dedicated parallel processing devices, or separate computing devices configured to interoperate as part of a large system.

As used herein in the context of computer implementation, unless otherwise specified or limited, the terms “component,” “system,” “module,” “block,” and the like are intended to encompass part or all of computer-related systems that include hardware, software, a combination of hardware and software, or software in execution. For example, a component may be, but is not limited to being, a processor device, a process being executed (or executable) by a processor device, an object, an executable, a thread of execution, a computer program, or a computer. By way of illustration, both an application running on a computer and the computer can be a component. One or more components (or system, module, and so on) may reside within a process or thread of execution, may be localized on one computer, may be distributed between two or more computers or other processor devices, or may be included within another component (or system, module, and so on).

In some implementations, devices or systems disclosed herein can be utilized, manufactured, installed, etc. using methods embodying aspects of the invention. Correspondingly, any description herein of particular features, capabilities, or intended purposes of a device or system is generally intended to include disclosure of a method of using such devices for the intended purposes, of a method of otherwise implementing such capabilities, of a method of manufacturing relevant components of such a device or system (or the device or system as a whole), and of a method of installing disclosed (or otherwise known) components to support such purposes or capabilities. Similarly, unless otherwise indicated or limited, discussion herein of any method of manufacturing or using for a particular device or system, including installing the device or system, is intended to inherently include disclosure, as embodiments of the invention, of the utilized features and implemented capabilities of such device or system.

Also as used herein, unless otherwise defined or limited, directional terms are used for convenience of reference for discussion of particular figures or examples or to indicate spatial relationships relative to particular other components or context but are not intended to indicate absolute orientation. For example, references to downward, forward, or other directions, or to top, rear, or other positions (or features) may be used to discuss aspects of a particular example or figure, but do not necessarily require similar orientation or geometry in all installations or configurations.

Also as used herein, unless otherwise limited or defined, “configured to” indicates that a component, system, or module is particularly adapted for the associated functionality. Thus, for example, a ZZ configured to YY is specifically adapted to YY, as opposed to merely being generally capable of doing so.

Although the presently disclosed technology has been described with reference to preferred examples, workers skilled in the art will recognize that changes may be made in form and detail to the disclosed examples without departing from the spirit and scope of the concepts discussed herein.

1. A system for modifying dairy protein functionality, the system comprising:
a milk protein input;
a treatment process;
a milk protein output; and
a controller in communication with the treatment process, the controller configured to:
receive one or more input parameters;
generate one or more treatment parameters based on the one or more input parameters; and
initiate the treatment process based on the one or more treatment parameters.

2. The system of claim 1, wherein the one or more input parameters include one or more characteristics of the milk protein output, the one or more characteristics of the milk protein output including one or more of:
particle size, flowability, foaming stability, wettability, water binding capacity, solubility, isoelectric point, pH, water activity, dry mass, purity, color, or moisture content.

3. The system of claim 1, wherein the one or more input parameters include end-use product type.

4. The system of claim 1, wherein the one or more input parameters are user input parameters.

5. The system of claim 1, wherein the one or more treatment parameters include one or more of:
duration, electric field strength, current, frequency, power, or temperature of the treatment process.

6. The system of claim 1, wherein the milk protein input is a milk protein concentrate or a micellar casein concentrate.

7. The system of claim 1, wherein the treatment process is pulsed electric field process.

8. The system of claim 1, wherein the treatment process is a cold plasma treatment process.

9. A method of producing a desired dairy product protein according to an input parameter of a processing treatment, the method comprising:
identifying a desired dairy product characteristic;
inputting the desired dairy product characteristic into a controller;
with the controller, providing a treatment parameter based on the desired dairy product characteristic;
performing a treatment process based on the treatment parameter; and
outputting the desired dairy product protein.

10. The method of claim 9, wherein the desired dairy product characteristic includes one or more of a desired particle size, flowability, foaming stability, wettability, water binding capacity, solubility, isoelectric point, pH, water activity, dry mass, purity, color, or moisture content of the outputted desired dairy product protein.
